(19) United States
(12) Patent Application Publication
(10) Pub. No.: US 2020/0114260 A1
(43) Pub. Date: Apr. 16, 2020

(54) SYSTEMS AND METHODS FOR DYNAMIC POINT CALCULATION USING REAL-TIME SCORING UPDATES FOR BRACKET BASED GAMING

(71) Applicant: Wayne Lourenco, Laguna Niguel, CA (US)

(72) Inventor: Wayne Lourenco, Laguna Niguel, CA (US)

(21) Appl. No.: 16/653,865

(22) Filed: Oct. 15, 2019

Related U.S. Application Data
(63) Continuation of application No. 15/706,395, filed on Sep. 15, 2017, now abandoned.
(60) Provisional application No. 62/395,944, filed on Sep. 16, 2016.

(51) Int. Cl. A63F 13/46; A63F 13/85; A63F 13/80; A63F 13/798; A63F 13/65; A63F 13/63; A63F 13/47; A63F 13/335; A63F 13/332; A63F 13/828; A63B 71/06

(52) U.S. Cl. CPC A63F 13/46; A63F 13/85; A63F 13/80; A63F 13/798; A63F 13/65; H04L 67/10; A63F 13/47; A63F 13/335; A63F 13/332; A63F 13/828; A63B 71/06; A63F 13/63

(57) ABSTRACT

Systems, methods and devices for promoting a social gaming environment including instructions stored on a computer-readable medium that, when executed by a processor, cause the processor to change point calculations for selections of a dynamic bracket gaming environment.

### CROSS-REFERENCE TO RELATED APPLICATIONS

The present application is a continuation of U.S. patent application Ser. No. 15/706,395, filed Sep. 15, 2017, which claims priority pursuant to 35 U.S.C. § 119(e) to U.S. Provisional Patent Application No. 62/395,944 filed Sep. 16, 2016, both of which are hereby incorporated by reference in their entireties.

### BACKGROUND

Bracket based gaming is a well-known and common form of organizing and following competitions, tournaments and other related forms of human interactions. In particular, sporting tournaments are often arranged using bracket based gaming. As an example, in a competition with four teams, in a bracket based gaming format, one half of a bracket may have two teams compete to determine a first intermediate winner while another half of the bracket may have an additional two teams compete to determine a second intermediate winner. Then each of the intermediate winners may compete in order to determine one ultimate winner.

One popular American bracket based sporting event is the National Collegiate Athletic Association (NCAA) Division 1 college basketball tournament, commonly referred to as “March Madness.” March Madness is held annually, and fans and casual observers perform the function of choosing a winning team for each matchup that they believe will win their individual games on March Madness brackets. One common way these fans and casual observers perform this function is by printing individual brackets and manually filling out the names of each team in an initial round of matchups, winners of each matchup in intermediate rounds and an ultimate tournament winner for the final matchup. Another common way this function is performed, aided by the ubiquity of handheld and other computing devices, is through systems that have been built by companies. These systems allow fans and casual observers can access, fill-out and store one or more brackets using servers connected through the Internet. Unfortunately, numerous problems exist with both of these previously developed scoring systems.

One major problem that exists with these previously developed bracket selection systems is that they are inherently static. This static nature results in the lack of an ability for fans to edit, update or otherwise change their selections. This means that if an individual fan makes a number of incorrect selections in the early rounds of the tournament, they may lose interest in following the tournament in later rounds.

Another major problem that exists with the previously developed bracket selection systems is that they do not account for any concept of time. Since many tournament games may occur at similar times, numerous events can occur at simultaneous or nearly simultaneous times in the real world. This can greatly affect the outcome of these games and ultimately in the livelihood of the brackets of millions of fans who are powerless to edit or otherwise affect the outcome of their own bracket's destinies.

These existing problems can lead to dissatisfaction and disengagement for fans and consequently lead to revenue loss for advertisers who sell advertisements during the games. As such, systems and methods for dynamic bracket based gaming would be beneficial. Although some previous attempts have been made to create bracket based systems that have some dynamic components, such as the system hosted at http://www.rtsports.com/march-madness-brackets, these previous systems do not perform dynamic scoring functions in real-time or nearly real-time.

With a worldwide value across various sporting events and other bracket based competitions in the tens of billions of dollars annually, the bracket based gaming industry is a largely untapped resource for advertisers that may benefit from more effective fan engagement, in addition to the added fun-factor for fans and casual observers.

Thus, needs exist for improved techniques by which to create dynamic bracket based gaming systems and methods.

### SUMMARY

Provided herein are embodiments of systems and methods for creating dynamic point calculations for bracket based gaming. Various concepts used to provide these dynamic improvements include computer network based solutions allowing users to alter aspects of their matchup selections, causing dynamic score recalculations in real-time or near real-time and can have at least one time-based component. As such, users have a greater impact on their own scoring potential and outcome implications than previous static systems. One aspect of these changes that makes them dynamic is that they can be calculated or recalculated at the moment the user makes a change. Another is that changes can be made in real-time as information is learned or events occur quickly.

One aspect of the embodiments described herein can be described as a “Quick Pick” ability, where users can allow the system to randomly select the winners of each game in each round, through the ultimate tournament champion. Another aspect of the embodiments described herein has a “Static” ability, where users can select a winner for each game and lock-in their choices. In some instances, a static bracket cannot be changed once it is saved. In other instances, parts of a bracket may be changed as a “Semi-Static” ability. Another aspect of the embodiments described herein has a “Dynamic” ability, where users can select a winner for each game but can also change the selected winner for each game as the tournament occurs.

Additional functionality for embodiments described herein include providing: live game information; notifications about key games a user may be interested in; functionality for users to create a bracket pool and invite other users to the pool; a leaderboard of individuals who are in a specific pool; newsfeeds with relevant game information and filters; chat rooms and messaging for users to chat with each other; integration with social media and other third party websites, applications and features; and functionality allowing users create and edit user profiles and notification settings. It is contemplated that the algorithms used for dynamic scoring described herein can be applied to various sporting and other competitive environments. Some sporting examples include various amateur, college and professional sports with tournaments such as: soccer, tennis, swimming, golf; other tournament based events such as electronic video-gaming and poker; and numerous others.

The configuration of the systems and methods described herein in detail are only example embodiments and should not be considered limiting. Other systems, methods, features and advantages of the subject matter described herein will be or will become apparent to one with skill in the art upon examination of the following figures and detailed description. It is intended that all such additional systems, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A shows an example embodiment diagram of a system architecture.

FIG. 1B shows an example embodiment diagram of a server architecture.

FIG. 1C shows an example embodiment diagram of a user mobile device.

FIG. 2 shows an example embodiment diagram of various sporting logos for sports that can benefit from the concepts described herein.

FIGS. 3A-3C show an example embodiment diagram of typical prior art NCAA printable tournament bracket.

FIGS. 4A-4C show an example embodiment diagram wireframe diagram of a user interface bracket image for a tournament.

FIG. 5 shows an example embodiment diagram of a user interface bracket display screen.

FIG. 6 shows an example embodiment diagram of a user interface bracket display screen with selected winners.

FIG. 7 shows an example embodiment diagram of a user interface bracket display screen with selected winners.

FIG. 8 shows an example embodiment diagram of a user interface bracket display screen with selected winners.

FIG. 9 shows an example embodiment diagram of a user interface home display screen.

FIGS. 10A-10B show an example embodiment diagram and an associated graph diagram of a time-based point calculator generation algorithm.

FIGS. 11A-11B show an example embodiment graph diagram and a diagram of a time-based point calculator generation algorithm.

FIG. 12 shows an example embodiment diagram of a diagram of a time-based point calculator generation algorithm.

FIG. 13A shows an example embodiment diagram of an account registration flowchart.

FIG. 13B shows an example embodiment diagram of a pre-tournament application user workflow options and navigation chart.

FIG. 13C shows an example embodiment diagram of a dashboard chart.

FIG. 13D shows an example embodiment diagram of a brackets chart.

FIG. 13E shows an example embodiment diagram of a pools chart.

FIG. 14A shows an example embodiment diagram of a live tournament application user workflow options and navigation chart.

FIG. 14B shows an example embodiment diagram of a live tournament application user workflow dashboard chart.

FIG. 14C shows an example embodiment diagram of a live tournament application user workflow brackets chart.

FIG. 14D shows an example embodiment diagram of a live tournament application user workflow pools chart.

FIG. 14E shows an example embodiment diagram of a live tournament application user workflow live interaction chart.

FIG. 15 shows an example embodiment diagram of a web-based user interface home screen.

FIG. 16 shows an example embodiment diagram of a web-based user interface dashboard login registration screen.

FIG. 17 shows an example embodiment diagram of a web-based user interface terms and conditions information user interface screen.

FIG. 18 shows an example embodiment diagram of a web-based user interface password recovery user interface screen.

FIG. 19 shows an example embodiment diagram of a web-based user interface password recovery reset user interface screen.

FIG. 20 shows an example embodiment diagram of a web-based user interface bracket matchup view screen.

FIG. 21 shows an example embodiment diagram of a web-based user interface bracket matchup view screen within individual game information.

FIG. 22 shows an example embodiment diagram of a web-based user interface bracket creation screen.

FIG. 23 shows an example embodiment diagram of a web-based user interface bracket importation screen.

FIG. 24 shows an example embodiment diagram of a web-based user interface bracket importation confirmation screen.

FIG. 25 shows an example embodiment diagram of a web-based user interface imported bracket display screen.

FIG. 26 shows an example embodiment diagram of a web-based user interface saved bracket screen.

FIG. 27 shows an example embodiment diagram of a web-based user interface competition joining screen.

FIG. 28 shows an example embodiment diagram of a web-based user interface static bracket screen and the option to select a button to make picks.

FIG. 29 shows an example embodiment diagram of a web-based user interface pool creation screen.

FIG. 30 shows an example embodiment diagram of a web-based user interface static pool creation screen.

FIG. 31 shows an example embodiment diagram of a web-based user interface static pool screen with chat functionality.

FIG. 32 shows an example embodiment diagram of a user home screen and dashboard prior to beginning a tournament with listings for pools, featured pools and recent news.

FIG. 33 shows an example embodiment diagram of a web-based user interface pool searching screen.

FIG. 34 shows an example embodiment diagram of a web-based user interface private pool accessing screen.

FIG. 35 shows an example embodiment diagram of a web-based user interface static pool screen with chat functionality.

FIG. 36 shows an example embodiment diagram of a web-based user interface live home screen.

FIG. 37 shows an example embodiment diagram of a web-based user interface news screen.

FIG. 38 shows an example embodiment diagram of a web-based user interface bracket member viewing screen.

FIG. 39 shows an example embodiment diagram of a web-based user interface live bracket prior to beginning a tournament start with all picks select viewing screen.

FIG. 40 shows an example embodiment diagram of a web-based user interface bracket member viewing screen with a link to a number of live games highlighted in top navigation bar.

FIG. 41 shows an example embodiment diagram of a web-based user interface bracket member viewing screen with new bracket creation button.

FIG. 42 shows an example embodiment diagram of a web-based user interface bracket deletion confirmation screen.

FIG. 43 shows an example embodiment diagram of a web-based user interface bracket live scoring screen.

FIG. 44 shows an example embodiment diagram of a web-based user interface bracket live scoring screen showing potential points.

FIG. 45 shows an example embodiment diagram of a web-based user interface bracket live scoring screen showing potential points, a current user's score, a global leaderboard listing of scores and selected game statistics.

FIG. 46 shows an example embodiment diagram of a web-based user interface bracket live scoring screen showing potential points, a current user's score, a global leaderboard listing of scores and select game player statistics.

FIG. 47 shows an example embodiment diagram of a web-based user interface live bracket screen.

FIG. 48 shows an example embodiment diagram of a web-based user interface live bracket editing screen.

FIG. 49 shows an example embodiment diagram of a web-based user interface live bracket editing warning screen.

FIG. 50 shows an example embodiment diagram of a web-based user interface live bracket editing confirmation screen.

FIG. 51 shows an example embodiment diagram of a web-based user interface live static bracket screen.

FIG. 52 shows an example embodiment diagram of a web-based user interface live global pool leaderboard screen.

FIG. 53 shows an example embodiment diagram of a web-based user interface live country pool leaderboard screen.

FIG. 54 shows an example embodiment diagram of a web-based user interface live pool country leaderboard selection screen.

FIG. 55 shows an example embodiment diagram of a web-based user interface live friend profile screen.

FIG. 56 shows an example embodiment diagram of a web-based user interface news screen.

FIG. 57 shows an example embodiment diagram of a web-based user interface news notifications screen.

FIG. 58 shows an example embodiment diagram of a web-based user interface profile screen.

FIG. 59 shows an example embodiment diagram of a web-based user interface profile editing screen.

FIG. 60 shows an example embodiment diagram of a web-based user interface password editing screen.

FIG. 61 shows an example embodiment diagram of a smartphone based iOS user interface dashboard screen.

FIG. 62 shows an example embodiment diagram of a smartphone based iOS user interface bracket screen with selected picks.

FIG. 63 shows an example embodiment diagram of a smartphone based iOS user interface live scoring screen.

FIGS. 64A-64C show example embodiment diagrams of a tablet computer based iOS user interface generic and tournament specific home screens.

FIG. 65 shows an example embodiment diagram of a tablet computer based iOS user interface dashboard screen.

FIG. 66 shows an example embodiment diagram of a tablet computer based iOS user interface login screen.

FIG. 67 shows an example embodiment diagram of a tablet computer based iOS user interface registration screen.

FIG. 68 shows an example embodiment diagram of a tablet computer based iOS user interface terms and conditions screen.

FIG. 69 shows an example embodiment diagram of a tablet computer based iOS user interface forgot password screen.

FIG. 70 shows an example embodiment diagram of a tablet computer based iOS user interface password change screen.

FIG. 71 shows an example embodiment diagram of a tablet computer based iOS user interface create bracket screen.

FIG. 72 shows an example embodiment diagram of a tablet computer based iOS user interface create bracket screen with a select game status view.

FIG. 73 shows an example embodiment diagram of a tablet computer based iOS user interface create bracket screen with a quick pick selection window.

FIG. 74 shows an example embodiment diagram of a tablet computer based iOS user interface create bracket screen with a bracket import window.

FIG. 75 shows an example embodiment diagram of a tablet computer based iOS user interface bracket select to import confirmation screen.

FIG. 76 shows an example embodiment diagram of a tablet computer based iOS user interface bracket import confirmation screen.

FIG. 77 shows an example embodiment diagram of a tablet computer based iOS user interface bracket saved confirmation screen and global pool selection screen.

FIG. 78 shows an example embodiment diagram of a tablet computer based iOS user interface bracket saved confirmation screen.

FIG. 79 shows an example embodiment diagram of a tablet computer based iOS user interface pools joined screen.

FIG. 80 shows an example embodiment diagram of a tablet computer based iOS user interface pool creation screen.

FIG. 81 shows an example embodiment diagram of a tablet computer based iOS user interface static pool creation screen.

FIG. 82 shows an example embodiment diagram of a tablet computer based iOS user interface new pool invite screen.

FIG. 83 shows an example embodiment diagram of a tablet computer based iOS user interface contact access confirmation screen.

FIG. 84 shows an example embodiment diagram of a tablet computer based iOS user interface pool joined viewing screen.

FIG. 85 shows an example embodiment diagram of a tablet computer based iOS user interface find pool search screen.

FIG. 86 shows an example embodiment diagram of a tablet computer based iOS user interface pool search entry screen.

FIG. 87 shows an example embodiment diagram of a tablet computer based iOS user interface pool password entry screen.

FIG. 88 shows an example embodiment diagram of a tablet computer based iOS user interface pool entry screen.

FIG. 89 shows an example embodiment diagram of a tablet computer based iOS user interface application purchase confirmation screen.

FIG. 90 shows an example embodiment diagram of a tablet computer based iOS user interface application password entry screen.

FIG. 91 shows an example embodiment diagram of a tablet computer based iOS user interface application pool entry confirmation screen.

FIG. 92 shows an example embodiment diagram of a tablet computer based iOS user interface application individual pool's member listing and leaderboard screen.

FIG. 93 shows an example embodiment diagram of a tablet computer based iOS user interface application live dashboard screen.

FIG. 94 shows an example embodiment diagram of a tablet computer based iOS user interface application bracket creation starting screen.

FIG. 95 shows an example embodiment diagram of a tablet computer based iOS user interface application created bracket listing screen.

FIG. 96 shows an example embodiment diagram of a tablet computer based iOS user interface application bracket creation screen.

FIG. 97 shows an example embodiment diagram of a tablet computer based iOS user interface application live bracket list screen.

FIG. 98 shows an example embodiment diagram of a tablet computer based iOS user interface application bracket deletion screen.

FIG. 99 shows an example embodiment diagram of a tablet computer based iOS user interface application bracket deletion confirmation screen.

FIG. 100 shows an example embodiment diagram of a tablet computer based iOS user interface application live game information screen.

FIG. 101 shows an example embodiment diagram of a tablet computer based iOS user interface application potential points for live game pick switching screen.

FIG. 102 shows an example embodiment diagram of a tablet computer based iOS user interface application live game score screen with selected game statistics.

FIG. 103 shows an example embodiment diagram of a tablet computer based iOS user interface application live game score screen with selected game player statistics.

FIG. 104 shows an example embodiment diagram of a tablet computer based iOS user interface application live bracket screen.

FIG. 105 shows an example embodiment diagram of a tablet computer based iOS user interface application live static bracket screen.

FIG. 106 shows an example embodiment diagram of a tablet computer based iOS user interface application live bracket and global leaderboard listing screen.

FIG. 107 shows an example embodiment diagram of a tablet computer based iOS user interface application live bracket single country leaderboard listing screen.

FIG. 108 shows an example embodiment diagram of a tablet computer based iOS user interface application live bracket country selection listing screen.

FIG. 109 shows an example embodiment diagram of a tablet computer based iOS user interface application live pool chat screen.

FIG. 110 shows an example embodiment diagram of a tablet computer based iOS user interface application live friend profile screen.

FIG. 111 shows an example embodiment diagram of a tablet computer based iOS user interface application news screen.

FIG. 112 shows an example embodiment diagram of a tablet computer based iOS user interface application notifications screen.

FIG. 113 shows an example embodiment diagram of a tablet computer based iOS user interface application settings screen.

FIG. 114 shows an example embodiment diagram of a tablet computer based iOS user interface application personal profile screen.

FIG. 115 shows an example embodiment diagram of a tablet computer based iOS user interface application personal profile editing screen.

FIG. 116 shows an example embodiment diagram of a tablet computer based iOS user interface application password changing screen.

FIG. 117 shows an example embodiment diagram of a tablet computer based iOS user interface application notifications settings screen.

FIG. 118 shows an example embodiment diagram of a tablet computer based iOS user interface application social accounts settings screen.

FIGS. 119A-119B show example embodiments of Android and iOS mobile device home screens, respectively.

FIGS. 120A-120B show example embodiments of Android and iOS mobile device first round bracket screens, respectively.

FIGS. 121A-121B show example embodiments of Android and iOS mobile device second round bracket screens, respectively.

FIGS. 122A-122B show example embodiments of Android and iOS mobile device third round bracket screens, respectively.

FIGS. 123A-123B show example embodiments of Android and iOS mobile device bracket results screens, respectively.

FIGS. 124A-124B show example embodiments of Android and iOS mobile device bracket results screens, respectively.

FIGS. 125A-125C show example embodiment diagrams of a mobile device based Android user interface generic and tournament specific home screens.

FIG. 126 shows an example embodiment diagram of a mobile device based Android user interface dashboard screen.

FIG. 127 shows an example embodiment diagram of a mobile device based Android user interface login and registration screen.

FIG. 128A shows an example embodiment diagram of a mobile device based Android user interface profile creation screen.

FIG. 128B shows an example embodiment diagram of a mobile device based Android user interface terms and conditions screen.

FIG. 129 shows an example embodiment diagram of a mobile device based Android user interface forgotten password screen.

FIG. 130 shows an example embodiment diagram of a mobile device based Android user interface new password creation screen.

FIG. 131 shows an example embodiment diagram of a mobile device based Android user interface individual bracket picks screen.

FIG. 132 shows an example embodiment diagram of a mobile device based Android user interface select game and team performance statistics screen.

FIG. 133 shows an example embodiment diagram of a mobile device based Android user interface quick pick selection screen.

FIG. 134 shows an example embodiment diagram of a mobile device based Android user interface import bracket choice selection screen.

FIG. 135 shows an example embodiment diagram of a mobile device based Android user interface confirming selected bracket to import screen.

FIG. 136 shows an example embodiment diagram of a mobile device based Android user interface imported bracket confirmation screen with pool selection option.

FIG. 137 shows an example embodiment diagram of a mobile device based Android user interface imported bracket saved confirmation and option to join global pool screen.

FIG. 138 shows an example embodiment diagram of a mobile device based Android user interface imported bracket saved confirmation screen.

FIG. 139 shows an example embodiment diagram of a mobile device based Android user interface dashboard screen.

FIG. 140 shows an example embodiment diagram of a mobile device based Android user interface pool creation screen.

FIG. 141 shows an example embodiment diagram of a mobile device based Android user interface static pool creation screen.

FIG. 142 shows an example embodiment diagram of a mobile device based Android user interface new pool invite screen.

FIG. 143 shows an example embodiment diagram of a mobile device based Android user interface contact access confirmation screen.

FIG. 144 shows an example embodiment diagram of a mobile device based Android user interface dashboard and pool joined viewing screen.

FIG. 145 shows an example embodiment diagram of a mobile device based Android user interface find pool search screen.

FIG. 146 shows an example embodiment diagram of a mobile device based Android user interface pool search entry screen.

FIG. 147 shows an example embodiment diagram of a mobile device based Android user interface pool password entry screen.

FIG. 148 shows an example embodiment diagram of a mobile device based Android user interface pool entry screen.

FIG. 149 shows an example embodiment diagram of a mobile device based Android user interface application password entry screen.

FIG. 150 shows an example embodiment diagram of a mobile device based Android user interface application pool entry confirmation screen.

FIG. 151 shows an example embodiment diagram of a mobile device based Android user interface application pool leaderboard screen.

FIG. 152 shows an example embodiment diagram of a mobile device based Android user interface application live dashboard screen.

FIG. 153 shows an example embodiment diagram of a mobile device based Android user interface application bracket creation start screen.

FIG. 154 shows an example embodiment diagram of a mobile device based Android user interface application bracket creation screen.

FIG. 155 shows an example embodiment diagram of a mobile device based Android user interface application bracket creation and game pick screen.

FIG. 156 shows an example embodiment diagram of a mobile device based Android user interface application live bracket list screen.

FIG. 157 shows an example embodiment diagram of a mobile device based Android user interface application bracket deletion screen.

FIG. 158 shows an example embodiment diagram of a mobile device based Android user interface application bracket deletion confirmation screen.

FIG. 159 shows an example embodiment diagram of a mobile device based Android user interface application live game information screen.

FIG. 160 shows an example embodiment diagram of a mobile device based Android user interface application live game potential points for pick switching screen.

FIG. 161 shows an example embodiment diagram of a mobile device based Android user interface application live game score and player statistics screen.

FIG. 162 shows an example embodiment diagram of a mobile device based Android user interface application live game score and game statistics screen.

FIG. 163 shows an example embodiment diagram of a mobile device based Android user interface application live bracket round 1 screen.

FIG. 164 shows an example embodiment diagram of a mobile device based Android user interface application live bracket round 2 game winner pick screen.

FIG. 165 shows an example embodiment diagram of a mobile device based Android user interface application live static bracket round 2 screen.

FIG. 166 shows an example embodiment diagram of a mobile device based Android user interface application live bracket global pool leaderboard listing screen.

FIG. 167 shows an example embodiment diagram of a mobile device based Android user interface application live bracket single country pool leaderboard listing screen.

FIG. 168 shows an example embodiment diagram of a mobile device based Android user interface application live bracket country selection listing screen.

FIG. 169 shows an example embodiment diagram of a mobile device based Android user interface application live pool chat screen.

FIG. 170 shows an example embodiment diagram of a mobile device based Android user interface application live friend profile screen.

FIG. 171 shows an example embodiment diagram of a mobile device based Android user interface application news screen.

FIG. 172 shows an example embodiment diagram of a mobile device based Android user interface application notifications screen.

FIG. 173 shows an example embodiment diagram of a mobile device based Android user interface application settings screen.

FIG. 174 shows an example embodiment diagram of a mobile device based Android user interface application logout confirmation screen.

FIG. 175 shows an example embodiment diagram of a mobile device based Android user interface application personal profile screen.

FIG. 176 shows an example embodiment diagram of a mobile device based Android user interface personal profile editing screen.

FIG. 177 shows an example embodiment diagram of a mobile device based Android user interface application password changing screen.

FIG. 178 shows an example embodiment diagram of a mobile device based Android user interface application notifications settings screen.

FIG. 179 shows an example embodiment diagram of a mobile device based Android user interface application social accounts settings screen.

FIG. 180 shows an example embodiment diagram of a game highlighter feature that can highlight games or matchups that are currently in progress.

FIG. 181 shows an example embodiment diagram of a pick percentage feature that is based on a total number of system users who have selected a particular team.

FIG. 182 shows an example embodiment image of a football selection screen.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

In various embodiments, the systems and methods described herein can be single-platform or cross-platform on existing platforms such as iOS, Android and Web platforms or those later developed. These embodiments can include Native Applications programmed in one or more of Objective C, Java, HTML/CSS or others for mobile devices such as iPhone 5-6 Plus, iPad, iPad mini, Android phones/tablets and other specific devices. It should be understood that back-office or back-end administrative tools can also be provided in addition to customer facing tools. These systems and methods can include Database Schema & Hosting Architecture/Infrastructure, including AWS hosting and configuration.

Mobile applications, mobile devices such as smart phones/tablets/wearable devices, application programming interfaces (APIs), databases, social media platforms including social media profiles or other sharing capabilities, load balancers, web applications, page views, networking devices such as routers, terminals, gateways, network bridges, switches, hubs, repeaters, protocol converters, bridge routers, proxy servers, firewalls, network address translators, multiplexers, network interface controllers, wireless interface controllers, modems, ISDN terminal adapters, line drivers, wireless access points, cables, servers and others equipment, components and devices as appropriate to implement the methods and systems described herein are contemplated.

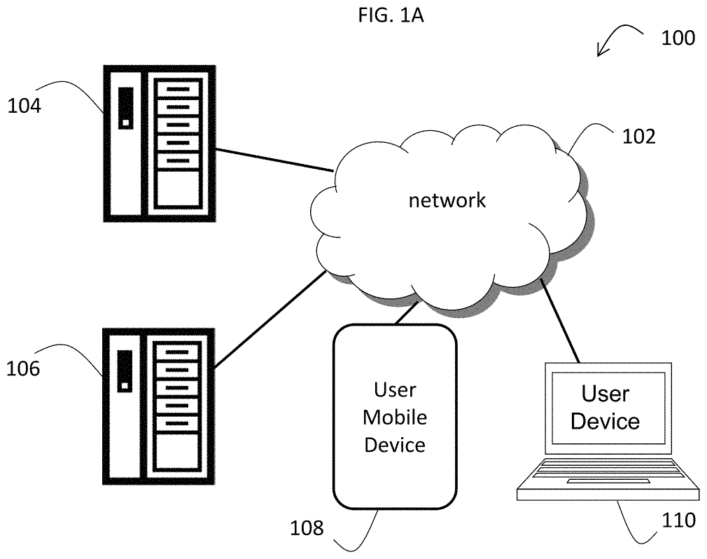

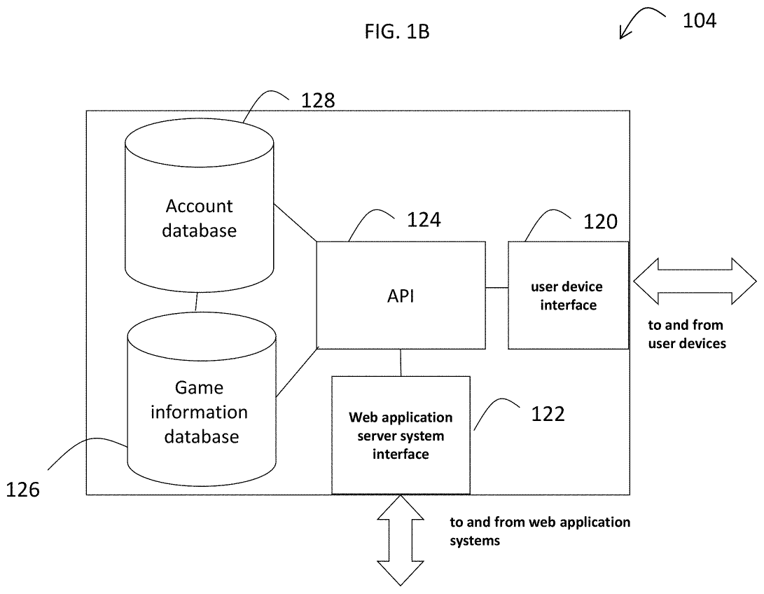

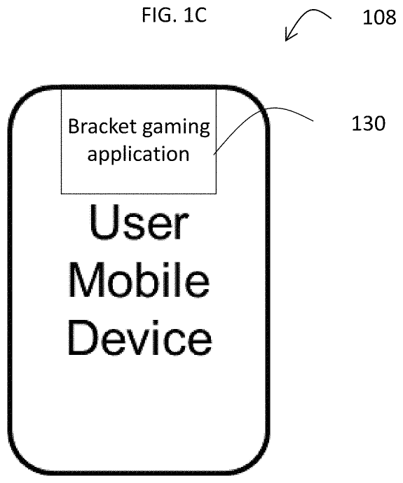

FIG. 1A shows an example embodiment diagram of a system architecture 100. As shown in the example embodiment, this can include multiple servers 104, 106 which may include applications distributed on one or more physical servers, each having one or more processors, non-transitory computer readable media memory banks, operating systems, input/output interfaces, and network interfaces, all known in the art, and a plurality of end user devices coupled to a network 102 such as a public network (e.g. the Internet and/or a cellular-based wireless network or other networks) or a private network. User devices 108, 110 can include, for example, mobile devices (e.g. phones, tablets and others) desktop or laptop devices, wearable devices (e.g. watches, bracelets, glasses and others), other devices with computing capability and network interfaces and so on. The server systems can include, for example, servers 104, 106 operable to interface with websites, webpages, web applications, social media platforms, advertising platforms and others.

FIG. 1B shows an example embodiment diagram of a server architecture 104. As shown in the example embodiment, a server system can include at least one user device interface 120 implemented with technology known in the art for communication with user devices. The server system can include at least one web application server system interface 122 for communication with web applications, websites, webpages, websites, social media platforms, and others. The server system can further include an application program interface (API) 124 that is coupled to at least one database, such as Account database 128 and Game information database 126 and others and can communicate with interfaces such as the user device interface 120 and web application server system interface 122, or others. API 124 may instruct the databases 126, 128 to store (and retrieve from the databases) information such as user account information, chat information or URL information, bracket information, game information, scoring information and others as appropriate. Databases 126, 128 may be implemented with technology known in the art such as relational databases and/or object oriented databases or others.

FIG. 1C shows an example embodiment diagram of a user mobile device 108. As shown in the example embodiment, user devices 136 can include a network connected game application 130 that is installed in, pushed to or downloaded and stored in non-transitory computer readable memory of the user mobile device 108. In many embodiments, user devices are touch screen devices such as smartphones and tablet computers that include one or more processors, operable to execute instructions stored in non-transitory computer readable memory of the device.

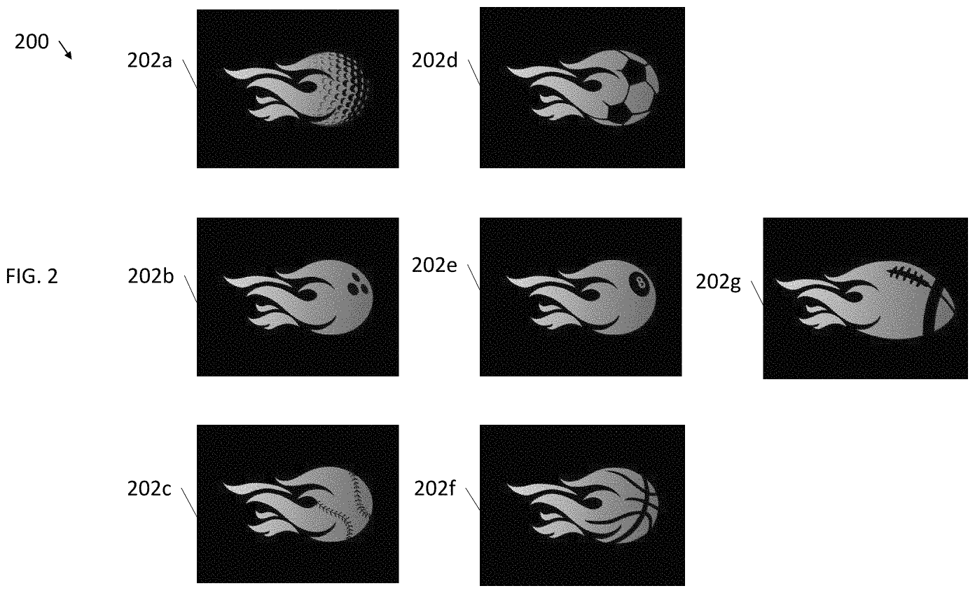

FIG. 2 shows an example embodiment diagram 200 of various sporting logos for sports that can benefit from the concepts described herein. As non-limiting examples, golf logo 202a, soccer logo 202d, bowling logo 202b, billiards logo 202e, baseball logo 202c, softball logo (not shown), basketball logo 202f, football logo 202g, and numerous other sports and competitions can use bracket based gaming systems and methods.

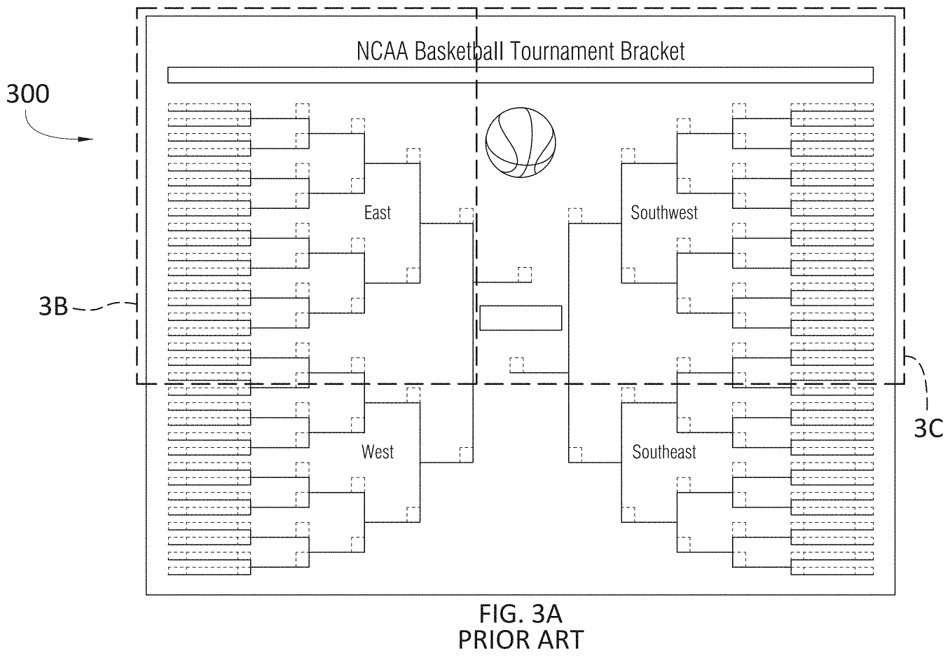

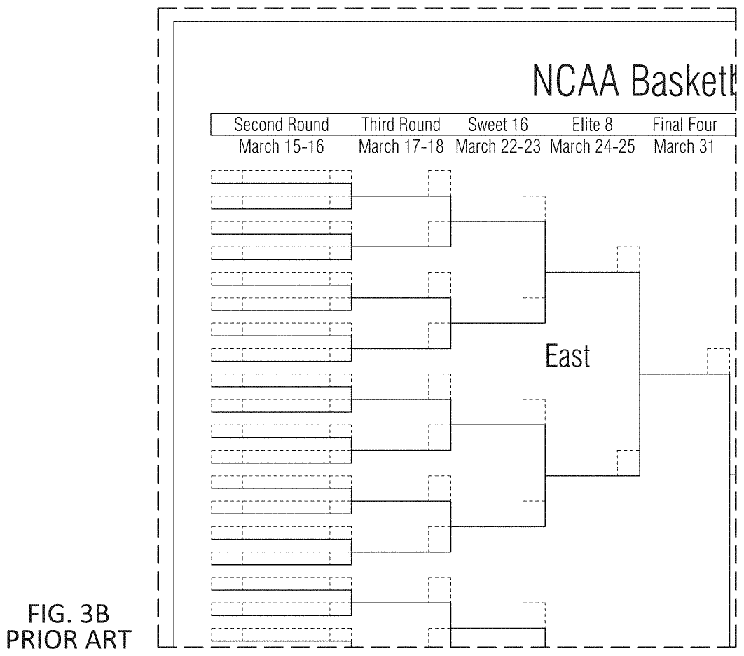

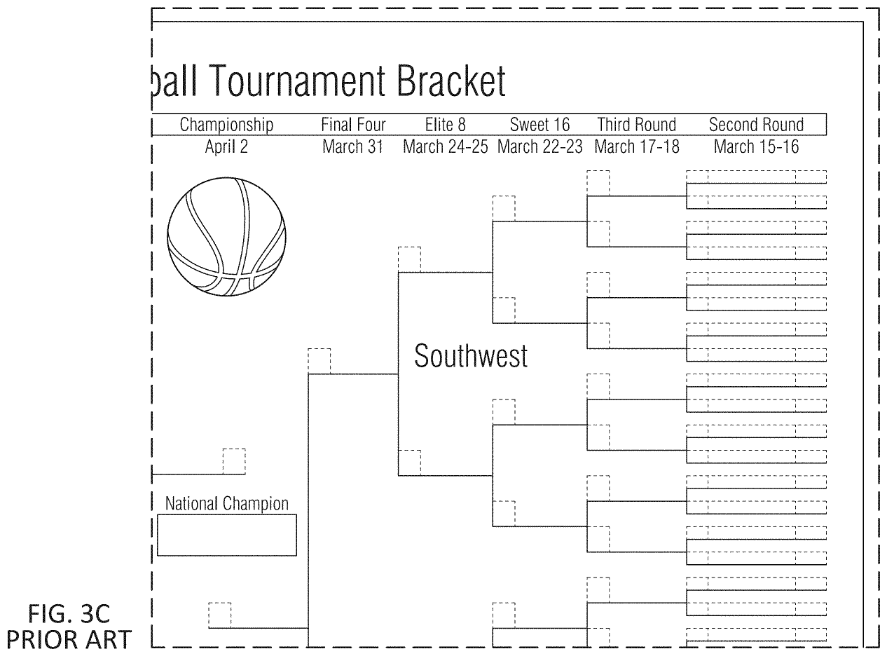

FIGS. 3A-3C show an example embodiment diagram 300 of typical prior art NCAA printable tournament bracket. As shown in the example embodiment, in the past, individual bracket players can print out a bracket in the form of diagram 300 and write in scheduled matchups of teams for each first round game on the lines provided in the bracket. Then they can write in their predicted winners for each matchup in the next round, up until the final matchup with a predicted overall winner in the center. Additionally, bracket players can write predicted scores next to each team in a small box, for further scoring enhancements, functions, and capabilities.

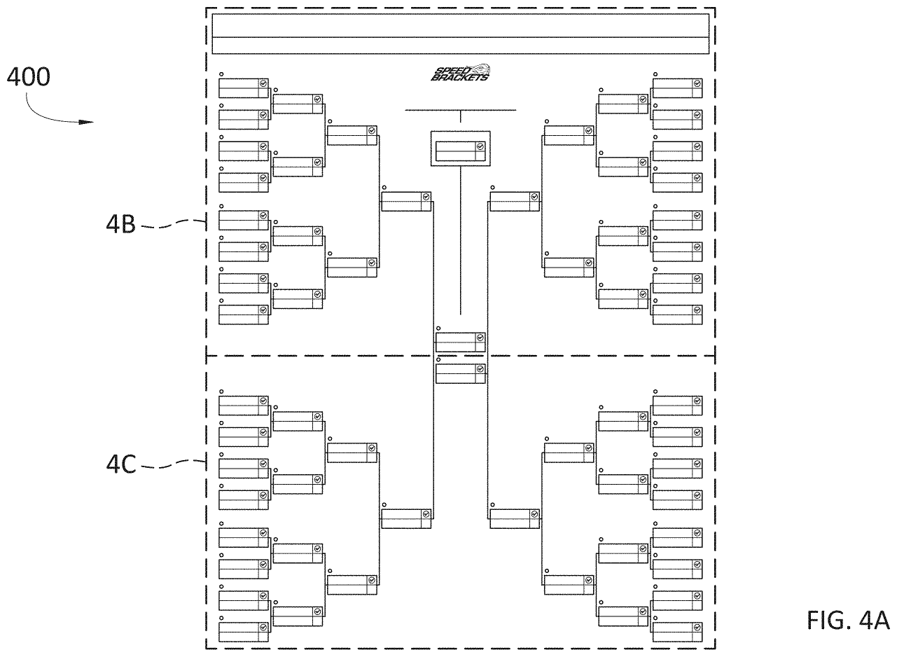

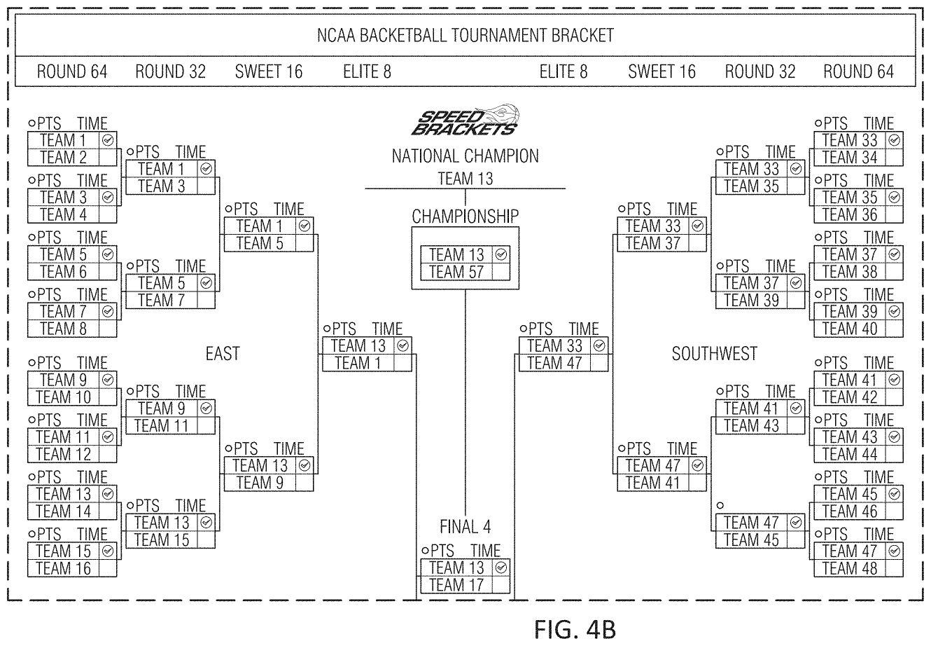

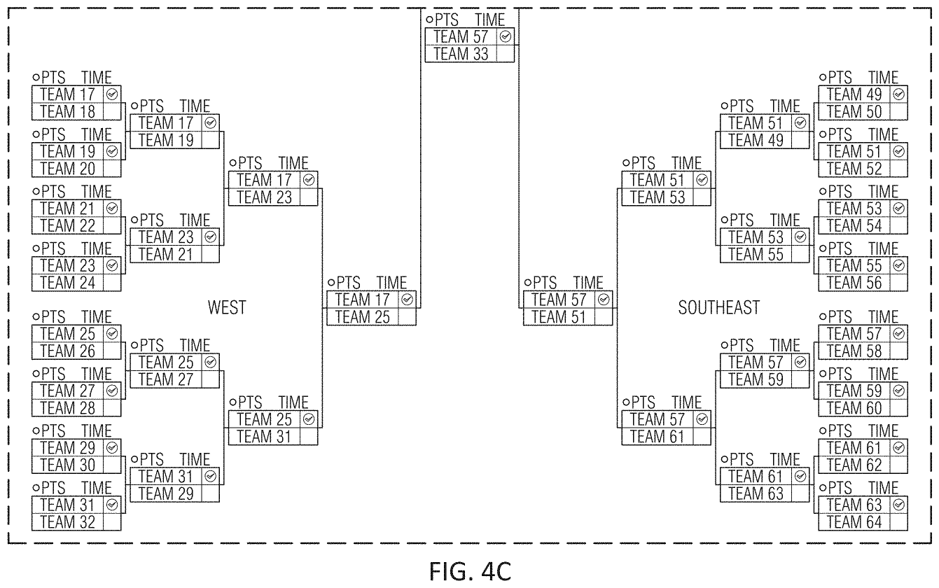

FIGS. 4A-4C show an example embodiment diagram wireframe diagram 400 of a user interface bracket image for a tournament. As shown, wireframe diagram 400 appears in similar fashion to the bracket of FIGS. 3A-3C but is implemented on a user interface of a user device. In various embodiments, the first-round team matchups can be automatically loaded or manually inputted by users. For later rounds and team scores, users may type in team names using a user interface, select from an auto-populated menu, such as a drop-down menu, or otherwise input information. This data can then be saved in non-transitory computer readable memory.

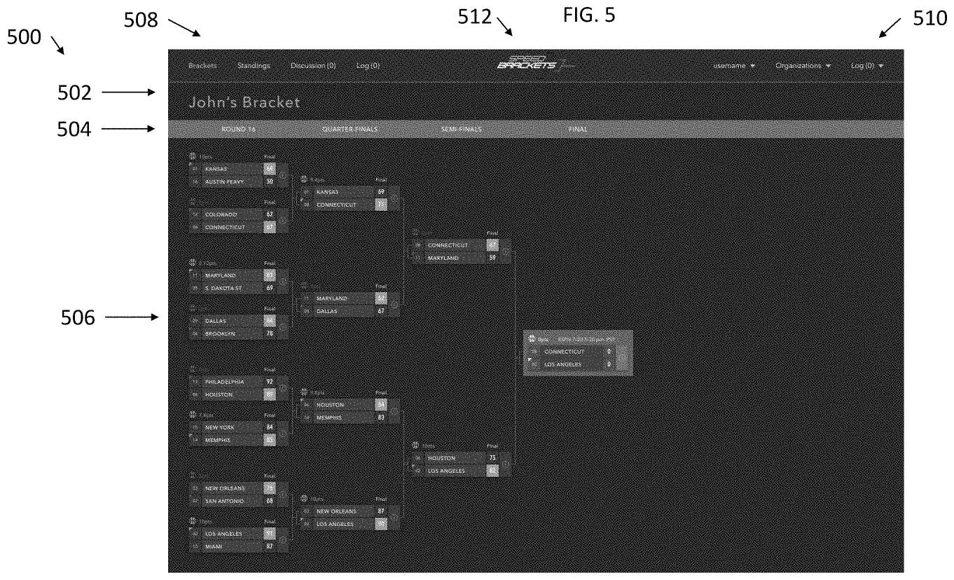

FIG. 5 shows an example embodiment diagram 500 of a user interface bracket display screen. As shown in the example embodiment, a user may be signed in initially as described elsewhere herein and their username may be displayed in field 502. Column descriptors field 504 can include the names for each column of a bracket display field 506, including round 16, quarter-finals, semi-finals, final, and others, as appropriate. In some embodiments, selecting a system logo button 512 can take users to a home screen or menu.

Also shown in the example embodiment are a series of user-selectable buttons 508 can include brackets, standings, discussion, log, or others. Bracket button may take users to a selectable bracket listing, showing the names of a variety of brackets that the user may be playing, as described elsewhere herein. Standings button may take users to an individual standing display for the current bracket or a listing of various other types of selectable standings displays, as described elsewhere herein. Discussion button may take users to a chat log for the current bracket, a global or regional chat log, or a listing of various selectable chat logs, as described elsewhere herein.

Additionally, as shown in the example embodiment, another series of user-selectable buttons 510 can include username, organizations, log, or others. Selecting a username button may display a series of username settings, information, or selectable buttons, as described elsewhere herein. In the example embodiment, this can be provided in a drop-down menu. Selecting an organizations button may display a series organization settings, information, or selectable buttons, as described elsewhere herein. In the example embodiment, this can be provided in a drop-down menu. Log button may take users to a log screen. In the example embodiment, this can be provided in a drop-down menu.

FIG. 6 shows an example embodiment diagram 600 of a user interface bracket display screen with selected winners. This can be similar to the user interface bracket display screen of FIG. 5 in general. As shown in the example embodiment, a bracket display field 602, can show each game matchup in the bracket that includes round 16, quarter-finals, semi-finals, final, and others, as appropriate. As shown in the inset 604, a single game matchup can include the names of two teams that are playing in the game, here “Houston” and “Los Angeles” in individual fields, along with each team's seed number and score next to the respective team name. A user selection indicator 606 can show that the user has selected Los Angeles to win the game. Specific colors, such as green and red, can be implemented in the system to indicate that the user has correctly or incorrectly chosen the game winner. Here indicator color 606 is green to indicate a correct selection. Game point total field 608 can be similarly colored and can recite the number of points the user has received for correctly predicting the game winner. Here it is green and lists 10 points for a correct user selection. Team names, seeds, and points for individual matchups can be colored according to game winners, game losers, point information, or other information. Lines connecting each matchup can be colored differently in different embodiments to indicate correct selections, winning teams, or other information.

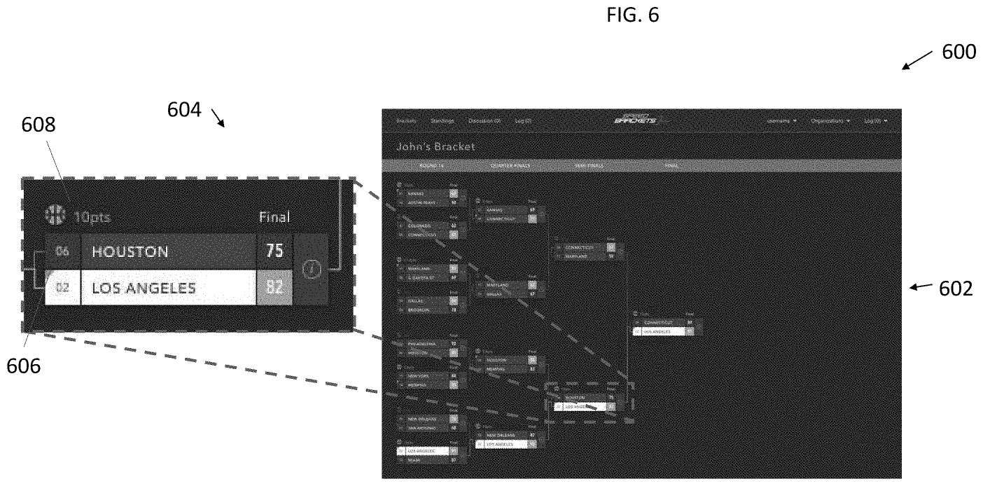

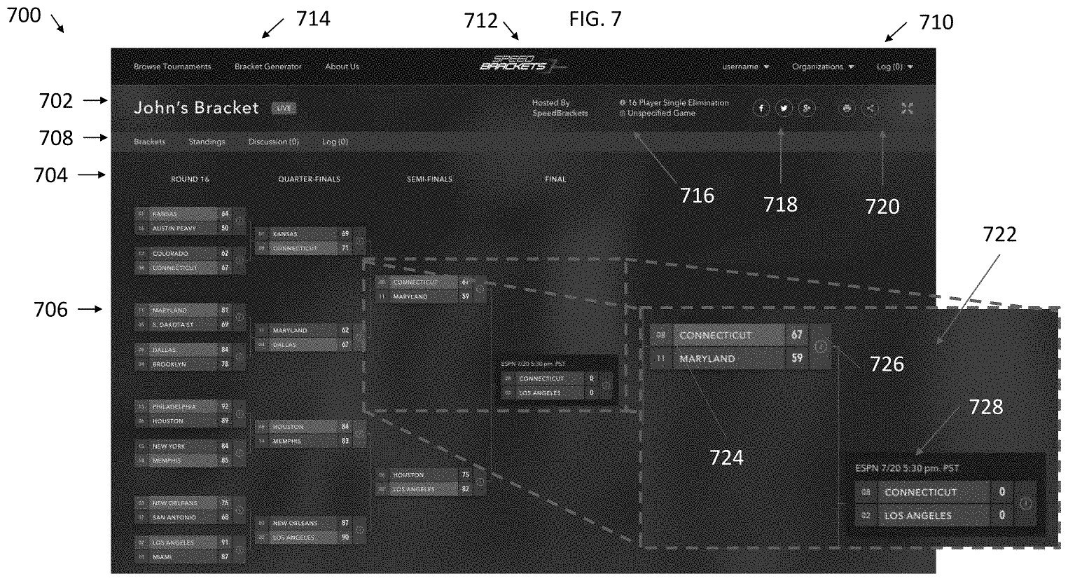

FIG. 7 shows an example embodiment diagram 700 of a user interface bracket display screen with selected winners. As shown in the example embodiment, a user may be signed in initially as described elsewhere herein and their username may be displayed in field 702. Field 702 can also include a status indicator, such as “LIVE,” to indicate that the bracket, games described in the bracket, or the tournament in general is currently occurring or temporarily on hold. Column descriptors field 704 can include the names for each column of a bracket display field 706, including round 16, quarter-finals, semi-finals, final, and others, as appropriate. In some embodiments, selecting a system logo button 712 can take users to a home screen or menu.

Also shown in the example embodiment are a series of user-selectable buttons 708 can include brackets, standings, discussion, log, or others. Descriptions of these button's functionality is given with respect to buttons 508 of FIG. 5. Additionally, as shown in the example embodiment, another series of user-selectable buttons 510 can include username, organizations, log, or others. Descriptions of these button's functionality is given with respect to buttons 510 of FIG. 5. User-selectable buttons 714 can include a browse tournaments button, bracket generator button, about us button, or others, as appropriate. Selecting a browse tournaments button may display one or more tournaments that a user may select to review. Selecting a bracket generator button may display an interactive bracket generator, as described elsewhere herein. Selecting an about us button may display information about the system operator.

Information field 716 can include information about the bracket displayed in field 706. As shown, this can include bracket host information, tournament type, and game type information. Tournament type information for diagram 700 describes that the current bracket is a 16-player single elimination type of tournament. User-selectable social media buttons 718 can allow a user to share information third party social media platforms, including: their bracket, their bracket score, their tournament score or information, or others, as appropriate. User-selectable buttons 720 can include a print button that will allow a user to print their bracket, a settings button that will allow users to adjust one or more settings, a sizing button that will allow the user to change a viewing mode or size of their bracket onscreen, or others, as appropriate.

Inset 722 shows information related to multiple matchups. As shown in the example embodiment, for games that have already been completed, a status indicator 724, which can be color shading can be provided to indicate a winning team, losing team, or both. A user-selectable information button 726 can provide information such as game statistics for previously completed games, or other statistical information, probability information, or others for games that have not yet occurred. For games that have not yet bet played, network information, date, time, and others can be provided in information field 728.

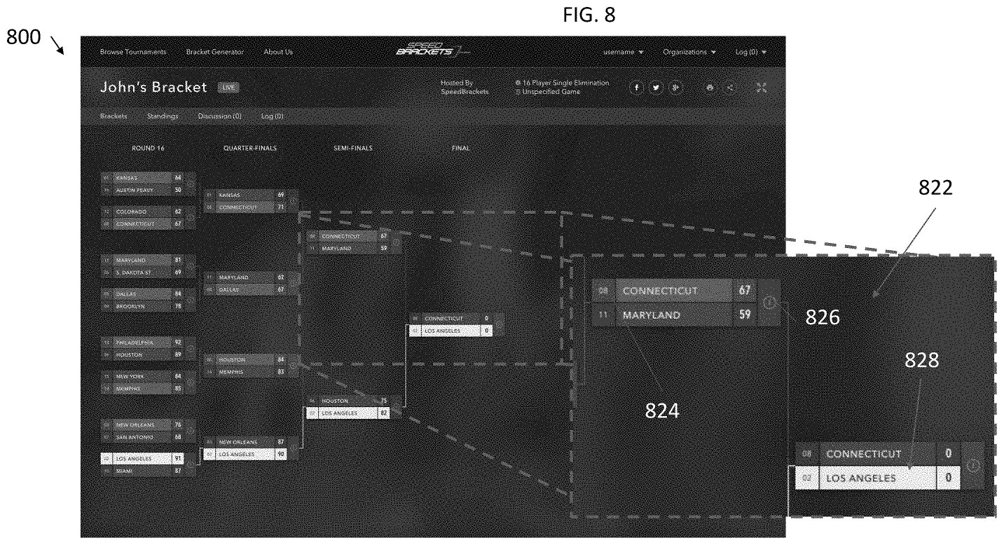

FIG. 8 shows an example embodiment diagram 800 of a user interface bracket display screen with selected winners. Inset 822 shows information related to multiple matchups. A user-selectable information button 826 can provide information such as game statistics for previously completed games, or other statistical information, probability information, or others for games that have not yet occurred. A selection indicator 828 can be a color indicating the team that the user currently has selected to win a game that has not yet been played.

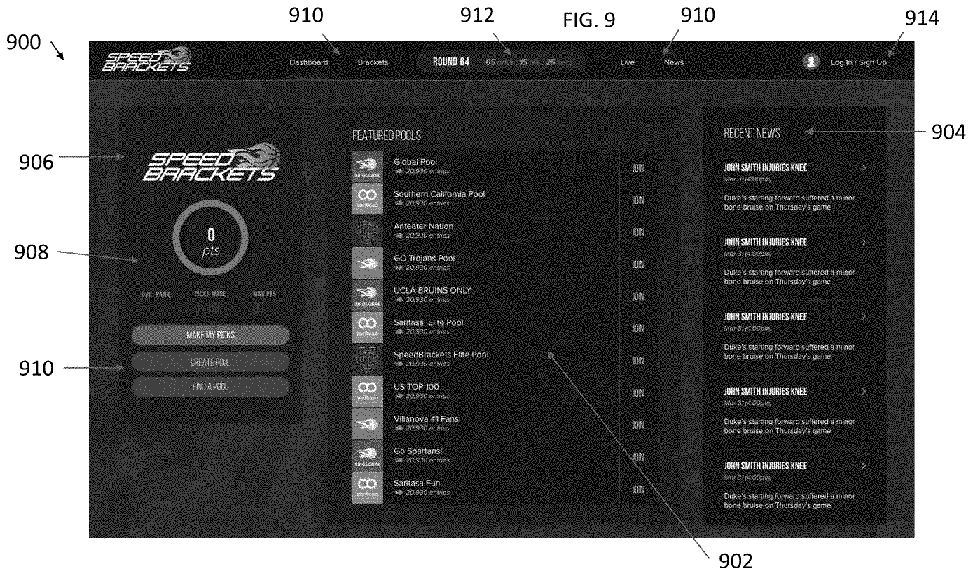

FIG. 9 shows an example embodiment diagram 900 of a user interface home display screen. As shown in the example embodiment, users can view and select a listing for one or more pools featured pools listing 902, which can display a featured pool name, number of entries, avatar, name, and other information. A recent news listing 904 can automatically or manually load recent news articles or information snapshots related to games being played in the tournament.

As shown, a miniature or limited dashboard field 906 can display bracket information for a current bracket, including points field 908 and user-selectable buttons 910. Points field 908 can include graphical indicators, numerical information, overall rank information, number of picks made information, maximum points still available information, and others. User-selectable buttons 910 can include a make my picks button, create pool button, find a pool button, and others. Selecting a make my picks button can display an interactive bracket listing that allows the user to fill out a bracket. Selecting a create pool button can display an interactive pool creation screen. Selecting a find a pool button can display a searchable or browsable listing of pools for users to select.

Also provided in the example embodiment are various user-selectable overall buttons 910. These can include a dashboard button that will display a full user-dashboard; a brackets button that will display a bracket listing; a live button that will display live information; a news button that will display current news articles, information, or clips; and others, as appropriate. A login/sign-up button 914 can display an interactive login or sign-up screen, as described elsewhere herein.

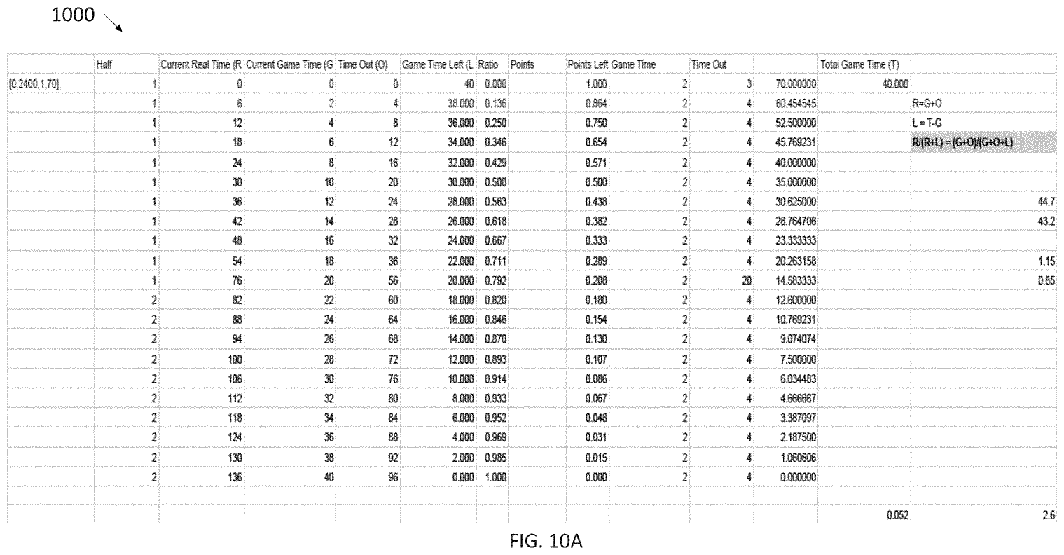

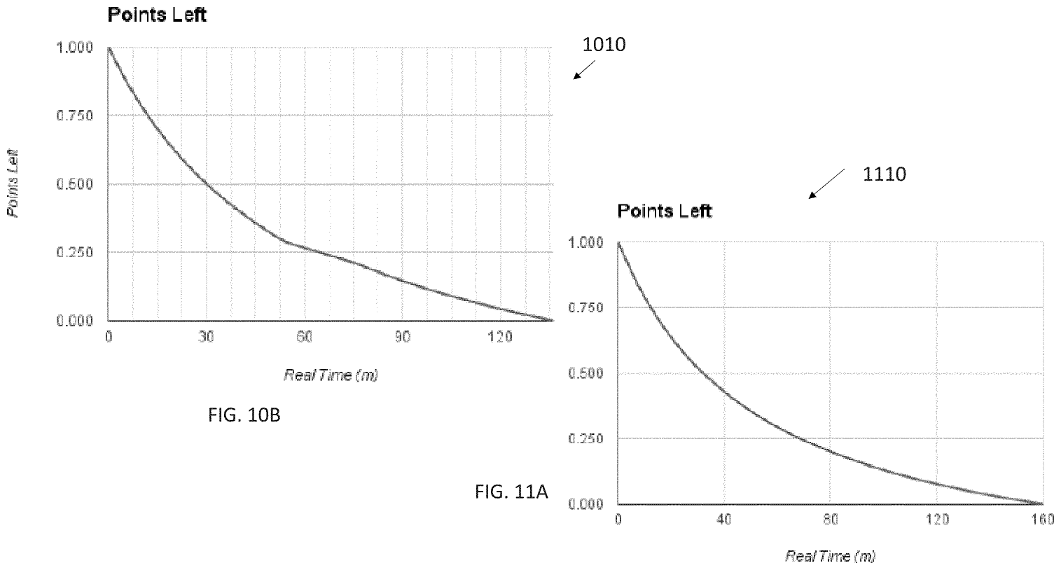

FIGS. 10A-10B show an example embodiment diagram 1000 and associated graph diagram 1010 of a time-based point calculator generation algorithm. In an example embodiment, a maximum points available to be earned or preserved for a particular matchup or a particular bracket can have a time based component. As such, these points can be related to time and limited using a decay function according to various algorithms or formulas, where a total number of points are available to begin with and then decay to 0 as time elapses. Overtime and other extraneous game related or application specific factors can also be accounted for using various algorithms.

These algorithms can be stored in non-transitory computer readable memory and when they are executed by a processor, can perform calculations in real-time in order to calculate values.

In a particular example, a first user may make a matchup selection but find out halfway through the matchup that one of the best players in the game has been injured. This may alter the user's perception of the predictable winner of the event. While in prior systems and methods the user would be locked into their static pick, in the example embodiment the user could change their pick. However, the changed pick can subject the user's choice to a reduction in potential points as compared to the scenario if the user had never changed their pick. This ability to change picks or “hedge” the user's bet provides vastly improved engagement for users, system operators and third parties.

As shown in the example embodiment 1000, column headings for factors that can affect game points earned or possible can include half, current real time (R), current game time (G), time out (O), number of time outs left or used, game time left (L), ratios, game points, and other factors can influence the total number of points that a player may be able to earn for a particular matchup selection change during a total game time (T). Here, R=G+O; L=T−G; R/(R+L)=(G+O)/(G+O+L). In the example embodiment, halves can be 1 or 2. Current real time (R) can range from 0-136. Current game time (G) can range from 0-40. Time out (O) can range from 0-96. Game time left (L) can range from 40-0.000. Ratios can range from 0.000-1.000. Game Time can be 2. Time out can range from 3-20. Total points can range from 70.000000-0.000000. For diagram 1010, points left on the y-axis can range from 1.000-0.000 and real time in minutes on the x-axis can range from 0-135. The line represents the amount of points left in the game.

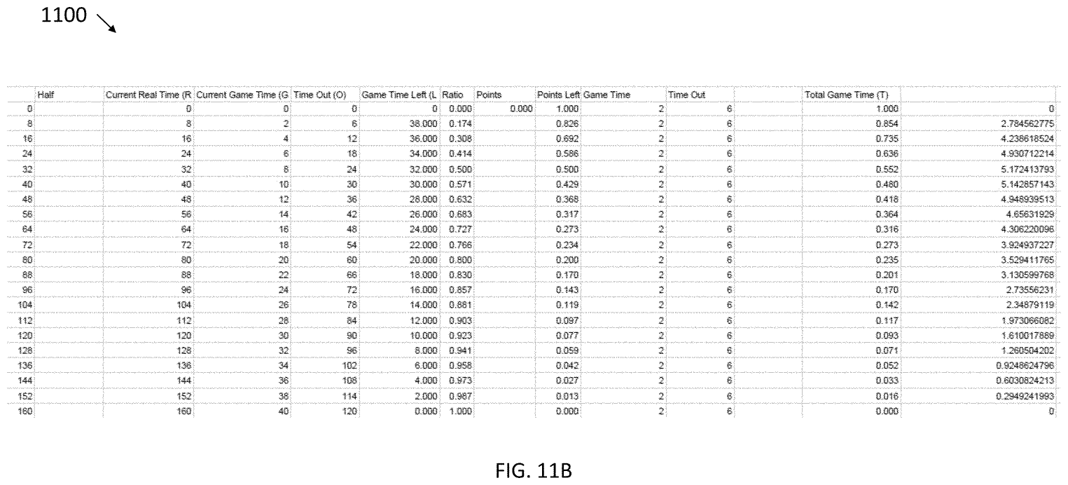

FIGS. 11A-11B shows an example embodiment diagram of a graph diagram 1110 and a diagram 1100 of a time-based point calculator generation algorithm. As shown in the example embodiment, an inverse logarithmic graph 1110 can represent the available point value decay based on a user changing their matchup winner selection. This can be inflected or modified in various manners based on differing algorithms, functions, programs or selections in various embodiments.

As shown in the example embodiment 1110, column headings for factors that can affect game points earned or possible can include half, current real time (R), current game time (G), time out (O), number of time outs left or used, game time left (L), ratios, points, points left, time out, total game time (T) and other factors can influence the total number of points that a player may be able to earn for a particular matchup selection change during a total game time (T). Current real time (R) can range from 0-160. Points left can range from 1.000-0.000. Current game time (G) can range from 0-40. Time out (O) can range from 0-120. Game time left (L) can range from 40-0.000. Ratios can range from 0.000-1.000. Game Time can be 2. Time out can be 6. Total game time (T) can range from 1.000-0.000. For diagram 1010, points left on the y-axis can range from 1.000-0.000 and real time in minutes on the x-axis can range from 0-135. The line represents the amount of points left in the game.

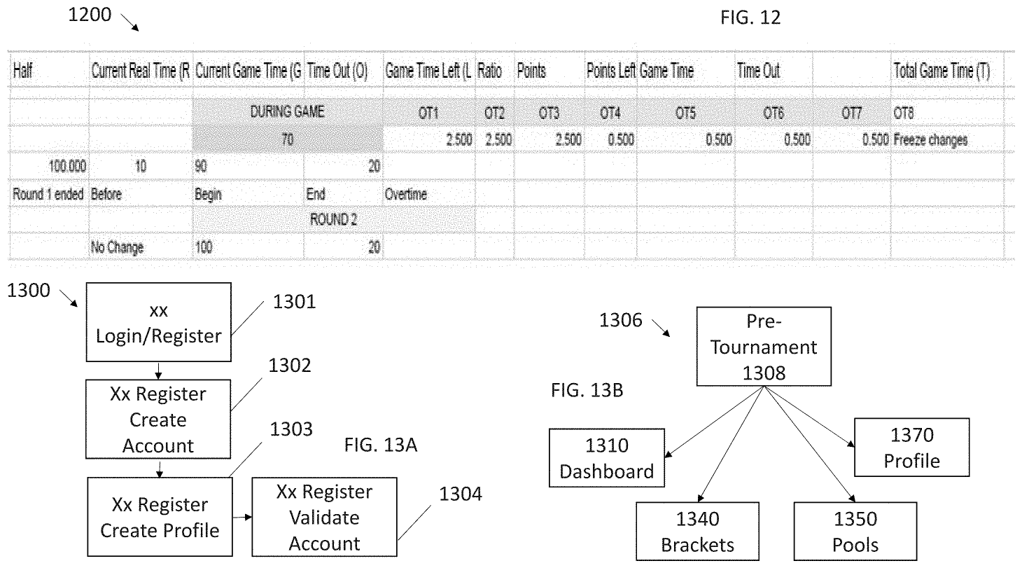

FIG. 12 shows an example embodiment diagram 1200 of a time-based point calculator generation algorithm. In some embodiments, an algorithm for a March Madness tournament bracket can use a points-earning program based on time. Time can begin to run when the first tournament game begins and last until the final tournament game ends. In other words, at the first whistle of the first game of the March Madness tournament, also called the first tip-off, and can continue running until the last whistle ends the final NCAA game in the tournament. In some embodiments, time can be measured in hours, minutes, seconds. In other embodiments, even more specific timing elements can be used, such as tenths or hundredths of seconds.

In an example embodiment, participants who have created their brackets and pools before the “tip-off” of the first tournament game may have the opportunity to gain a maximum number of points available in the tournament bracket. As such, anyone who creates a bracket or pool after the first tip-off may have fewer maximum points available to earn, since they have entered their bracket late. This lower possible total can be time based. Additionally, if a user changes, switches or otherwise modifies their bracket by selecting different winner picks during the tournament, a maximum number of points available can be penalized using a deduction in maximum available points according to an algorithm, such as a time based decay algorithm. The closer to an individual tournament game's final whistle a user's pick-switch is made, the lower the number of maximum available points that can be earned by that user, according to the algorithm. A pool winner may be the user with the most points after the last whistle of the final tournament game is blown. This can be applied in either global pools or in individual pools.

In some embodiments, the maximum available total points that a user can earn or preserve for a bracket-based tournament can be 9600. This can then be reduced in correspondence with an algorithm, which itself may have a time-based component. As tournament games and matchups are iterative, changes in game-winner selections by users can affect later games in tournament trees and their possible total earnable points as well. For instance, a change to a first round matchup winner selection by a user can affect second round and third round matchups. Users can be warned of the implications of their changes before they confirm the switch in selected winning picks.

At a high level, the goal of the bracket based tournament game systems and methods can be for individual users to correctly select each tournament matchup winning pick prior to the start of the tournament and make no changes their selections for their individual bracket. If a user wants or needs to change a pick, that user may earn more points by making their selection change earlier in the tournament rather than later since the decaying point algorithm function may help them earlier rather than later. Expressed differently, the closer to an individual game last whistle a selection switch is made, the fewer the number of points that can be earned or the more the reduction in points may occur. The winner of an individual pool may be the person with the most points at the conclusion of the last whistle in the championship or final game.

As shown in the example embodiment, halves and overtimes can be taken into account by various algorithms. During a game, 70 points can be allotted, overtime 1 can be 2.500, overtime 2 can be 2.500, overtime 3 can be 2.500, overtime 4 can be 0.500, overtime 5 can be 0.500, overtime 6 can be 0.500, overtime 7 can be 0.500, overtime 8 can freeze any further changes. If no changes are made, a user can earn a full 100.000 points. If changes are made, 70 points can be earned.

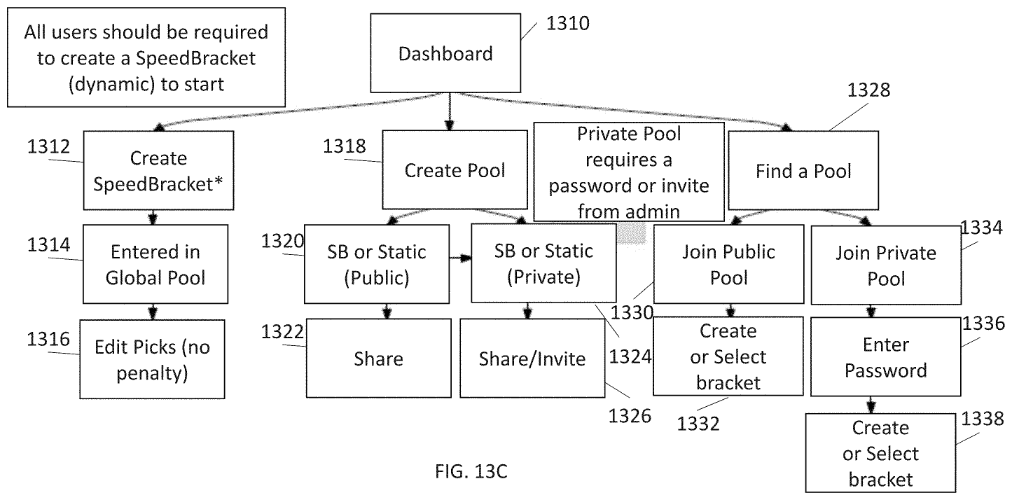

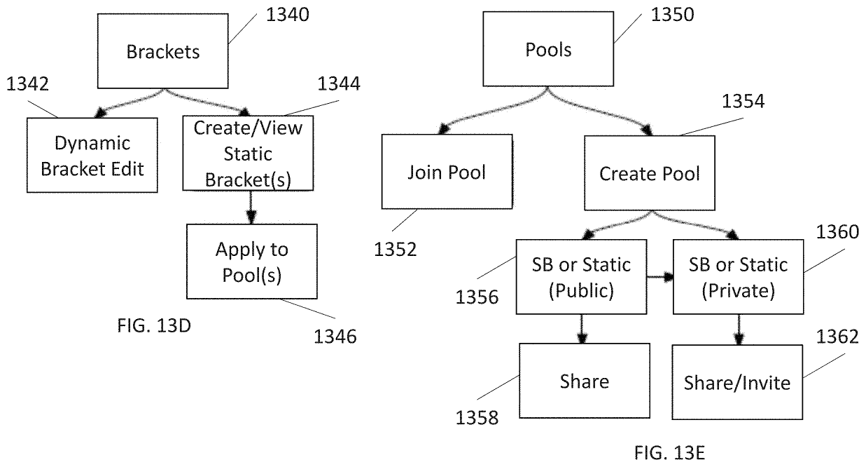

FIG. 13A shows an example embodiment diagram 1300 of an account registration flowchart. As shown in the example embodiment, a user can select a login/register button in step 1301. Next, they can select a register or create new account button in step 1302. Next, they can enter information to register and create a profile in step 1303. Finally, they can select an option to register or validate account in step 1304.

FIG. 13B shows an example embodiment diagram 1306 of a pre-tournament application user workflow options and navigation chart. As shown in the example embodiment, various aspects of a pre-tournament 1308 can include navigation and a variety of features. These can include dashboard 1310, as shown in FIG. 13C; brackets 1340, as shown in FIG. 13D; pools 1350, as shown in FIG. 13E; profile 1370; and others. Prior to engaging in operations for pre-tournament 1308, a user may be required to login/register/create account, create a profile, and validate the account, (e.g. as shown in FIG. 13A). Once an account has been created, aspects of a user profile 1370 that can be updated can include: a profile picture, logo or avatar, number of brackets, overall rank, number of pools, and other information.

As shown in FIG. 13C, dashboard 1310 can include creating brackets in step 1312, entering them into a global pool in step 1314, and editing picks without penalty in step 1316. In some embodiments, all users are required to create a dynamic bracket before performing other operations.

Dashboard 1310 can also allow users to create pools in step 1318, assign dynamic settings or static settings for a public pool in step 1320, and sharing the public pool in step 1322. If a user wishes to create a private pool or change a public pool to a private pool, they can do so in step 1324, after which it can be shared, or other users can be invited in step 1326. It can also include finding pools such as joining public pools and creating brackets in them or joining private pools after entering passwords and creating or selecting brackets. In various embodiments, private pools can require a user to enter a correct password or receive an invitation from a system administrator.

Dashboard 1310 can also allow users to find a pool in step 1328, which can include joining a public pool in step 1330 and then creating or selecting a bracket in step 1332. Alternatively, or additionally, users can join a private pool in step 1334, enter a password in step 1336, and create or select a bracket in step 1338.

As shown in FIG. 13D, brackets 1340 can include dynamic bracket editing in step 1342 and alternatively or additionally creating or viewing static brackets in step 1344 and applying the bracket to one or more pools in step 1346.

As shown in FIG. 13E, pools 1350 can include operability to join pools in step 1352 and create pools in step 1354. Creating pools in step 1354 can allow users to assign dynamic settings or static settings for a public pool in step 1356 and sharing the public pool in step 1358. If a user wishes to create a private pool or change a public pool to a private pool, they can do so in step 1360, after which it can be shared, or other users can be invited in step 1326.

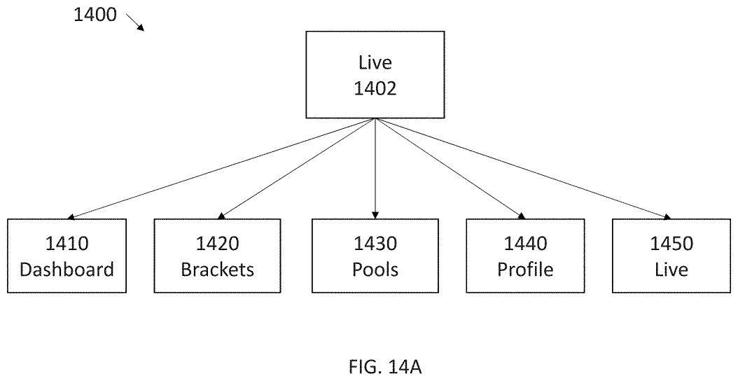

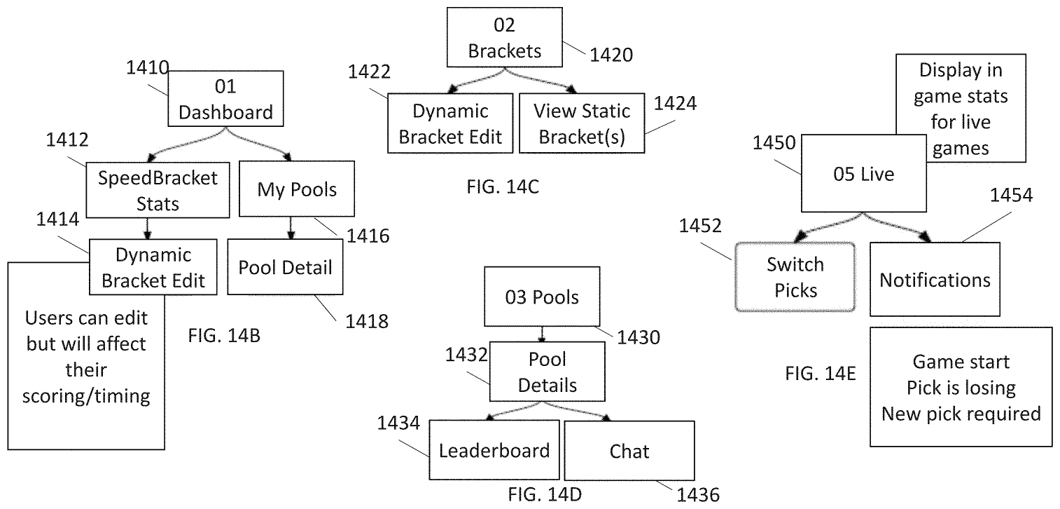

FIG. 14A shows an example embodiment diagram 1400 of a live tournament application user workflow options and navigation chart. As shown in the example embodiment this can include a dashboard 1410, brackets 1420, pools 1430, profiles 1440, live interaction 1450 and others. Once an account has been created, aspects of a user profile 1440 that can be updated can include: a profile picture, logo or avatar, number of brackets, overall rank, number of pools, and other information.

As shown in FIG. 14B, dashboard 1410 can include dynamic bracket statistics in step 1412 and dynamic bracket editing functionality in step 1414, which may affect scoring based on timing information. Dashboard 1410 can also allow viewers to view their current pools in step 1416 and individual pool details in step 1418.

As shown in FIG. 14C, brackets 1420 can include dynamic bracket editing in step 1422 and viewing static brackets in step 1424.

As shown in FIG. 14D, pools 1430 can include viewing pool details in step 1432, including leaderboards in step 1434 and chat information in step 1436.

As shown in FIG. 14E, live interaction 1450 can include displaying in-game statistics on a graphical user interface and allowing users to change or switch their picks in step 1452 and view notifications in step 1454, such as when a game is starting, when a pick is losing, when a new pick is required, or other information.

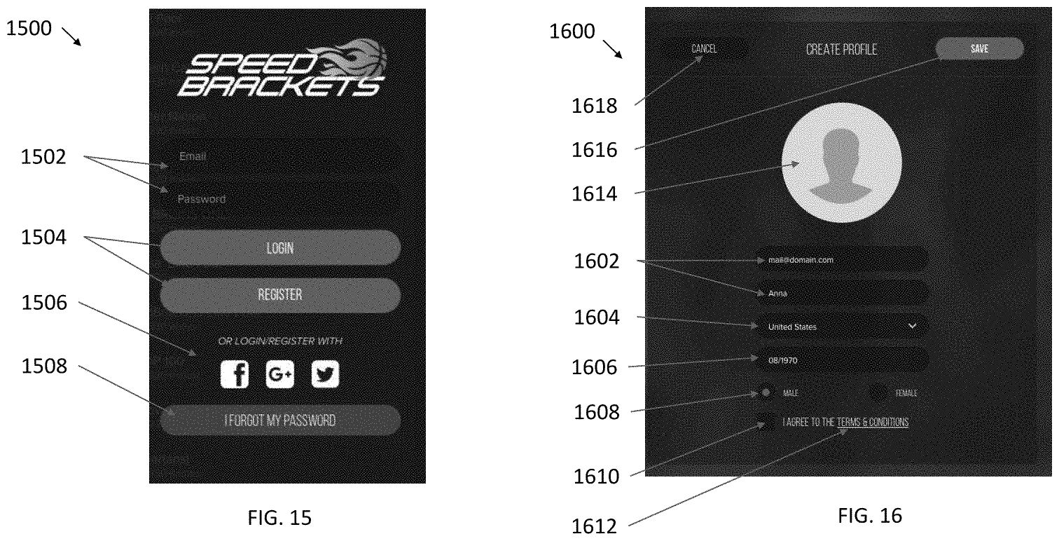

FIG. 15 shows an example embodiment diagram 1500 of a web-based user interface home screen. As shown in the example embodiment, fields 1502 allow a user to enter an email and password in order to login or register. User-selectable buttons 1504 allow the user to choose whether to login or register a new account with the system. An example of a new profile or account registration screen is shown in FIG. 16. Users can also select buttons 1506 to login or register using account information from a third-party platform, such as a social media platform. Users can also select button 1508 to receive access to their account if they forget their password or username that will cause the system to display a password recovery screen, an example of which is shown in FIG. 18.

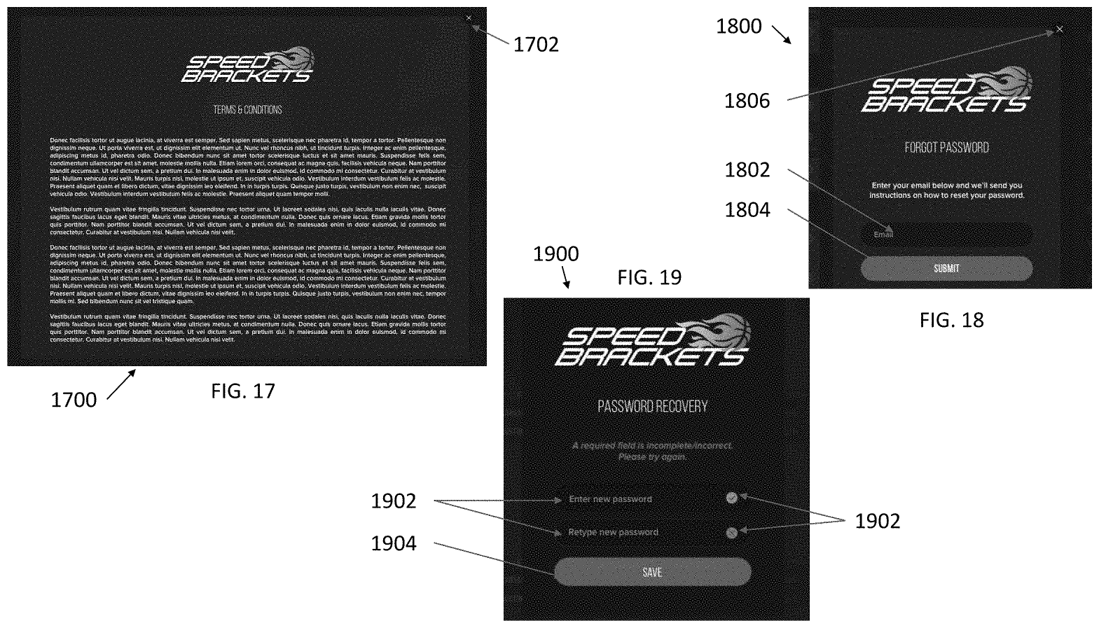

FIG. 16 shows an example embodiment diagram 1600 of a web-based user interface registration and profile creation screen. As shown in the example embodiment, fields 1602 allow a user to enter an email and username in order to register a new account. Drop-down menu 1604 allows users to select a country or region. Birthdate field 1606 allows users to input a birthdate month and year. User-selectable radio buttons 1608 allow the user to select a gender. User selectable agreement checkbox 1610 allows a user to agree to system terms and conditions. If the user wishes to review the terms and conditions, they can be displayed on the graphical user interface by selecting button 1612, an example of which can be seen in FIG. 17. Users can also upload or import a profile picture or avatar by selecting field 1614. The profile information that has been inputted can be saved in non-transitory computer readable memory by selecting the save button 1616. Otherwise, users can select a cancel button 1618 to cancel the registration operation.

FIG. 17 shows an example embodiment diagram 1700 of a web-based user interface terms and conditions information user interface screen. Users can exit the screen by selecting an exit button 1702.

FIG. 18 shows an example embodiment diagram 1800 of a web-based user interface password recovery user interface screen. As shown in the example embodiment, if the user has forgotten their password, they can enter their email address in field 1802 and select submit button 1804. This will cause the system to send an automated email to the email address entered with instructions, links, or other information related to recovering the password. Otherwise, the user can select an exit button 1806 to return to a previous screen.

FIG. 19 shows an example embodiment diagram 1900 of a web-based user interface password recovery reset user interface screen. As shown in the example embodiment, once a user has received password recovery instructions, they can enter a new password and confirm the new password in fields 1902, before selecting a save button. Indicators 1906 can indicate whether the new password meets system requirements for passwords and whether both passwords entered match.

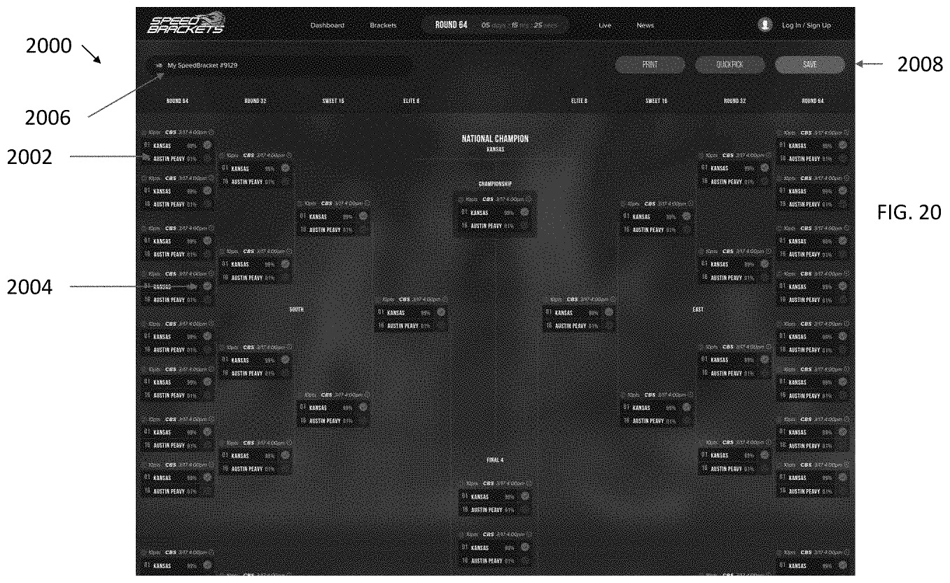

FIG. 20 shows an example embodiment diagram 2000 of a web-based user interface bracket matchup view screen. Although only an upper half of a full bracket is shown here, this can show an entire bracket that a user has created, including each of their matchup selections 2002, and chosen winners, indicated by indicator 2004. Users can enter a name in name field 2006 for each bracket they create and select buttons 2008 for printing, having automated quick-picks, and saving.

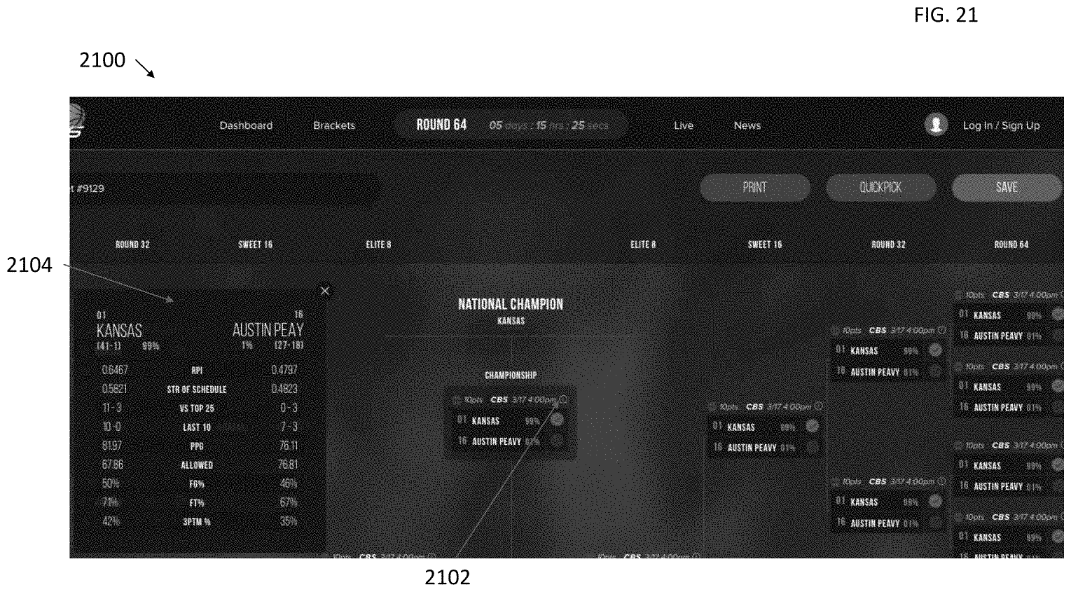

FIG. 21 shows an example embodiment diagram 2100 of a web-based user interface bracket matchup view screen within individual game information. This information can be selected and interacted with by users by selecting a matchup information button 2102, which displays informational window 2104. Here, important information can be RPI, strength of schedule, record versus top 25 teams, last ten games win/loss ratio, points per game, points allowed, field goal percentage, free throw percentage, three point shots made percentage, and others in different embodiments.

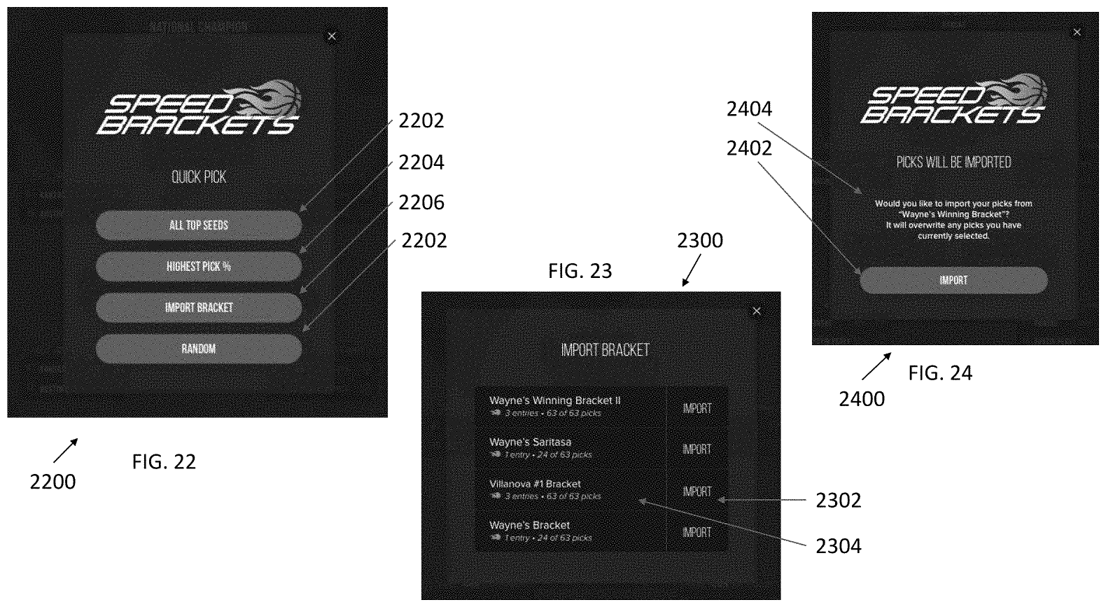

FIG. 22 shows an example embodiment diagram 2200 of a web-based user interface quick pick bracket creation screen. Users can choose various options including selecting all top seeds with button 2202, highest percentage chances to win button 2204, importing bracket button 2206, random selection button 2208, or others. Otherwise, the user can select an exit button to return to a previous screen.

FIG. 23 shows an example embodiment diagram 2300 of a web-based user interface bracket importation screen. As shown in the example embodiment, a list of previously created brackets can include selectable name buttons with a brief overview of information, each of which may be a button 2304 that is selectable. In general, these importation brackets can be pre-created bracket files that are saved in non-transitory computer readable memory, either locally or on a server. Information for each can include a bracket name, number of entries, and number of picks. Users can select an import button 2302 to import a particular bracket that can bring up an importation confirmation screen, an example of which is provided in FIG. 24. Otherwise, the user can select an exit button to return to a previous screen.

FIG. 24 shows an example embodiment diagram 2400 of a web-based user interface bracket importation confirmation screen. As shown in the example embodiment, if a user has selected a bracket for importation, the user can select a confirmation button 2402 to confirm their selection, which is described in field 2404. This will import information for the associated, named bracket. Otherwise, the user can select an exit button to return to a previous screen.

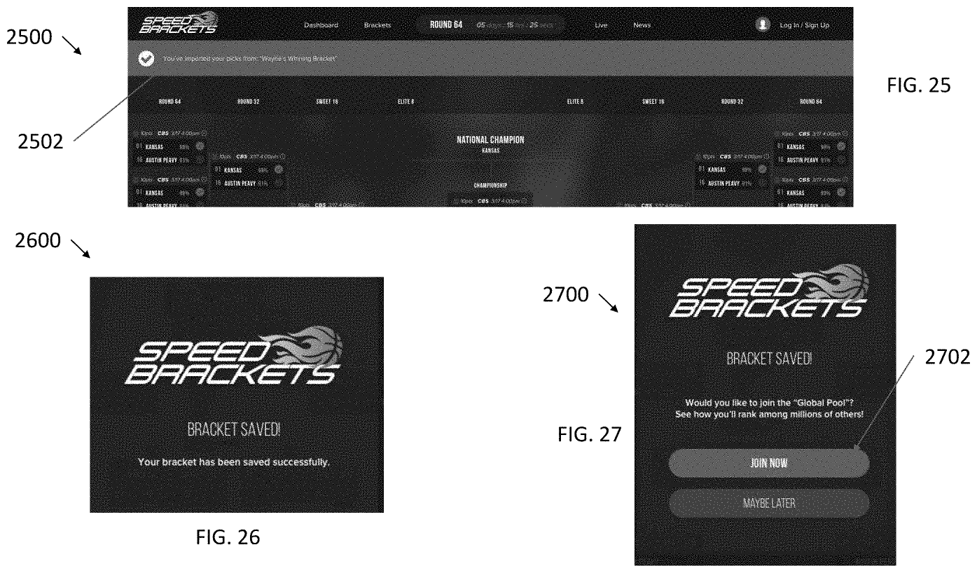

FIG. 25 shows an example embodiment diagram 2500 of a web-based user interface imported bracket display screen. As shown, if a user elects to import a previously created bracket, the system can save it to non-transitory memory and display a confirmation field message 2502 and display the bracket choices made by the user.

FIG. 26 shows an example embodiment diagram 2600 of a web-based user interface saved bracket screen. As shown, the system can display a confirmation message if a user successfully creates a portion or all of a bracket and saves it to non-transitory memory. In some embodiments, this can be done on a local machine, while in others, a user device can transmit bracket related data to one or more servers for saving via a computer network.

FIG. 27 shows an example embodiment diagram 2700 of a web-based user interface competition joining screen. As shown in the example embodiment, a confirmation message can be displayed after a user has saved a bracket and a prompt can ask the user if they want to join one or more pools. The user can then select a button 2702 to join a pool or defer to a later time.

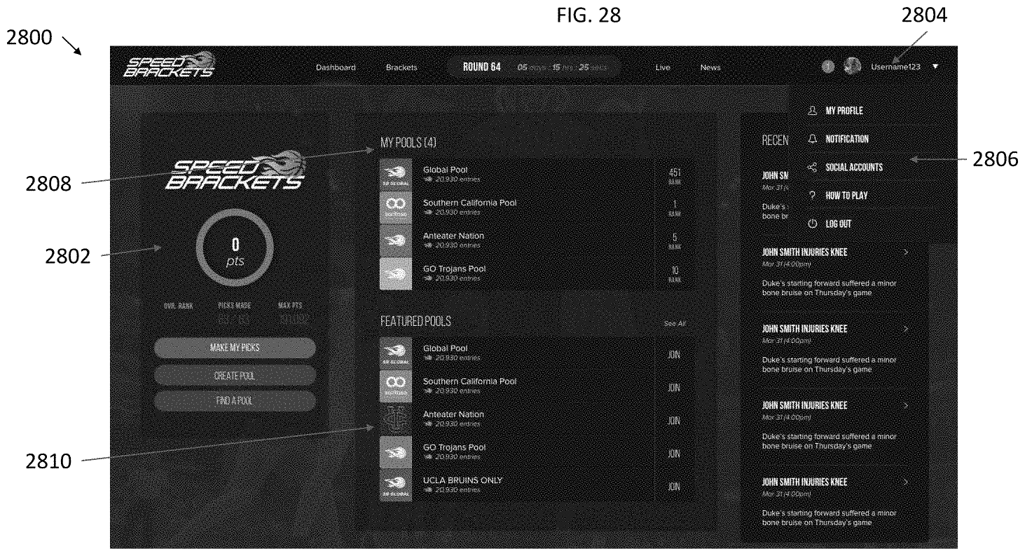

FIG. 28 shows an example embodiment diagram 2800 of a web-based user interface static bracket screen. Here, users can make matchup picks, view points, create pools, find pools, and view other information in limited dashboard field 2802, further described with respect to FIG. 9. If the user has logged in, their username and avatar can be shown in field 2804, which can also indicate whether they have any pending messages or activities. In some embodiments, the username field is selectable and can bring up a menu, such as a dropdown menu 2806 with selectable buttons for viewing a profile, notifications, social accounts, how to play information, log out, or others. Personal pools field 2808 can show names, numbers of entries, avatars, personal rankings within the pool players, and other information in some embodiments. Featured pools field 2810 can include system selected pool names, numbers of entries, avatars, allow users to join pools, or view all pools, and other information in some embodiments. Selecting a pool name can show additional information about the pool.

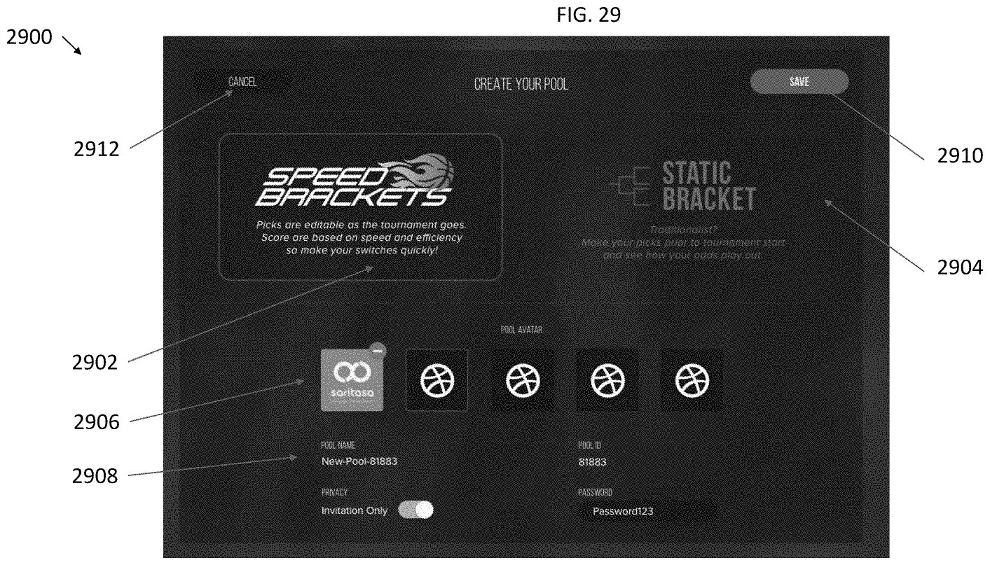

FIG. 29 shows an example embodiment diagram 2900 of a web-based user interface pool creation screen. If a user has elected to make a dynamic pool, the system can display options and information for dynamic pools 2902 as brighter, and information about static pools 2904 more dimly. Here users can include avatars 2906 and view information 2908 about pool names, select privacy buttons, view pool identifiers, enter and create passwords in a password field. Users can save the pools by selecting a save button 2910 and cancel by selecting a cancel button.

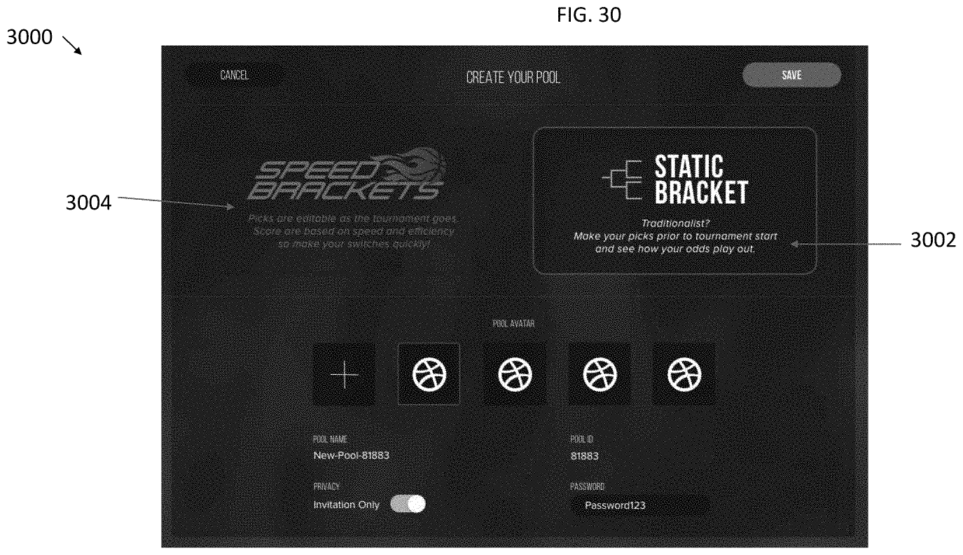

FIG. 30 shows an example embodiment diagram 3000 of a web-based user interface static pool creation screen. Here, similar description to that regarding FIG. 29 can be applied, the difference being that the system can display options and information for static pools 3002 as brighter and dynamic pools 3004 more dimly.

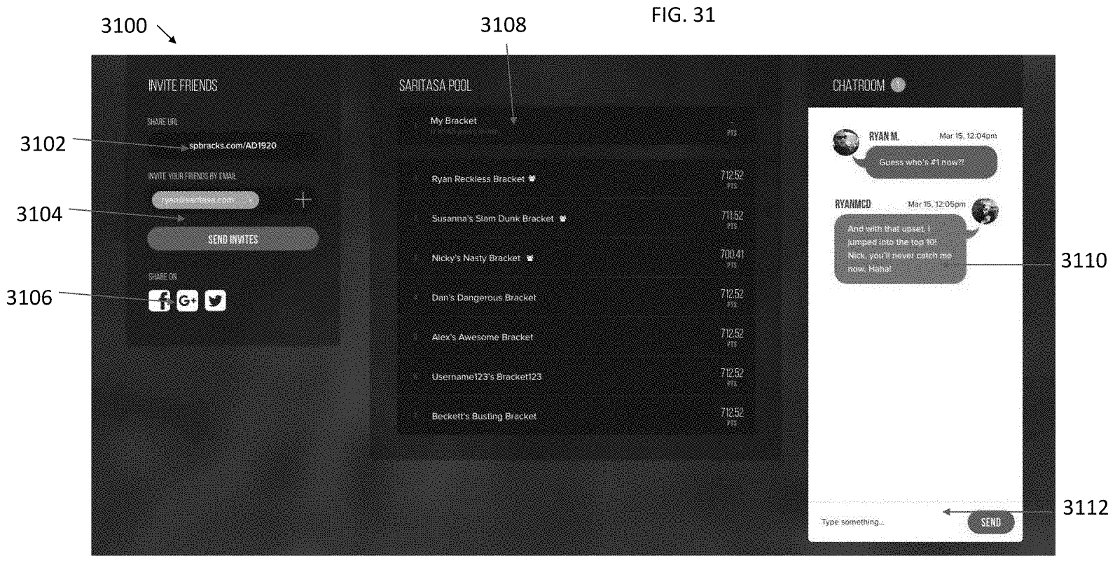

FIG. 31 shows an example embodiment diagram 3100 of a web-based user interface static pool screen with chat functionality. Here, users can share a web-based URL to a pool they have created by selecting a URL button 3102 or copying and pasting a link. They can invite friends who are system users or non-users by entering usernames, emails, phone numbers, or other information and then selecting a send button 3104. They can also send invites to friends on social media by selecting appropriate buttons 3106. Pool information can include links or user-selectable buttons 3108 that include the name of pool members, point information, or other information. When selected, they can view brackets included in the pool. A chat window or chatroom 3110 can display a transcript of a conversation between one or more users through the network, including usernames, date and time messages are sent, words, numbers, letters, punctuation, images, GIFs, videos, audio clips and others that may be sent through the system. Users can enter and send messages by interacting with chat interaction fields and buttons 3112.

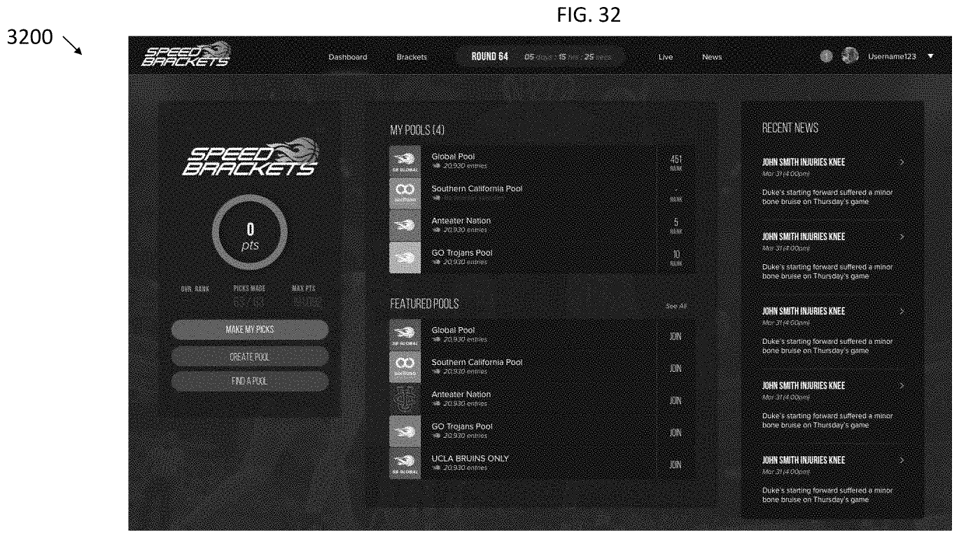

FIG. 32 shows an example embodiment diagram 3200 of a web-based user interface user home screen and dashboard prior to beginning a tournament with pools, featured pools and recent news screen. Recent news can be system based news, tournament related news, pool related news or other notifications. Information related to this screen is similar to that described with respect to FIG. 28.

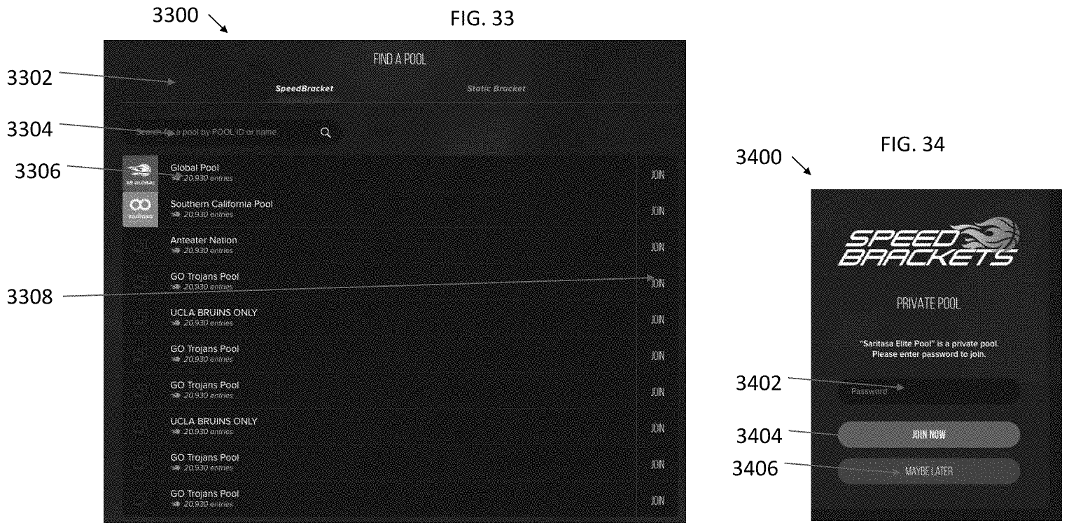

FIG. 33 shows an example embodiment diagram 3300 of a web-based user interface pool searching screen. Here users can select whether to search for dynamic or static brackets by select the associated button 3302, search for pools by entering a pool id or name in field 3304, view pool names, avatars, numbers of entries, and other information in selectable pool information buttons 3306, join pools by selecting associated join buttons 3308 and use different filters and other features in various embodiments.

FIG. 34 shows an example embodiment diagram 3400 of a web-based user interface private pool accessing screen. Here, the user can be prompted to enter a password in order to join a private pool. The user can enter a password in a password field 3402 and also select an appropriate button 3404 in order to sign access a private pool they have been invited to or otherwise want to try to access or select a button 3406 to leave the page.

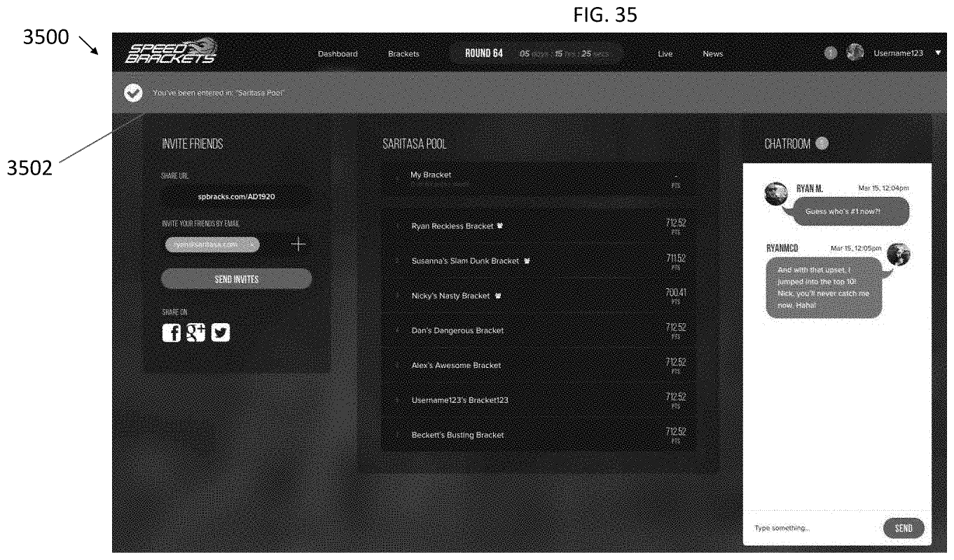

FIG. 35 shows an example embodiment diagram 3500 of a web-based user interface static pool screen with chat functionality, where users can interact with friends via the network, invite friends to join the system or their pool and view other users brackets who are in the same pool. Here, once the user enters or is entered into a pool, the system can display a notification 3502 that the user has been successfully entered into the pool. Various other functionality is similar to that described with respect to FIG. 31.

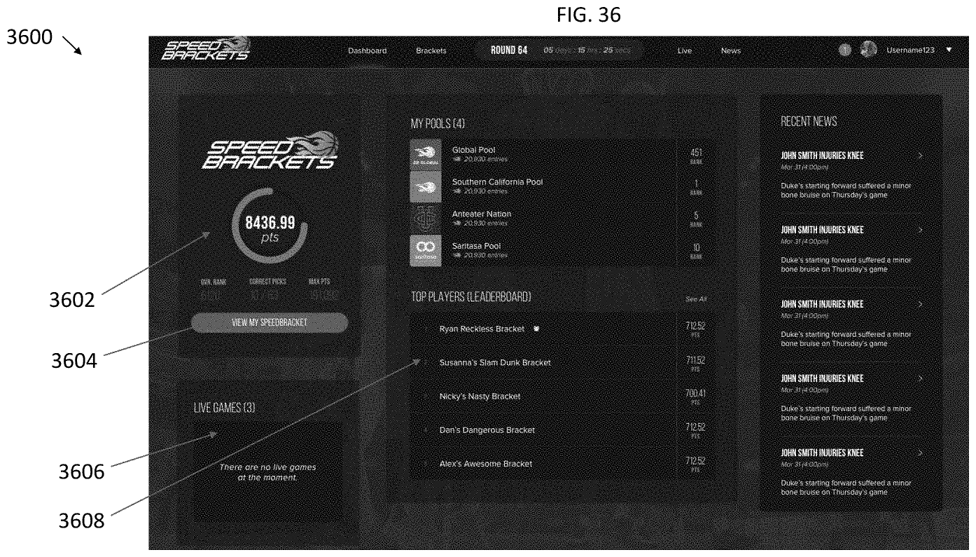

FIG. 36 shows an example embodiment diagram 3600 of a web-based user interface live home screen. Here a running total of points 3602 is shown and users can select button 3604 to view their own individual brackets. Ranking in different pools can be displayed, as well as leaderboard information 3608 for pool players. Users can also view recent news. If any live games are occurring, information about them, video feeds, audio feeds, clips, articles, scores, timing, and other information can be displayed in field 3606. Other functionality that can be included is described with respect to FIG. 28.

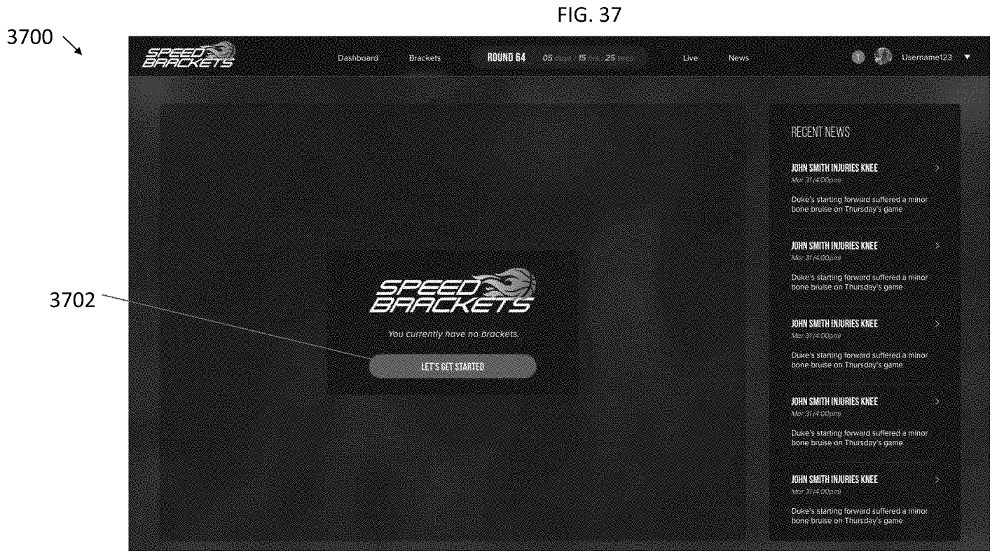

FIG. 37 shows an example embodiment diagram 3700 of a web-based user interface news screen. As shown, if the user currently has no brackets filled out, the system can prompt them to create a bracket and if a bracket creation button 3702 is selected, a bracket creation screen can be displayed.

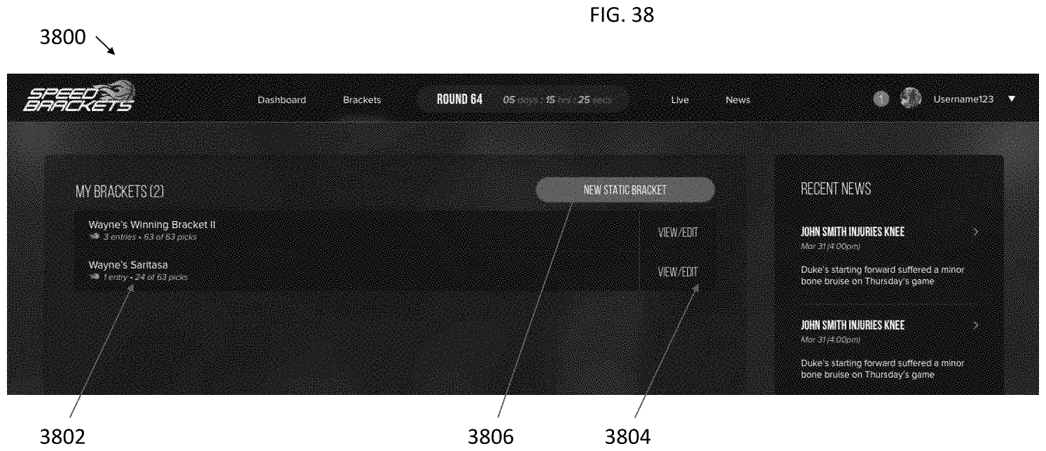

FIG. 38 shows an example embodiment diagram 3800 of a web-based user interface bracket member viewing screen. As shown, users can view a listing 3802 of their brackets by name or identifier, with information such as how many pools each has been entered in, how many picks have been made, how many successful or unsuccessful picks have been made, and other information. The user can select a view/edit button 3804 to display bracket information and change picks in dynamic brackets. They can select a new static bracket button 3806 to create a new static bracket.

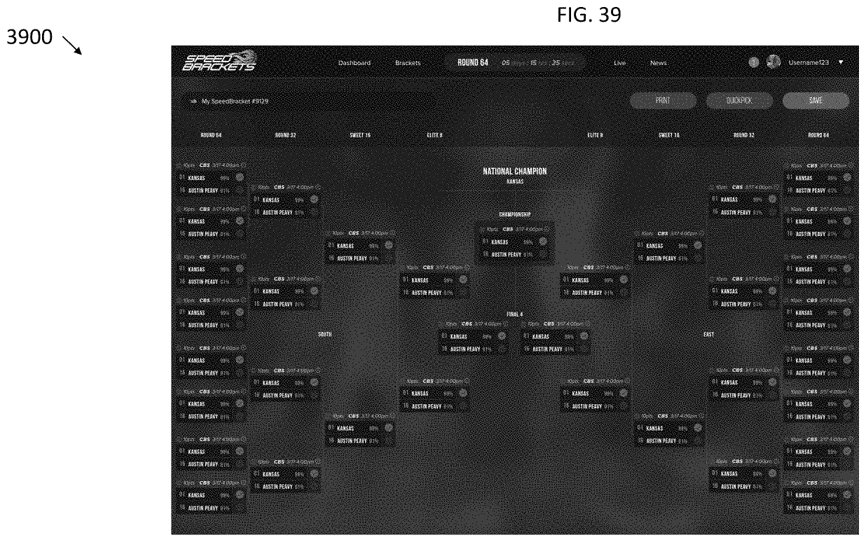

FIG. 39 shows an example embodiment diagram 3900 of a web-based user interface live bracket prior to a tournament start with all picks selected viewing screen. Here a user has selected teams to win each of the matchups possible and can print or save their bracket and can change picks by selecting or modifying them. Further description is similar to that given with respect to FIGS. 20-21.

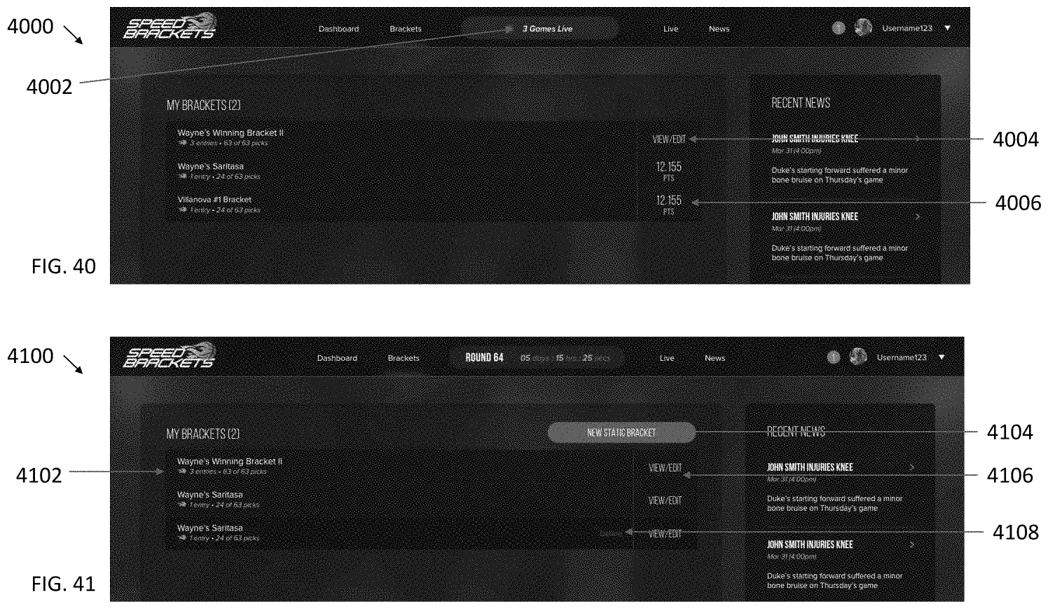

FIG. 40 shows an example embodiment diagram 4000 of a web-based user interface bracket member viewing screen with selectable button 4002 or link to a number of live games highlighted in top navigation bar. As shown, for dynamic brackets, users can select a view/edit button 4004 to view and edit their picks. For static brackets and, in some embodiments, dynamic brackets, running point totals 4006 can be displayed and brackets can be viewed after being selected.

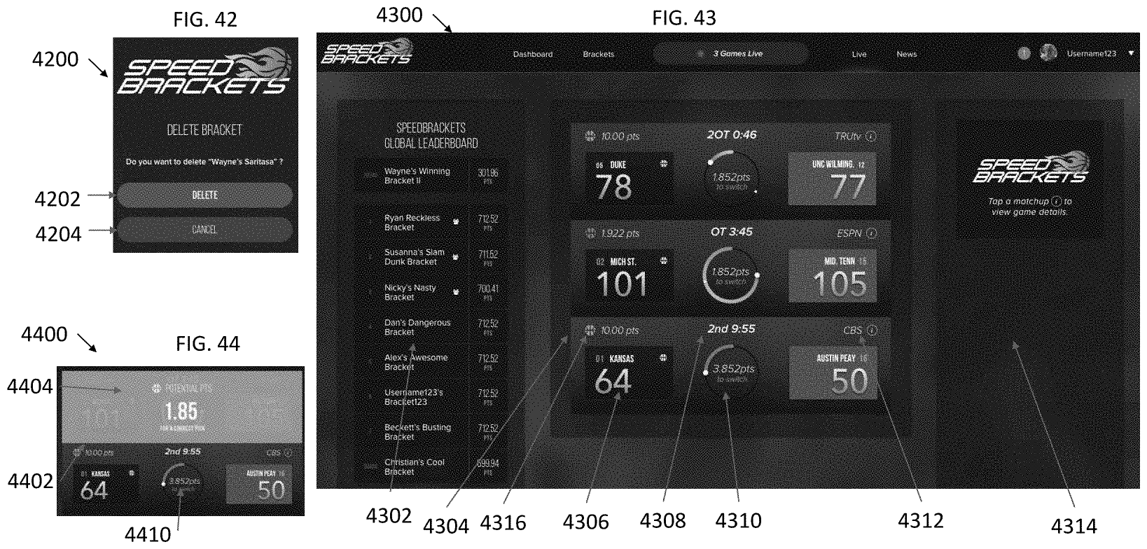

FIG. 41 shows an example embodiment diagram 4100 of a web-based user interface bracket member viewing screen with new bracket creation button 4104. Here, information about brackets can be listed in bracket listing 4102 and users can select a view/edit button 4106 to view and edit their picks. Users can also delete brackets by selecting a delete button 4108, which may then prompt the user to confirm that they want to delete the bracket, as shown and described with respect to FIG. 42.

FIG. 42 shows an example embodiment diagram 4200 of a web-based user interface bracket deletion confirmation screen. As shown, if a user selects a bracket deletion button, the system can then prompt them for confirmation that they want to actually delete the bracket, in order to avoid inadvertent deletions. Here, the user can select a delete button 4202 to confirm the deletion or a cancel button 4204 to cancel.

FIG. 43 shows an example embodiment diagram 4300 of a web-based user interface bracket live scoring screen. Here, users can view their possible points and current points for each active game. They can also view global or pool leaderboards 4302, with a listing of bracket names and running point totals. For current live games, a live game status window 4304 can include team names, rankings, currently in possession, and running point total information 4306. Status window 4306 can be selectable in some embodiments to view additional individual game information. Timing information can include a current quarter, half, overtime, running clock, and other information. Total points available for the user who has made the pick can be displayed in information field 4316. A running point differential display 4310 can show users how many points they may stand to lose if they elect to change their winning selection pick at the current time. Television information field 4312 can display information about which radio station, television channel, web site, or other coverage source the user can view the game. Information field 4314 can display system messages to the user.

FIG. 44 shows an example embodiment diagram 4400 of a web-based user interface bracket live scoring screen showing potential points. Here, users can view how many points they may sacrifice or stand to gain by changing their pick based on various system calculations that are executed according to algorithms or instructions that are stored in non-transitory computer readable memory and that are processed by a processor of the system that is server or locally based on a user device. As shown, this can be a field 4404 that covers a matchup 4402 when a user selects a button, such as a running point differential display 4410. Field 4404 can include the number of points the user may win, lose, sacrifice, or salvage based on changing a pick or other metric identifiers. This can also show point changes for later round games as well. In various example embodiments, confirmation may be required by the user in order to change a pick.

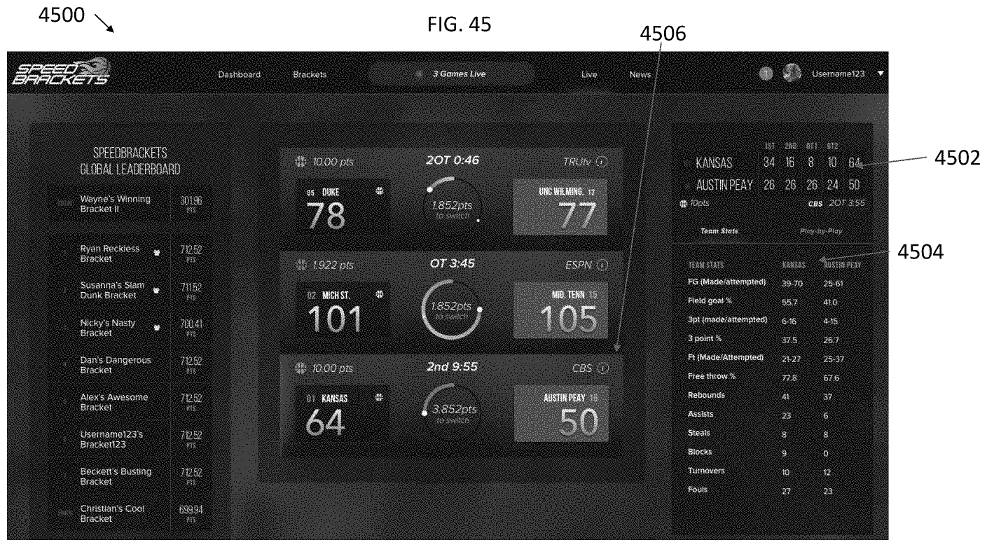

FIG. 45 shows an example embodiment diagram 4500 of a web-based user interface bracket live scoring screen showing potential points, a current user's score, a global leaderboard and listing of scores and selected game stats. Further description of these features is given with respect to FIG. 44. As shown, if a user wishes to learn more information about a particular matchup than is provided in a brief status window 4506, they can select that matchup and the system can then display more information in windows 4502, 4504. As shown, window 4502 can display point totals by quarters, halves, periods, or others, channel information, current game-time information, points won or lost by the user, and selectable team or play by play statistics. As shown in window 4504, team stats can include field goals made and/or attempted and percentage, three point shots made and/or attempted and percentage, free throws made and/or attempted and percentage, rebounds, assists, steals, blocks, turnovers, fouls, time of possession, and various other statistics.

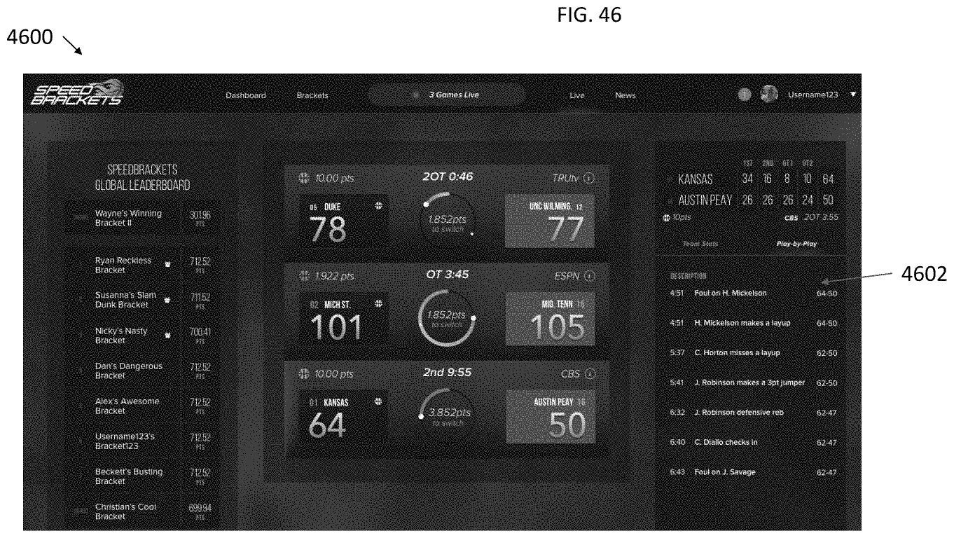

FIG. 46 shows an example embodiment diagram 4600 of a web-based user interface bracket live scoring screen showing potential points, a current user's score, a global leaderboard listing of scores and select game player statistics. Here, different point totals are shown for each game. These can include the amount of points successfully won or captured based on picks or potential picks, as well as points available for future matchups that have not occurred yet. As shown, descriptive information 4602 can be given if a user selects a play-by-play option, including players involved, time, description of the play, scoring information, and others.

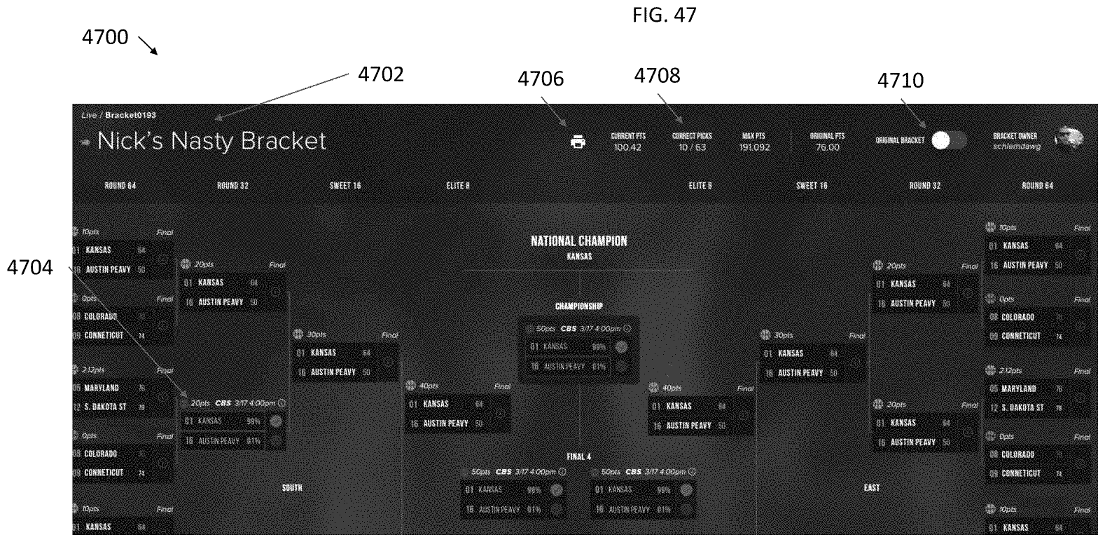

FIG. 47 shows an example embodiment diagram 4700 of a web-based user interface live bracket screen. As shown in the example embodiment, when viewing a live bracket, users can view a name of the bracket 4702 and various matchup related information 4704, including ranking, team name, chance of success, percent of users choosing a particular team to win, score, number of points won or lost by the user, success or failure of a particular pick, channel, date, time, and others. Users can select a print button 4706 to print their bracket and also view information 4708 related to how well their picks are performing in the bracket. This can include current point totals, potential point totals, correct picks versus total picks, maximum points still possible, original picks points, and others. If the user has changed their bracket or the bracket is a dynamic bracket, the user can select an original bracket button or slider 4710 to view who they originally chose and compare their changes.

FIG. 47 shows an example embodiment diagram 4800 of a web-based user interface live bracket screen. As shown, if a user elects to change any picks, their selections can be indicated by indicators 4802 and saved by selecting a save changes confirmation button 4804 or canceled by selecting a cancel button 4806.

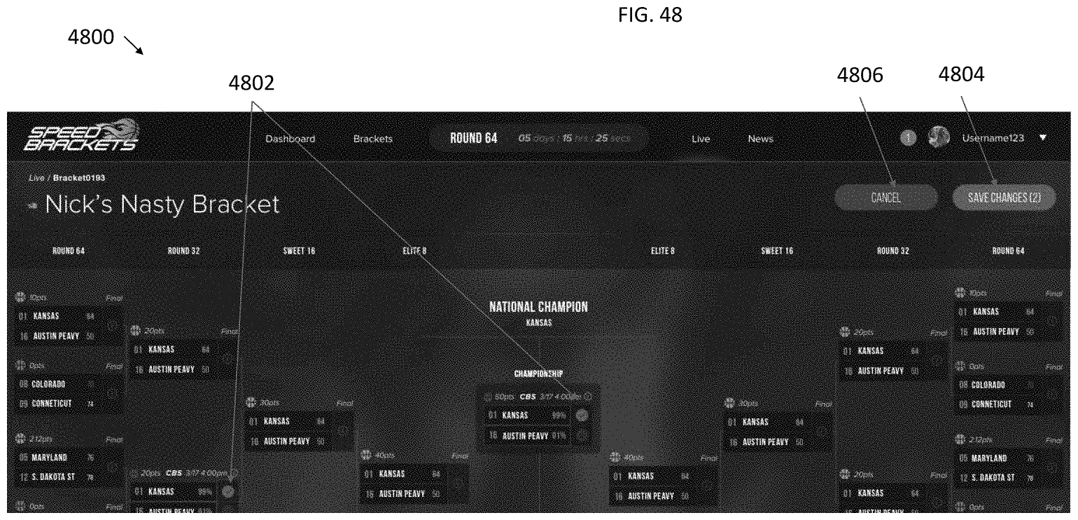

FIG. 48 shows an example embodiment diagram of a web-based user interface live bracket editing screen. Here, different colors can show current changes to matchup selections, past correct picks, past incorrect picks, and others and any current changes can be saved by selecting an appropriate button. Also shown are round indicators and time indicators.

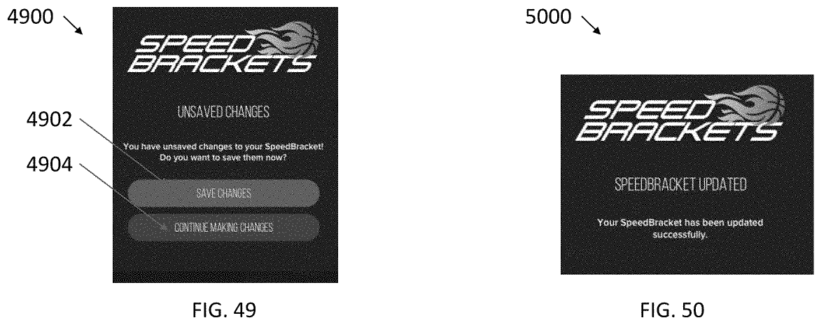

FIG. 49 shows an example embodiment diagram 4900 of a web-based user interface live bracket editing warning screen. Here, a user can elect to save changes by selecting button 4902 or leave the current screen without saving changes or to continue making changes by selecting button 4904.

FIG. 50 shows an example embodiment diagram 5000 of a web-based user interface live bracket editing confirmation screen. As shown, if the user elects to make changes, the system can display a confirmation message notifying them that their changes have been made and saved and that the operation was successful.

FIG. 51 shows an example embodiment diagram 5100 of a web-based user interface live static bracket screen. Here, current game scores are shown as well as current points, correct picks, points available, and other information. As shown, if a user's pick is eliminated in the tournament, they can be crossed off in any subsequent rounds by negative indicators 5104. Conversely, if their pick was successful, a positive indicator can be shown in later rounds.

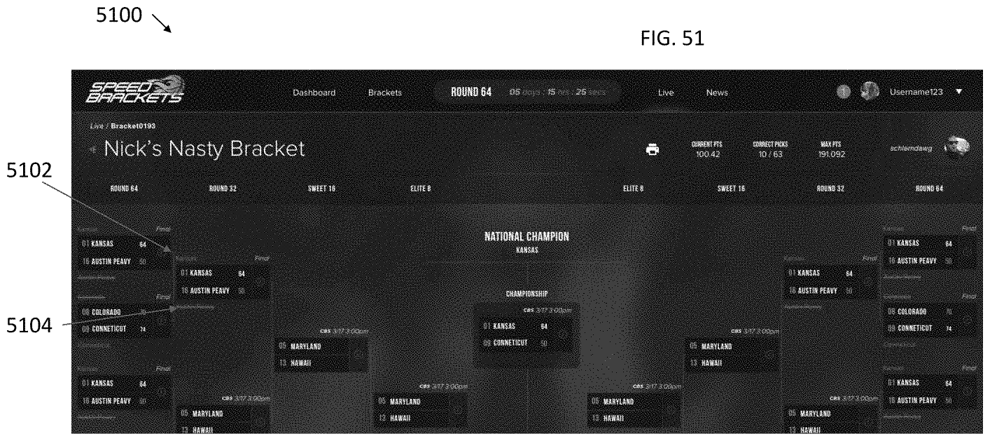

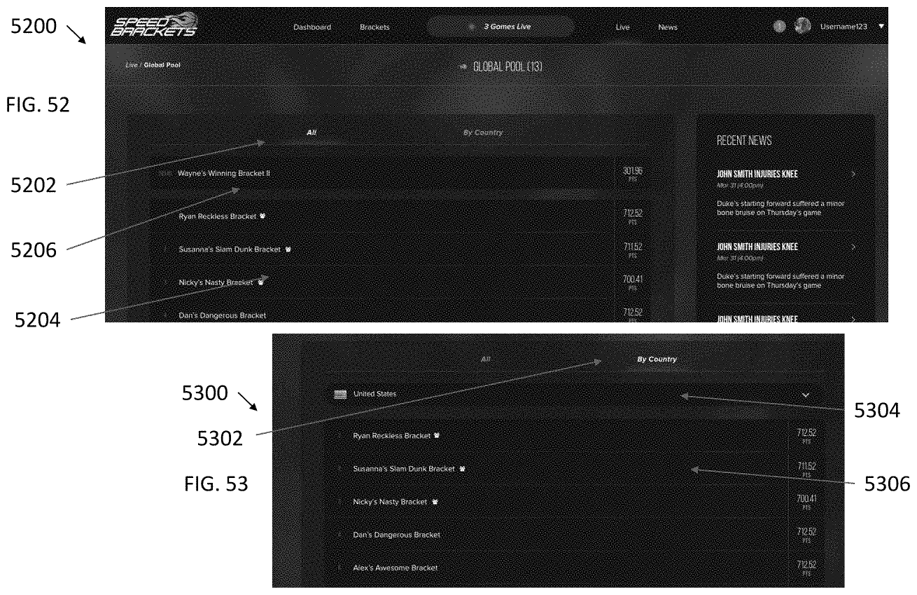

FIG. 52 shows an example embodiment diagram 5200 of a web-based user interface live global pool leaderboard screen. Here, users can view how well their bracket is performing in various pools and information displayed can include point totals and ranking information. As shown users can select whether to view all pools as selected here, or pools by country (see e.g. FIG. 53), pools by city, pools by state, pools by province, pools by county, pools by town, pools by organization or company, or other designations by selecting button 5202. Listing 5204 can include information related to brackets in a particular grouping and user bracket information 5206 can be displayed for comparison, including point totals and numeric listings based on point totals.

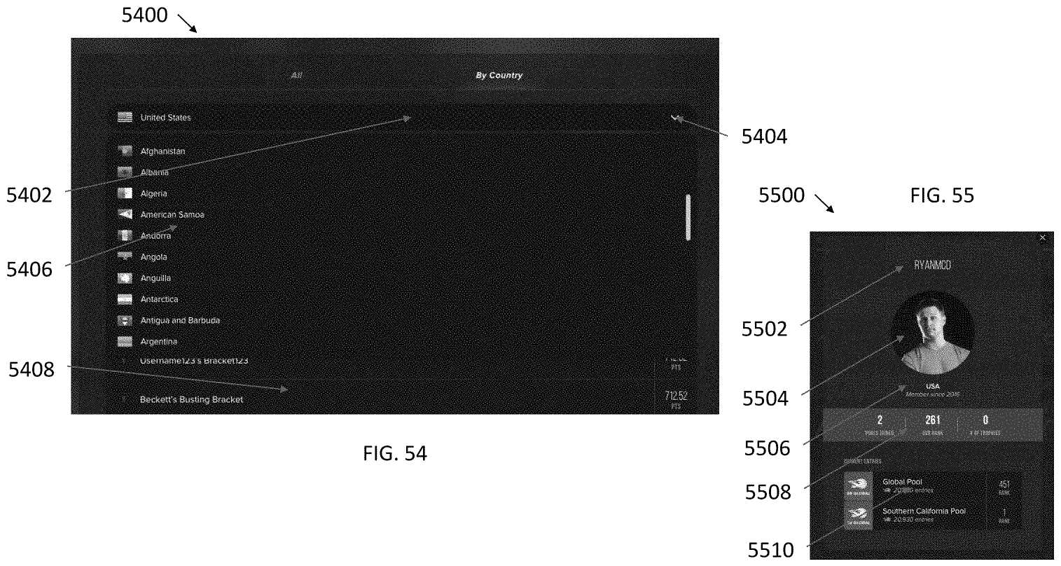

FIG. 53 shows an example embodiment diagram 5300 of a web-based user interface live country pool leaderboard screen. As shown users can select whether to view pools by country 5302 and then select a country from a dropdown menu 5304 (see e.g. FIG. 54) or other menu, along with a listing 5306 of brackets by performance.

FIG. 54 shows an example embodiment diagram 5400 of a web-based user interface live pool country leaderboard selection screen. Here, users can view how their brackets are performing against brackets of users created by users of one or more countries worldwide. As shown users can select whether to view pools by country 5402 and if they have selected a dropdown menu button 5404, a country listing 5406 can be shown over a bracket listing 5408.

FIG. 55 shows an example embodiment diagram 5500 of a web-based user interface live friend profile screen. Here, users can view how well their saved friends are performing, based on current or recent information as well as other personalized information, saved conversation threads and other information. As shown in the example embodiment a username 5502, avatar or picture 5504, country and membership age 5506 can be included. Also shown are a statistics information field 5508 that includes the number of pools joined, overall ranking, number of trophies, or other information. Additionally, current entries 5510 can include which pools the user is a member of, how many people are in the pools, and the user's rank in the pool.

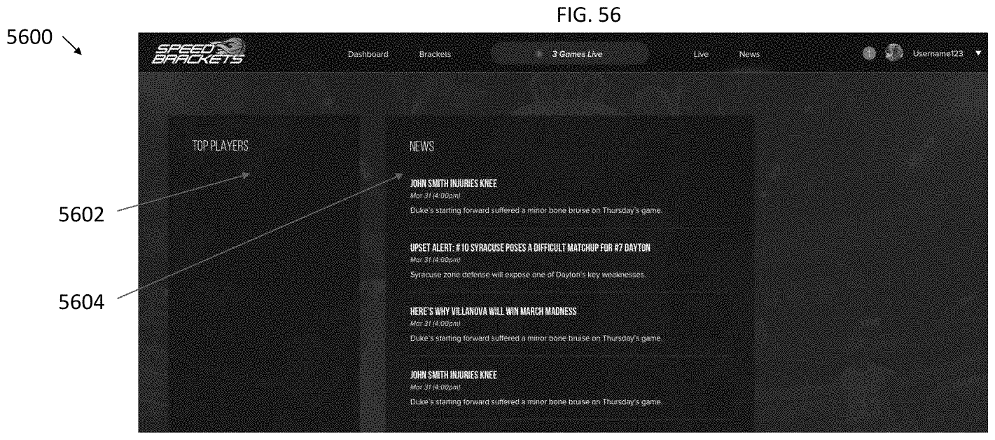

FIG. 56 shows an example embodiment diagram 5600 of a web-based user interface news screen. Here, current news information or articles can be displayed in field 5604 that may affect user's decision to keep or change picks. Additionally, top players can be listed in field 5602.

FIG. 57 shows an example embodiment diagram 5700 of a web-based user interface news notifications screen. Here, a current total points available indicator is shown, overall rank information, number of correct picks and maximum points information. Also shown are current live game scores, individual user pool information, top players and game and player based notifications. If a user selects a notifications button 5702, a listing 5704 can be displayed that includes current unread and/or previously read notifications.

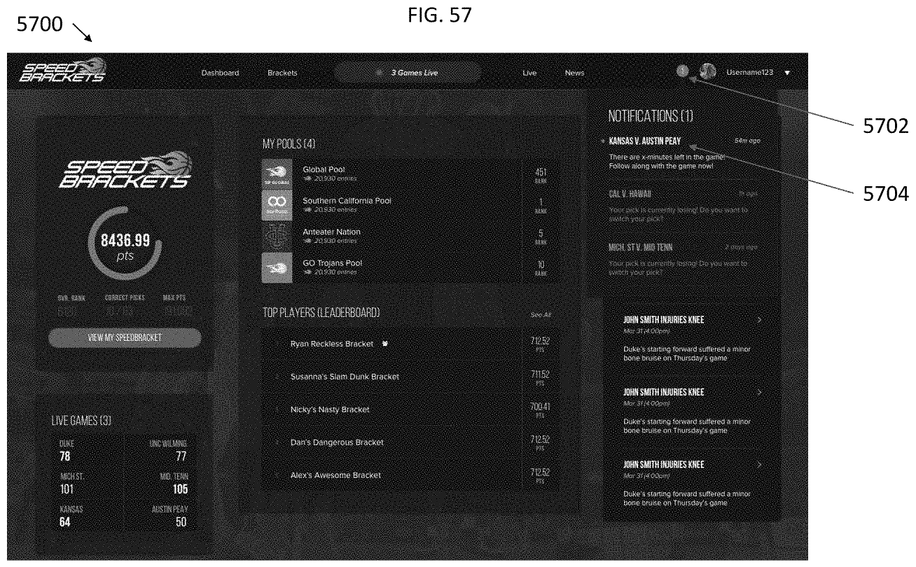

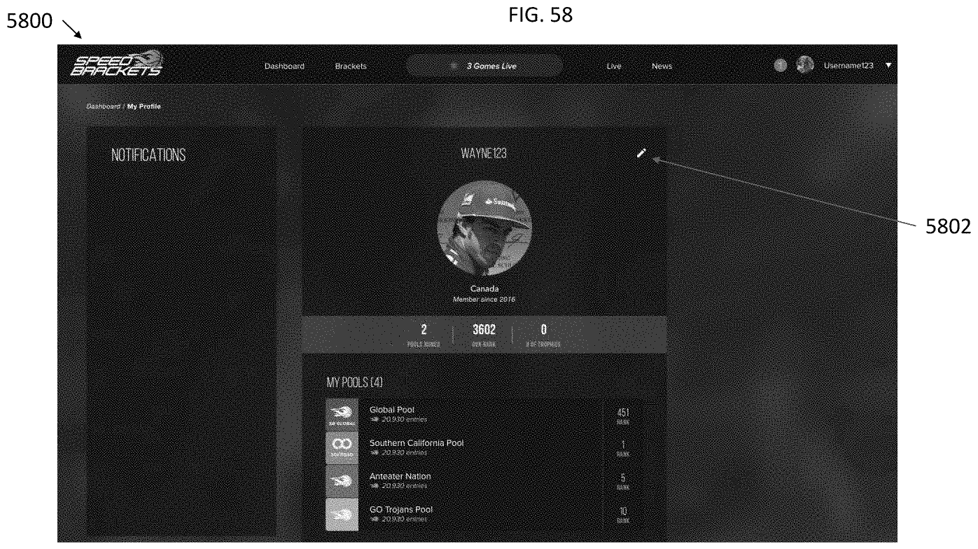

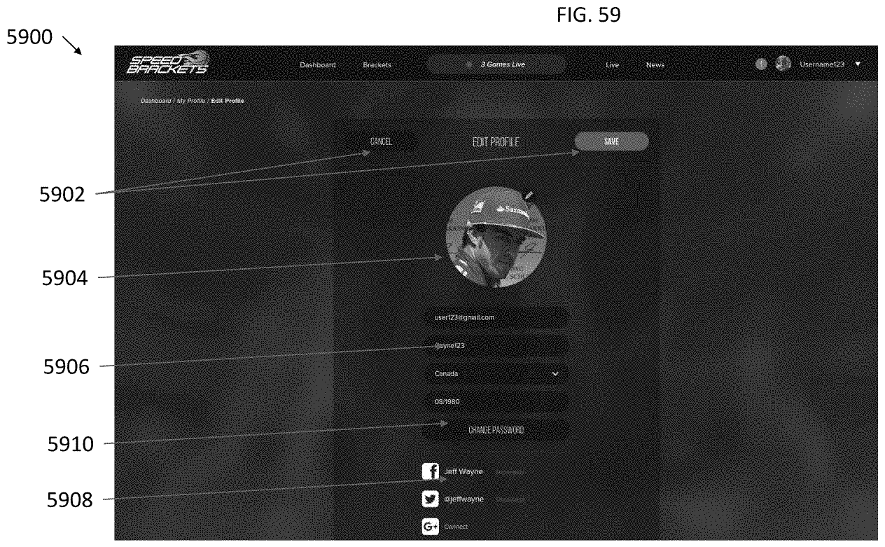

FIG. 58 shows an example embodiment diagram 5800 of a web-based user interface profile screen. Here, users can view their current profile information and select an edit button 5802 if they wish to change any profile information, which will display an editing screen, as shown in FIG. 59.

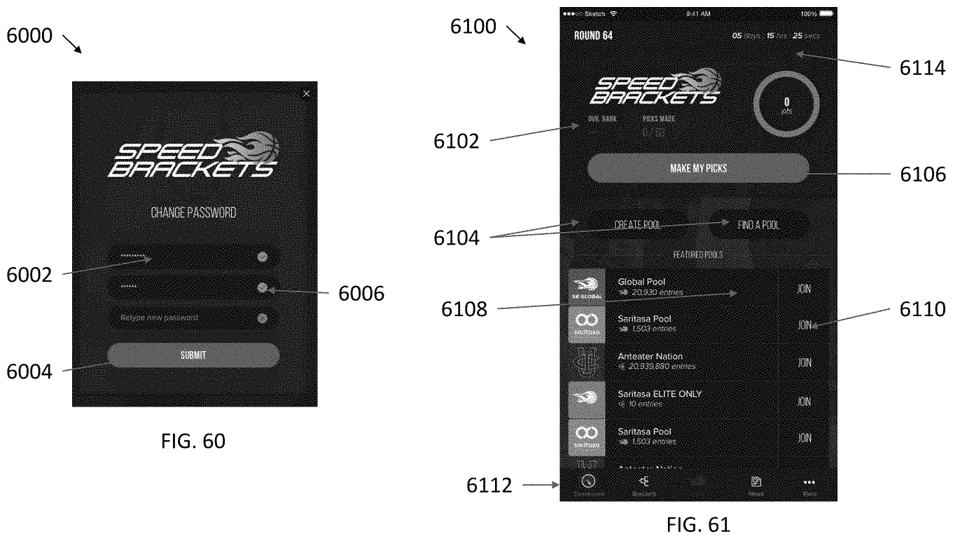

FIG. 59 shows an example embodiment diagram 5900 of a web-based user interface profile editing screen. Here, users can modify their avatar 5904 change their information in fields 5906, select buttons 5910 to change their password (e.g. see FIG. 60), link to third party websites or applications 5908, such as social media accounts and save or cancel any changes with selectable buttons 5902.

FIG. 60 shows an example embodiment diagram 6000 of a web-based user interface password editing screen. As shown in the example embodiment, users can enter their old password, a new password, and confirm the new password in fields 6002, before selecting a submit button 6004. Indicators 6006 can indicate whether the new password meets system requirements for passwords and whether both passwords entered match.

FIG. 61 shows an example embodiment diagram 6100 of a smartphone based iOS user interface dashboard screen including information field 6102 with points, ranking, picks made, and others. Users can make picks by selecting a button 6106 and create or find pools by selecting buttons 6104. Also shown are featured pools listing 6108, for selection and joining with a join button 6110, and dashboard, brackets, live game information, news, and more buttons 6112. Further, countdown information, round information and others can be shown in field 6114.

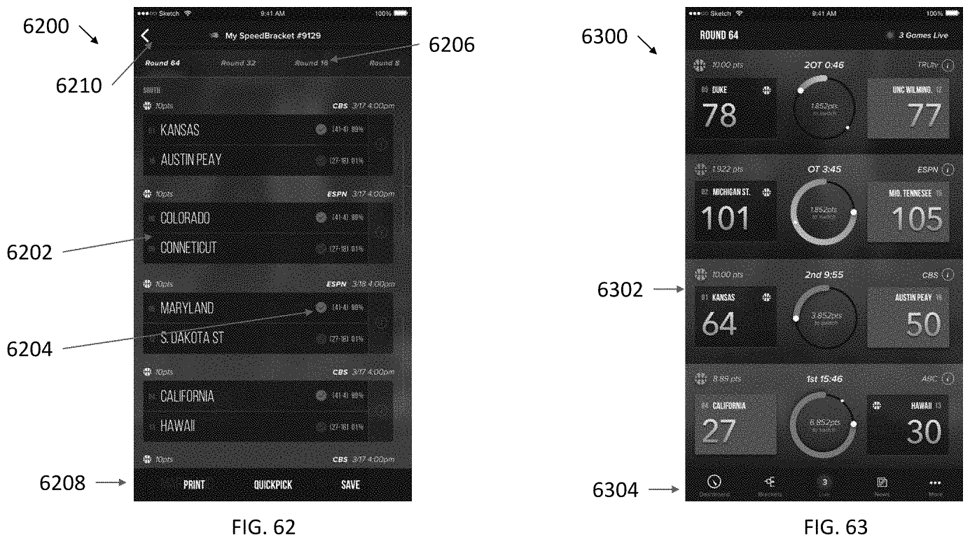

FIG. 62 shows an example embodiment diagram 6200 of a smartphone based iOS user interface bracket screen with selected picks and probability to win information. In some embodiments, third party websites or applications can be scraped or otherwise provide information directly to the system for live updates of system information. As shown, users can view and select different rounds 6206 for information on matchups 6202 and picks 6204. Users can also select buttons 6208 to print, quick-pick, or save brackets, or back button 6210 to return to a previous screen.

FIG. 63 shows an example embodiment diagram 6300 of a smartphone based iOS user interface live scoring screen. Here, users can view listings of various information for matchups 6202, including: time, scores, points available if switching picks and others. Further description is similar to that given for live game status window 4304 of FIG. 43. Additionally, users can select buttons 6304 for dashboard, brackets, live game information, news, and more buttons.

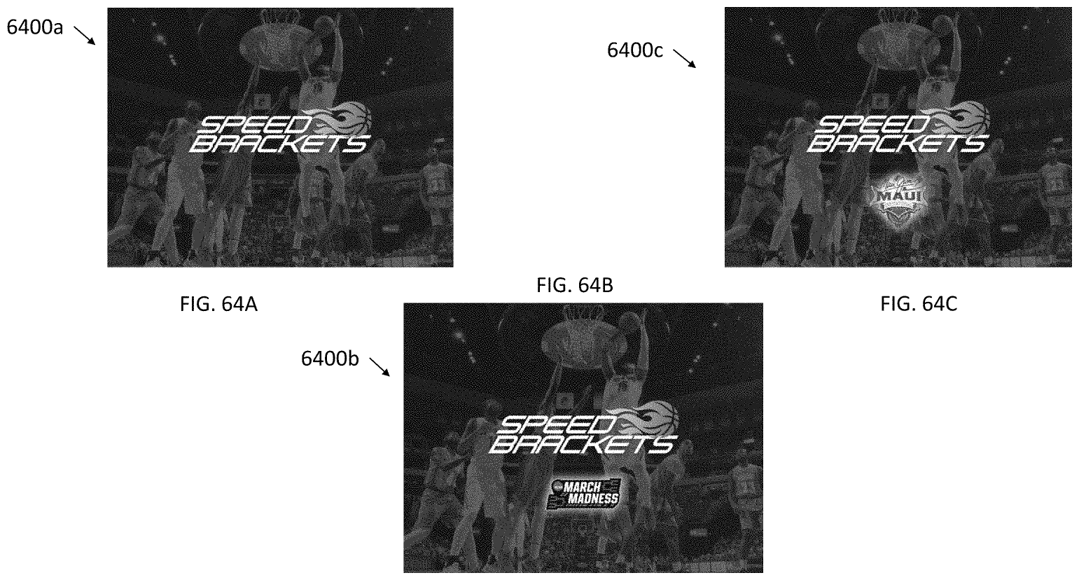

FIGS. 64A-64C show example embodiment diagrams 6400a-6400c of a tablet computer based iOS user interface generic and tournament specific home screens.

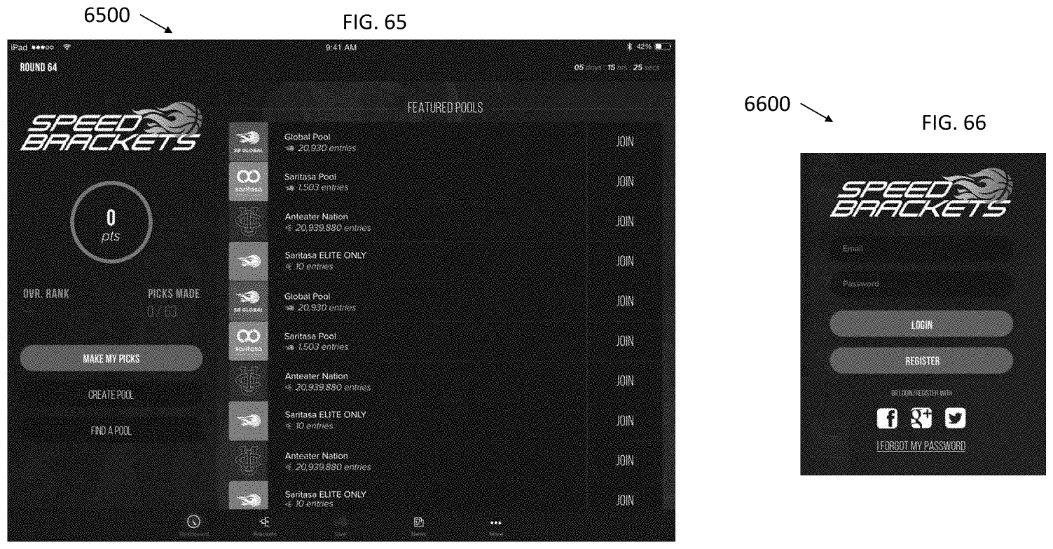

FIG. 65 shows an example embodiment diagram 6500 of a tablet computer based iOS user interface dashboard screen. Here, users can make matchup picks, view points, create pools, find pools, view personal pools, view featured pools and view news information. Description of the features of this screen is similar to that of FIG. 9.

FIG. 66 shows an example embodiment diagram 6600 of a tablet computer based iOS user interface login screen. Description of the features of this screen is similar to that of FIG. 15.

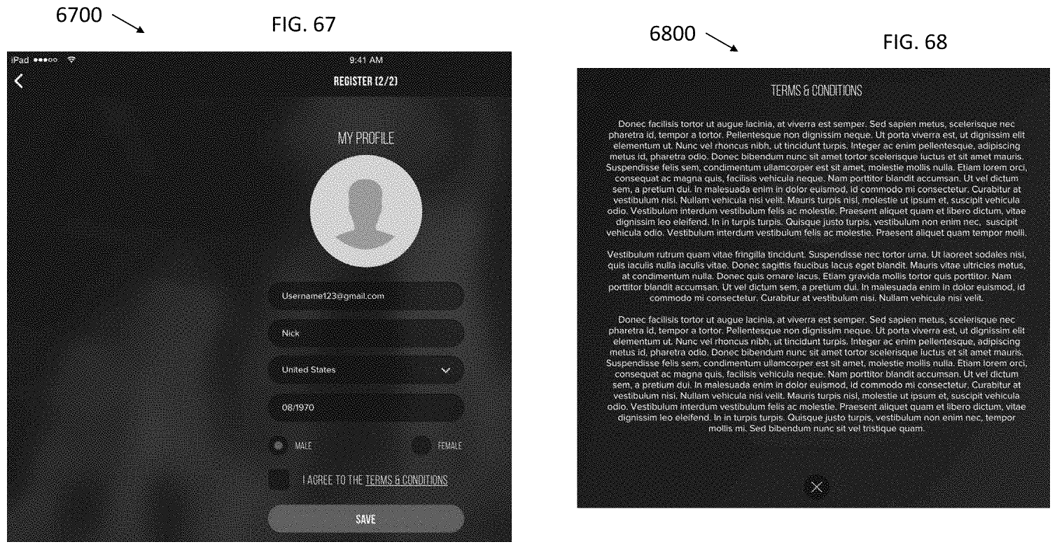

FIG. 67 shows an example embodiment diagram 6700 of a tablet computer based iOS user interface registration screen. Description of the features of this screen is similar to that of FIG. 16.

FIG. 68 shows an example embodiment diagram 6800 of a tablet computer based iOS user interface terms and conditions screen. Description of the features of this screen is similar to that of FIG. 17.

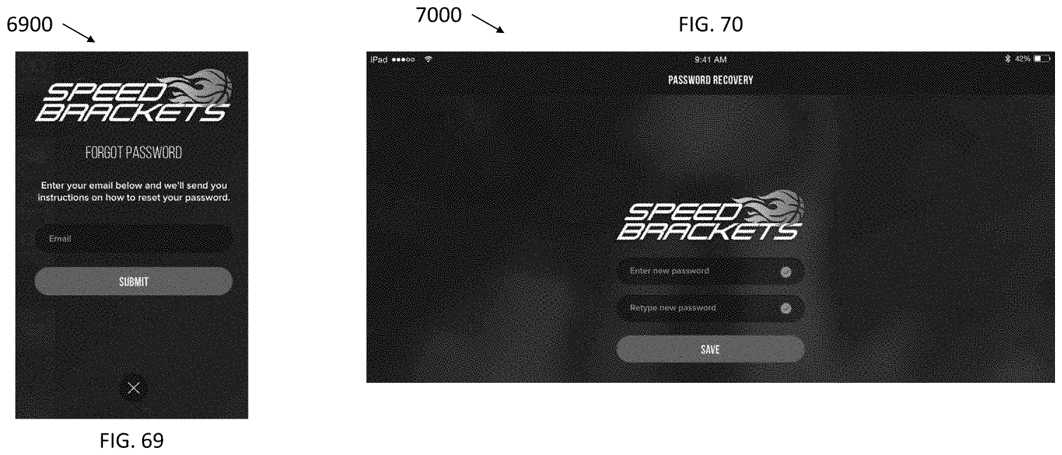

FIG. 69 shows an example embodiment diagram 6800 of a tablet computer based iOS user interface forgot password screen. Description of the features of this screen is similar to that of FIG. 18.

FIG. 70 shows an example embodiment diagram 7000 of a tablet computer based iOS user interface password change screen. Description of the features of this screen is similar to that of FIG. 19.

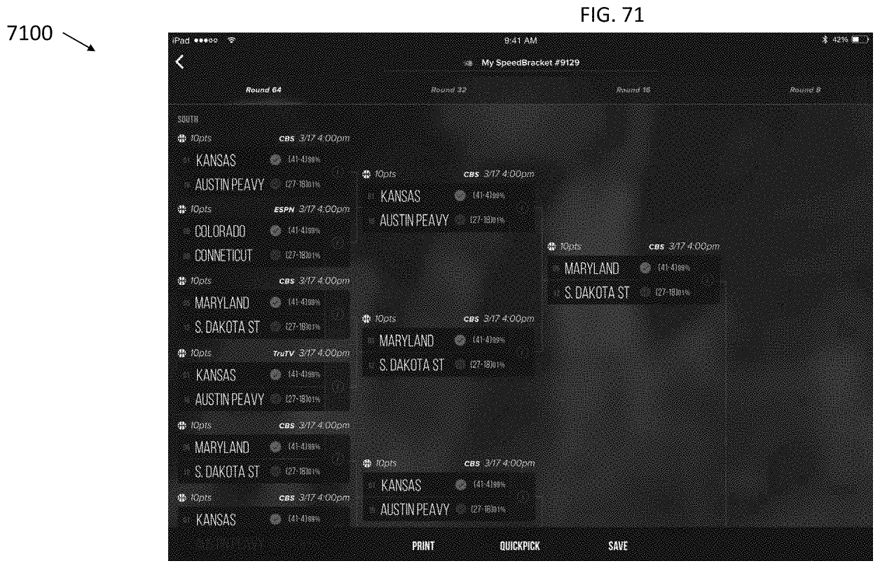

FIG. 71 shows an example embodiment diagram 7100 of a tablet computer based iOS user interface create bracket screen. Description of the features of this screen is similar to that of FIG. 20.

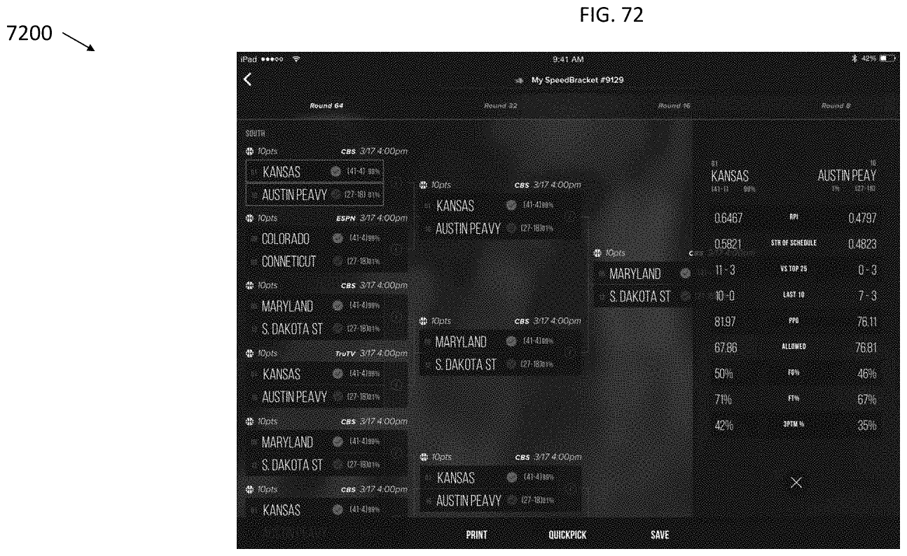

FIG. 72 shows an example embodiment diagram 7200 of a tablet computer based iOS user interface create bracket screen with select game status information in the form of statistics, time and other pertinent scoring information. This information can be selected and interacted with by users. Description of the features of this screen is similar to that of FIG. 21.

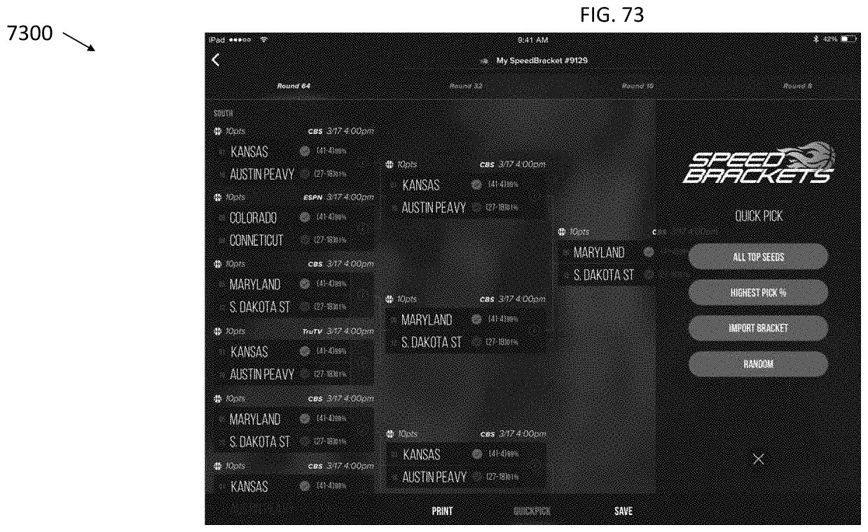

FIG. 73 shows an example embodiment diagram of a tablet computer based iOS user interface create bracket screen with a quick pick selection window. Users can choose various options including selecting all seeds, highest percentage chances to win, importing brackets or choosing bracket choices randomly. Description of the features of this screen is similar to that of FIG. 22.

FIG. 74 shows an example embodiment diagram 7400 of a tablet computer based iOS user interface create bracket screen with a bracket import window. Description of the features of this screen is similar to that of FIG. 23.

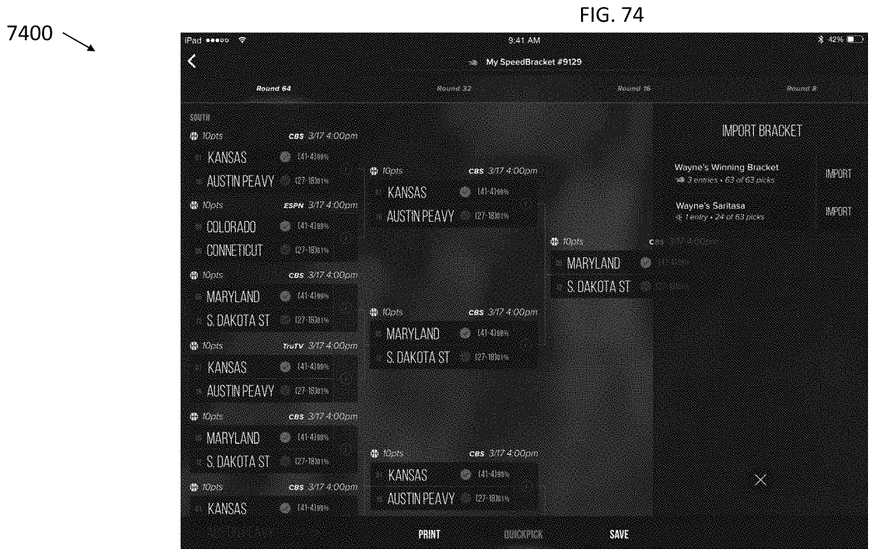

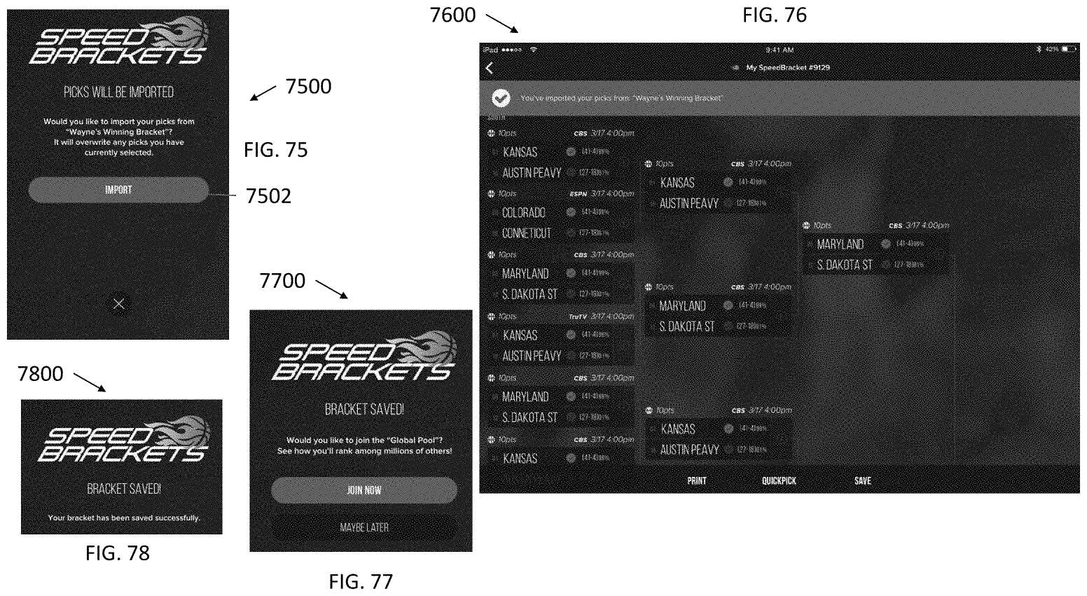

FIG. 75 shows an example embodiment diagram 7500 of a tablet computer based iOS user interface bracket select to import confirmation screen. Description of the features of this screen is similar to that of FIG. 24. Additionally, here users can cancel importation by selecting a cancel button 7502.

FIG. 76 shows an example embodiment diagram of a tablet computer based iOS user interface bracket import confirmation screen. Description of the features of this screen is similar to that of FIG. 25.

FIG. 77 shows an example embodiment diagram 7700 of a tablet computer based iOS user interface bracket saved confirmation screen and global pool selection screen. Description of the features of this screen is similar to that of FIG. 27.

FIG. 78 shows an example embodiment diagram 7800 of a tablet computer based iOS user interface bracket saved confirmation screen. Description of the features of this screen is similar to that of a combination of FIG. 26.

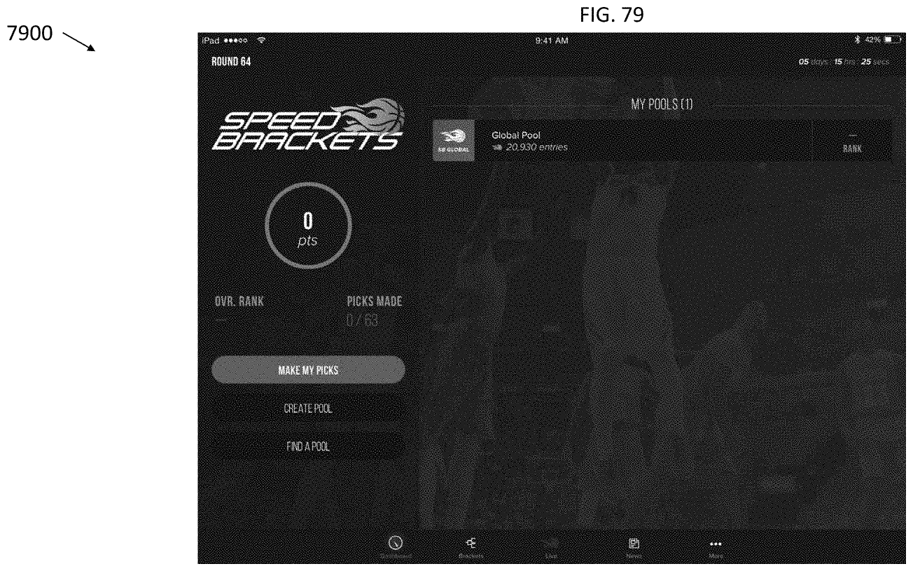

FIG. 79 shows an example embodiment diagram 7900 of a tablet computer based iOS user interface pools joined screen. Description of the features of this screen is similar to that of FIG. 28.

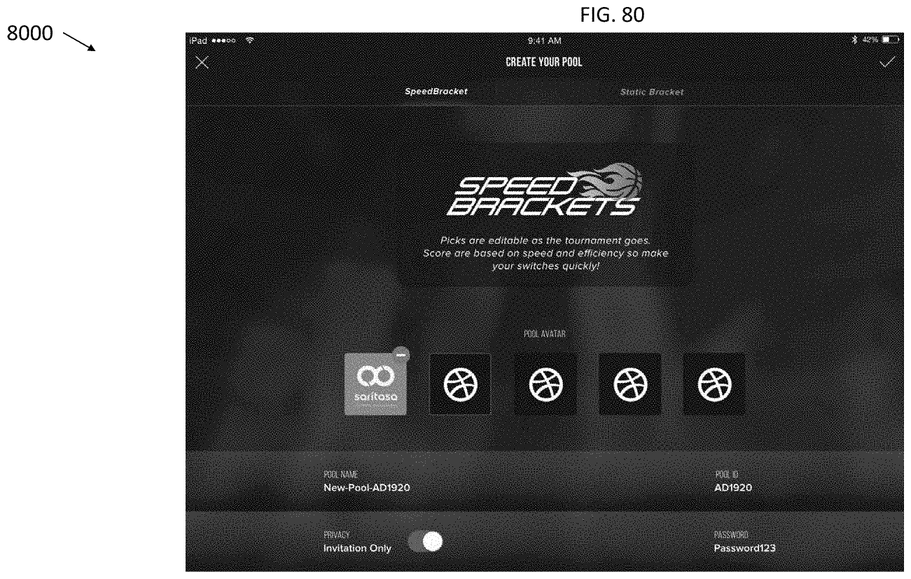

FIG. 80 shows an example embodiment diagram 8000 of a tablet computer based iOS user interface pool creation screen. Here, users can make matchup picks, view points, create pools, find pools, view personal pools, view featured pools and view news information. Description of the features of this screen is similar to that of FIG. 29.

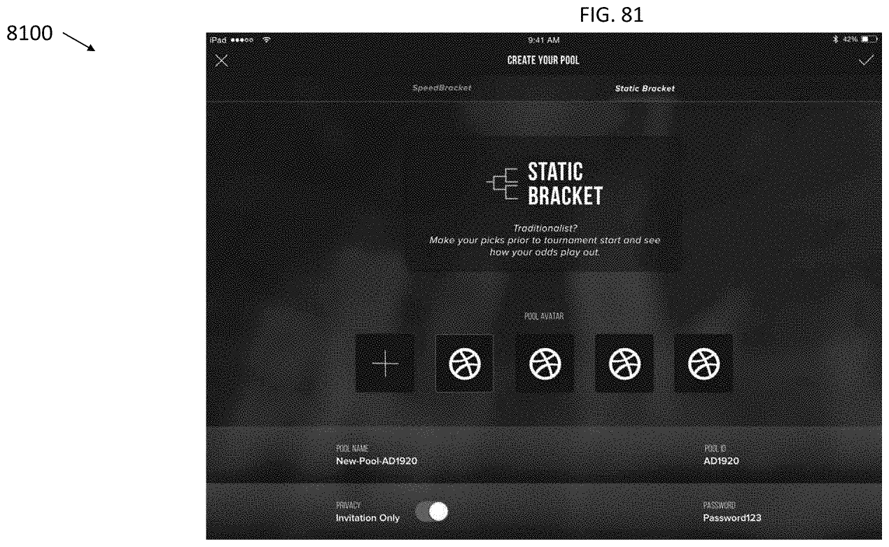

FIG. 81 shows an example embodiment diagram 8100 of a tablet computer based iOS user interface static pool creation screen. Description of the features of this screen is similar to that of FIG. 30.

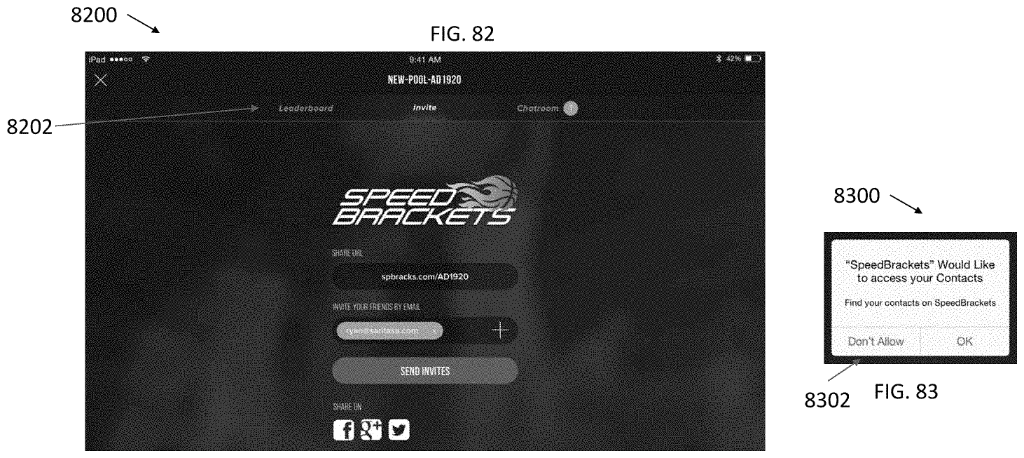

FIG. 82 shows an example embodiment diagram of a tablet computer based iOS user interface new pool invite screen to invite additional friends or users to join a pool. Description of the features of this screen is similar to that of FIG. 31. However, here buttons 8202 can be used to navigate between a leaderboard, invitation, and chatroom.

FIG. 83 shows an example embodiment diagram 8300 of a tablet computer based iOS user interface contact access confirmation screen. As shown in the example embodiment, if a user wishes to import contact information from a contact list stored on a mobile device, the system can show a screen with buttons 8302 for allowing this or preventing it.

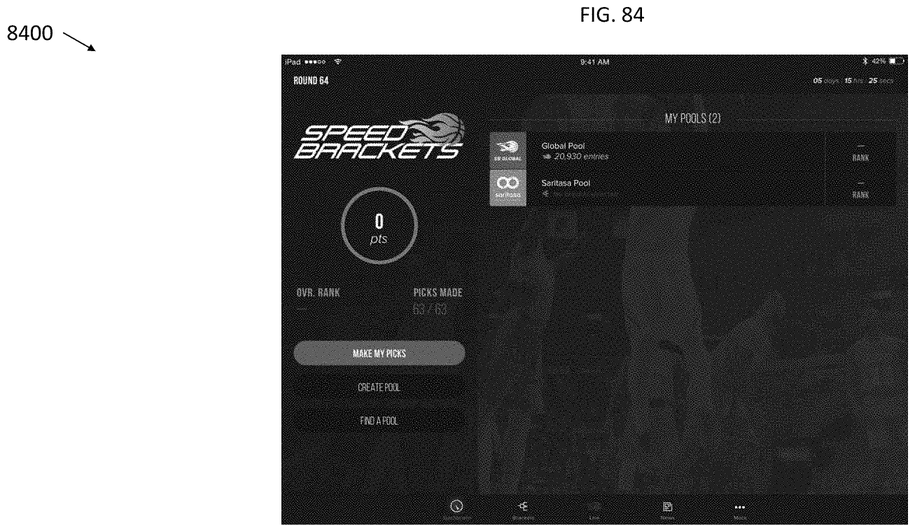

FIG. 84 shows an example embodiment diagram 8400 of a tablet computer based iOS user interface pool joined viewing screen. Description of the features of this screen is similar to that of FIG. 32.

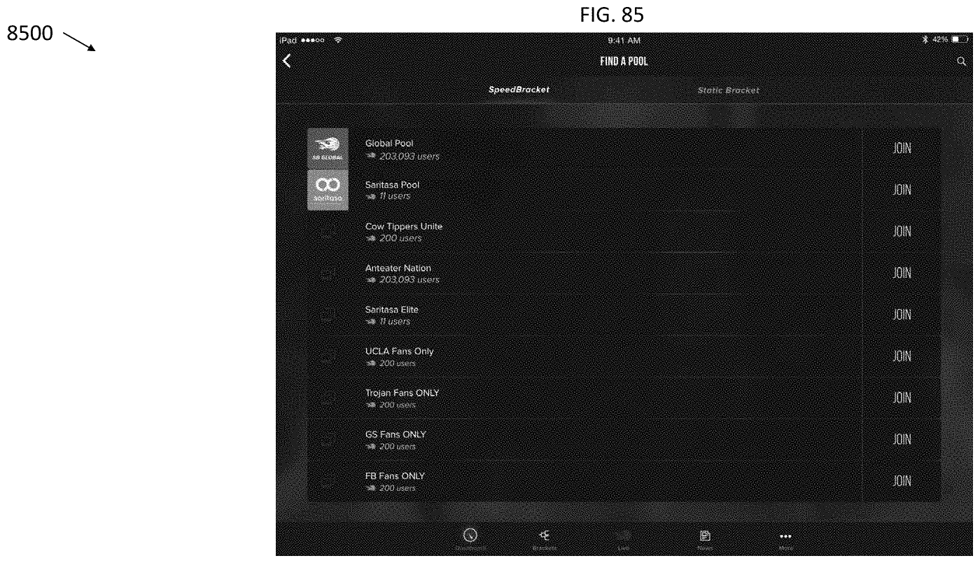

FIG. 85 shows an example embodiment diagram 8500 of a tablet computer based iOS user interface find pool search screen. Pools can be searched or viewed based on type, such as static or dynamic. Description of the features of this screen is similar to that of FIG. 33.

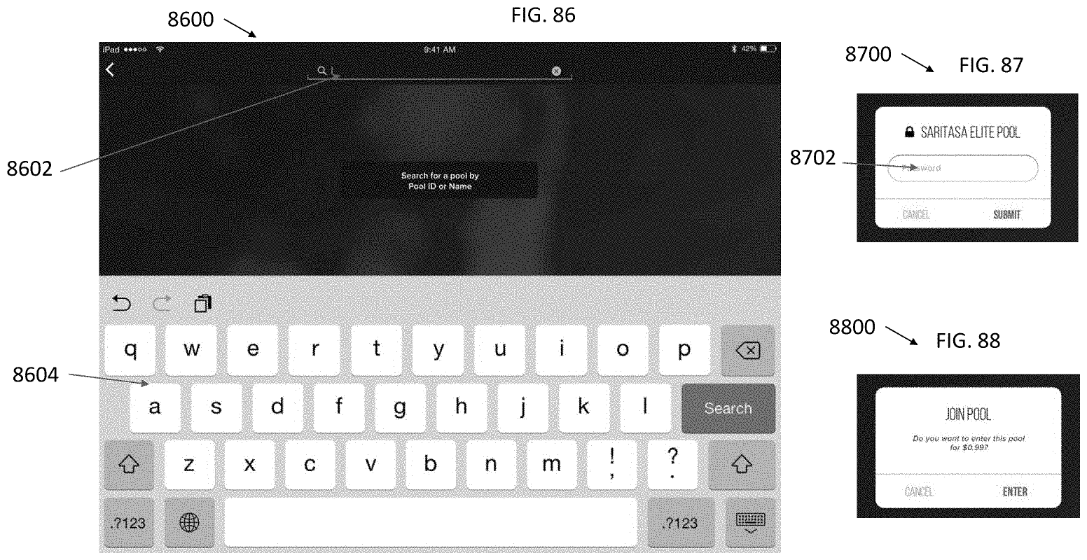

FIG. 86 shows an example embodiment diagram 8600 of a tablet computer based iOS user interface pool search entry screen, including a search field 8602 and touchscreen based keyboard 8604 to search for pool identifiers or names.

FIG. 87 shows an example embodiment diagram 8700 of a tablet computer based iOS user interface pool password entry screen. As shown, users can be prompted to enter a password in a password field 8702 if a pool is private.

FIG. 88 shows an example embodiment diagram 8800 of a tablet computer based iOS user interface pool entry screen, including pricing information.

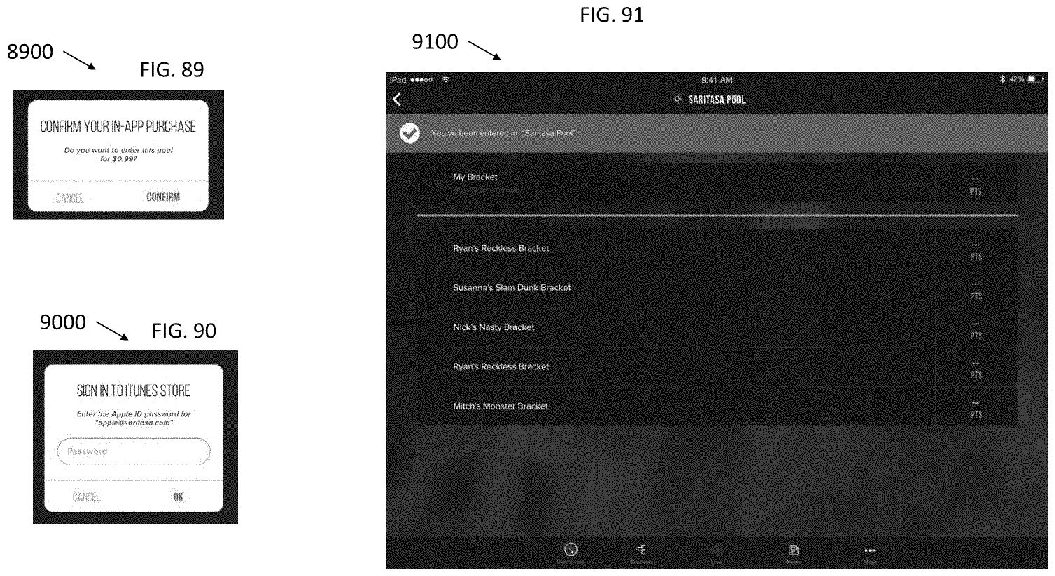

FIG. 89 shows an example embodiment diagram 8900 of a tablet computer based iOS user interface application purchase confirmation screen.

FIG. 90 shows an example embodiment diagram 9000 of a tablet computer based iOS user interface application password entry screen when trying to couple with a user pay account.

FIG. 91 shows an example embodiment diagram 9100 of a tablet computer based iOS user interface application pool entry confirmation screen. Description of the features of this screen is similar to that of FIG. 35.

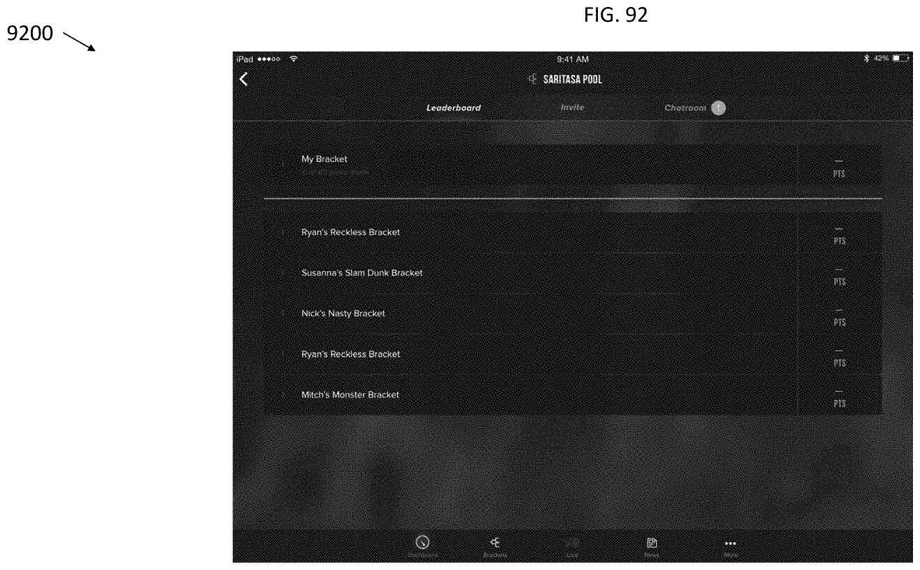

FIG. 92 shows an example embodiment diagram 9200 of a tablet computer based iOS user interface application individual pool's member listing and leaderboard screen. Description of the features of this screen is similar to that of FIG. 31.

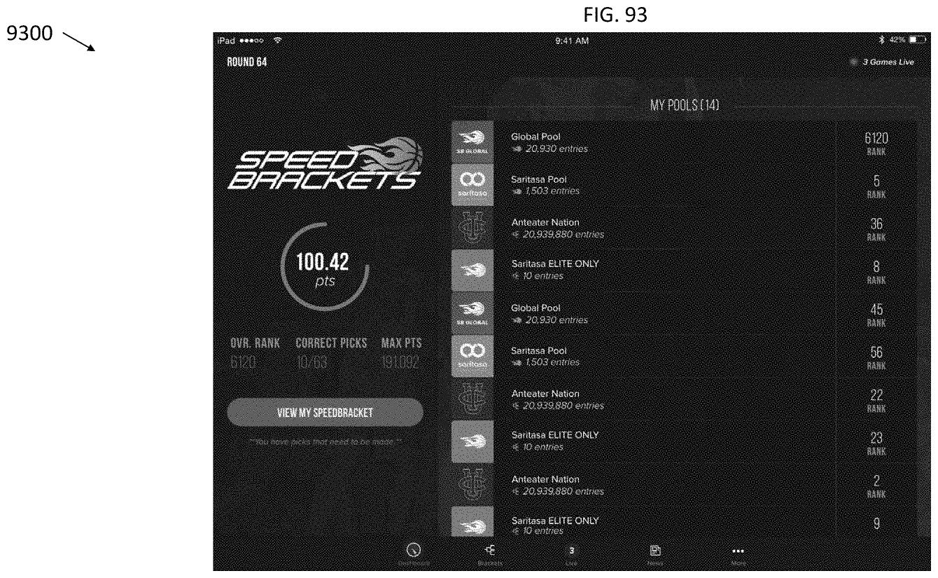

FIG. 93 shows an example embodiment diagram 9300 of a tablet computer based iOS user interface application live dashboard screen. Description of the features of this screen is similar to that of FIG. 36.

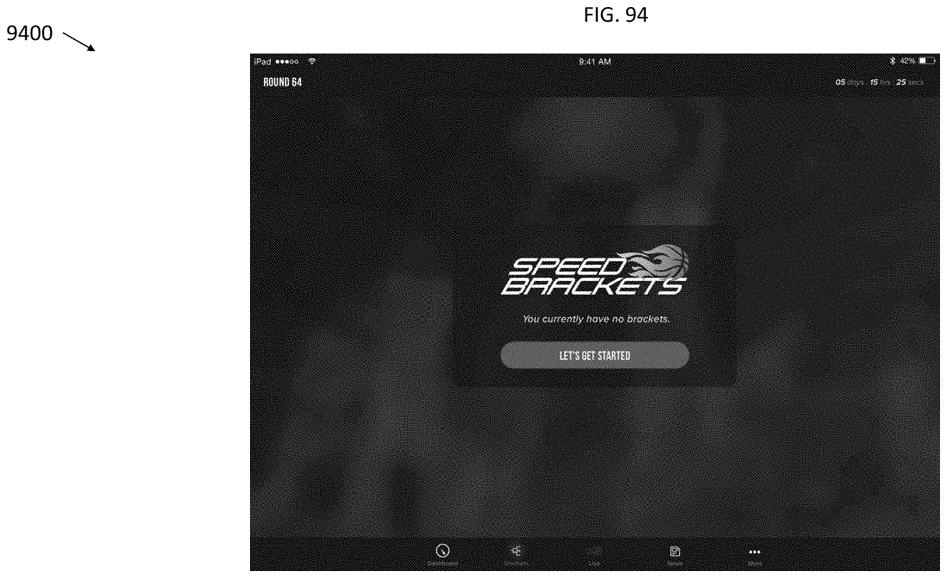

FIG. 94 shows an example embodiment diagram 9400 of a tablet computer based iOS user interface application bracket creation starting screen. Description of the features of this screen is similar to that of FIG. 37.

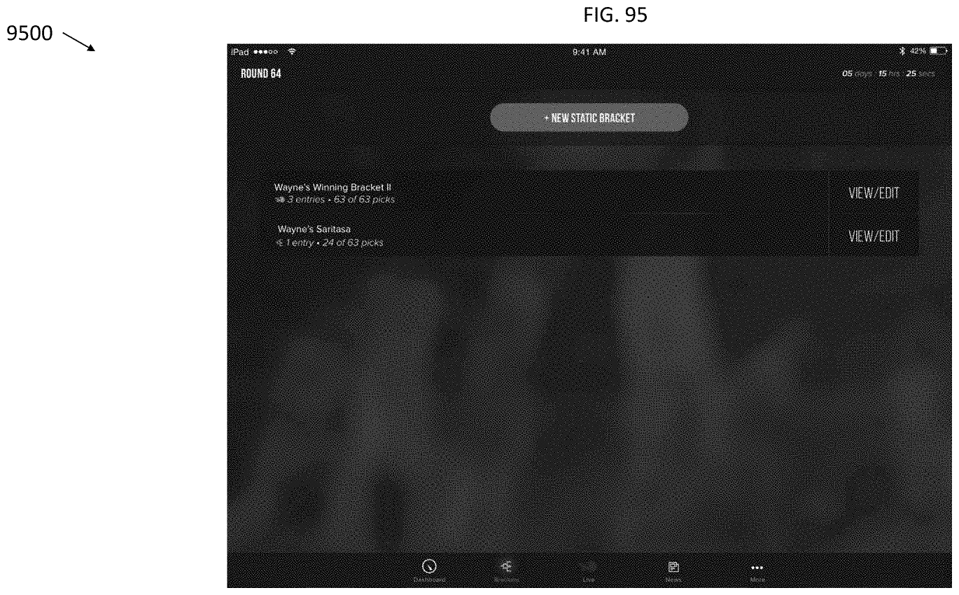

FIG. 95 shows an example embodiment diagram 9500 of a tablet computer based iOS user interface application created bracket listing screen, including the option to select and view or edit individual brackets and create new brackets. Also shown is a timer until a tournament begins. Description of the features of this screen is similar to that of FIG. 38.

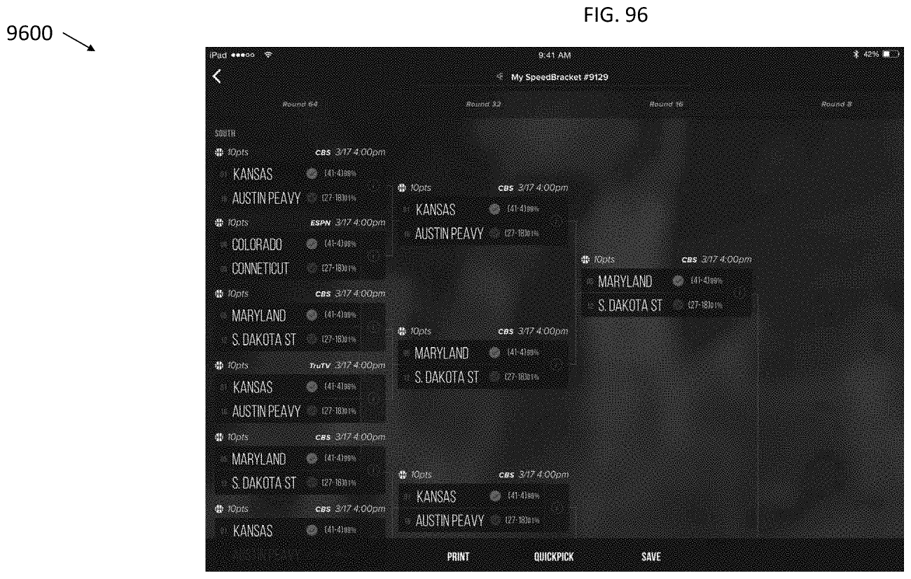

FIG. 96 shows an example embodiment diagram 9600 of a tablet computer based iOS user interface application bracket creation screen. Description of the features of this screen is similar to that of FIG. 39.

FIG. 97 shows an example embodiment diagram 9700 of a tablet computer based iOS user interface application live bracket list screen. Description of the features of this screen is similar to that of FIG. 40.

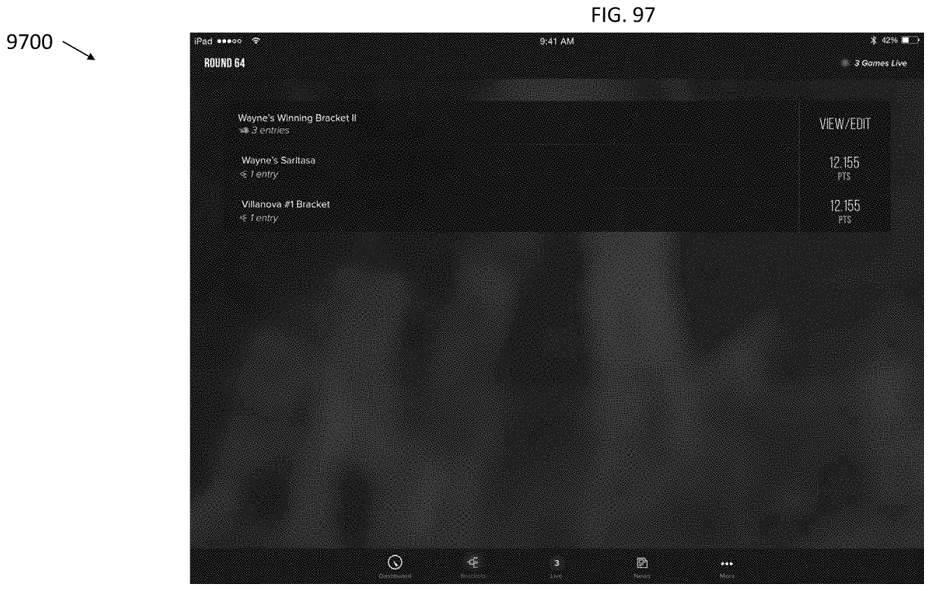

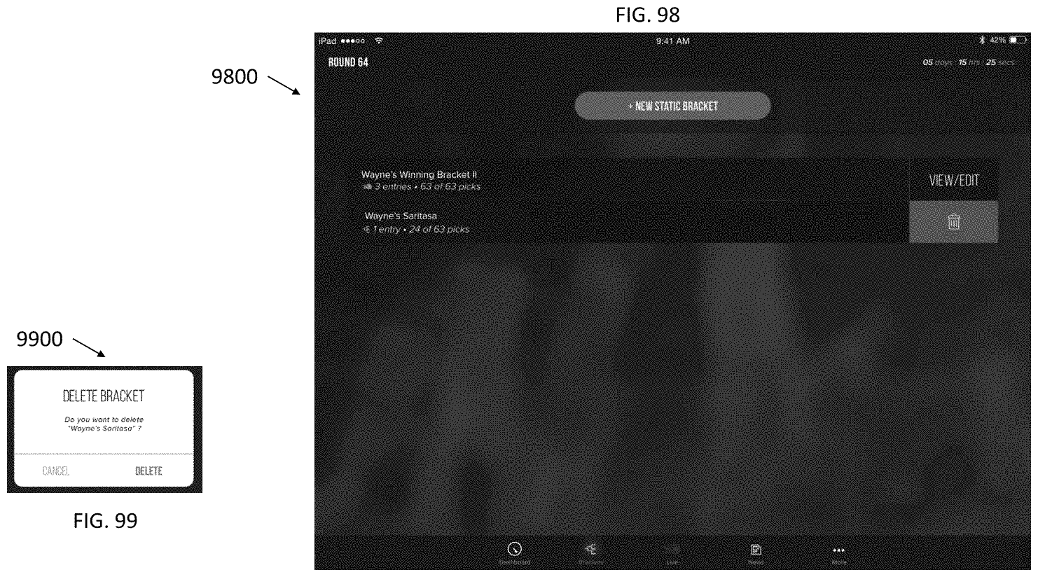

FIG. 98 shows an example embodiment diagram 9800 of a tablet computer based iOS user interface application bracket deletion screen. Description of the features of this screen is similar to that of FIG. 41.

FIG. 99 shows an example embodiment diagram 9900 of a tablet computer based iOS user interface application bracket deletion confirmation screen. Description of the features of this screen is similar to that of FIG. 42.

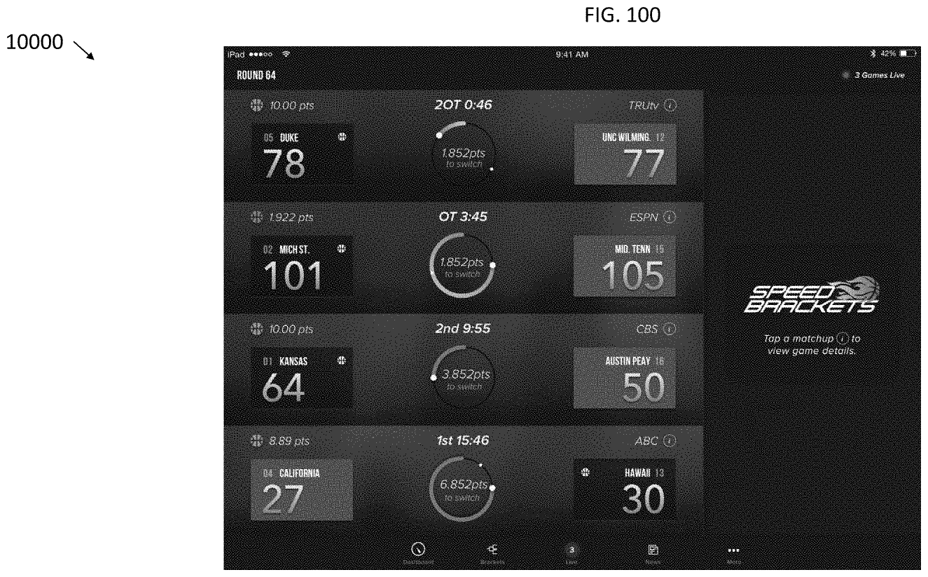

FIG. 100 shows an example embodiment diagram 10000 of a tablet computer based iOS user interface application live game information screen. Here, users can view their possible points and current points for each active game. They can also view global or pool leaderboards and select individual matchups to view individual game information. Description of the features of this screen is similar to that of FIG. 43.

FIG. 101 shows an example embodiment diagram 10100 of a tablet computer based iOS user interface application potential points for live game pick switching screen. Here, users can view how many points they may sacrifice based on various system calculations based on stored algorithms. As shown, this can include the number of points they may win or salvage based on changing a pick, the number of points they may sacrifice or other metric identifiers. Description of the features of this screen is similar to that of FIG. 44.

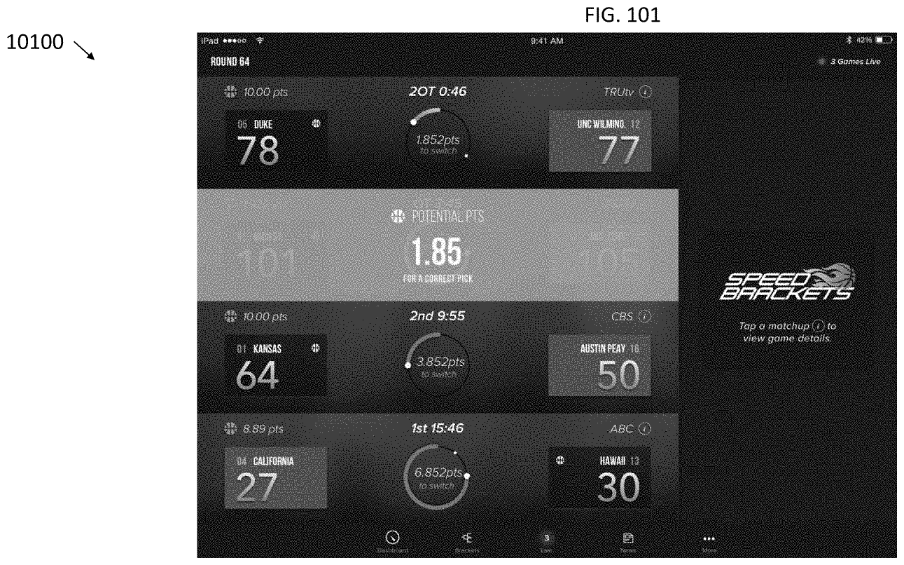

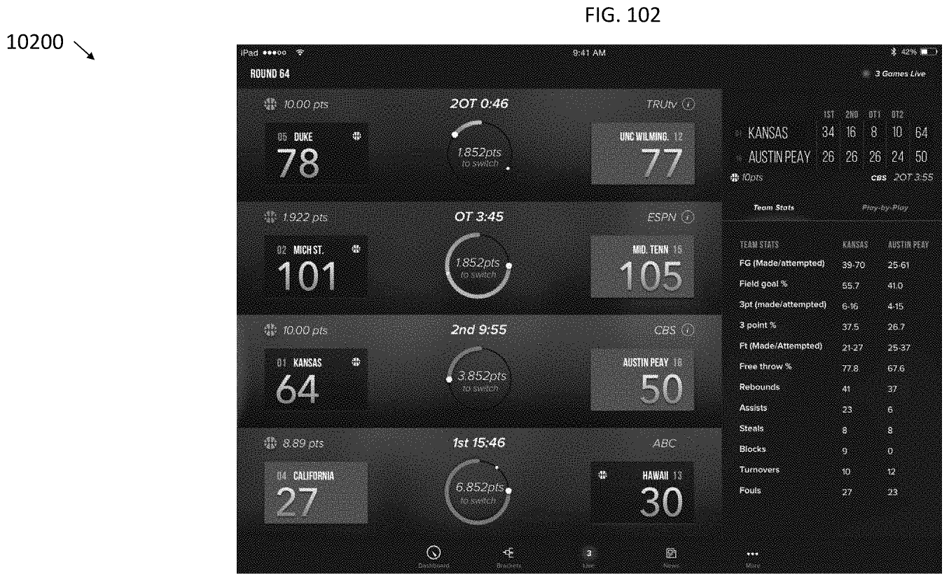

FIG. 102 shows an example embodiment diagram 10200 of a tablet computer based iOS user interface application live game score screen with selected game statistics. Description of the features of this screen is similar to that of FIG. 45.

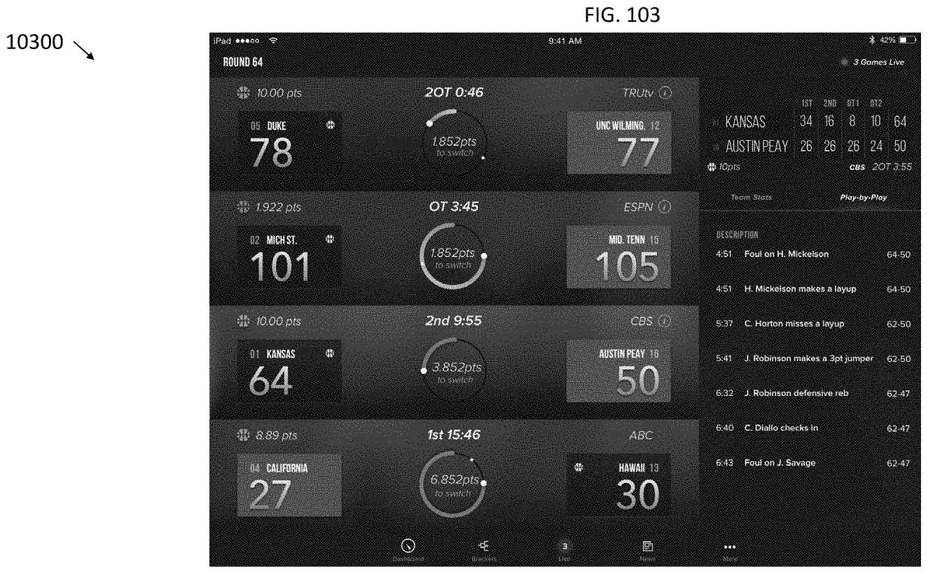

FIG. 103 shows an example embodiment diagram 10300 of a tablet computer based iOS user interface application live game score screen with selected game player statistics. Here, different point totals are shown for each game. These can include the amount of points successfully won or captured based on picks or potential picks, as well as points available for future matchups that have not occurred yet. Description of the features of this screen is similar to that of FIG. 46.

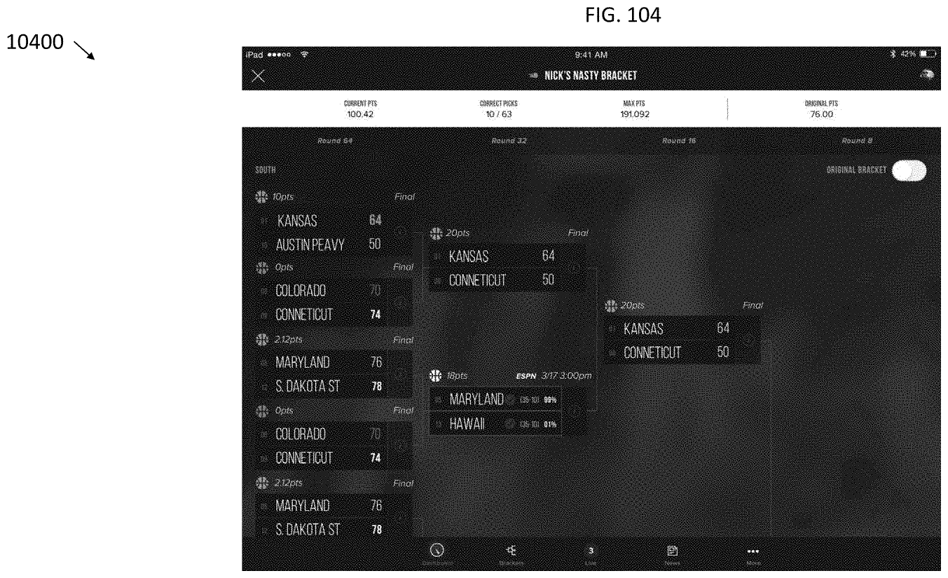

FIG. 104 shows an example embodiment diagram 10400 of a tablet computer based iOS user interface application live bracket screen. Description of the features of this screen is similar to that of FIG. 47.

FIG. 105 shows an example embodiment diagram 10500 of a tablet computer based iOS user interface application live static bracket screen. Description of the features of this screen is similar to that of FIG. 51.

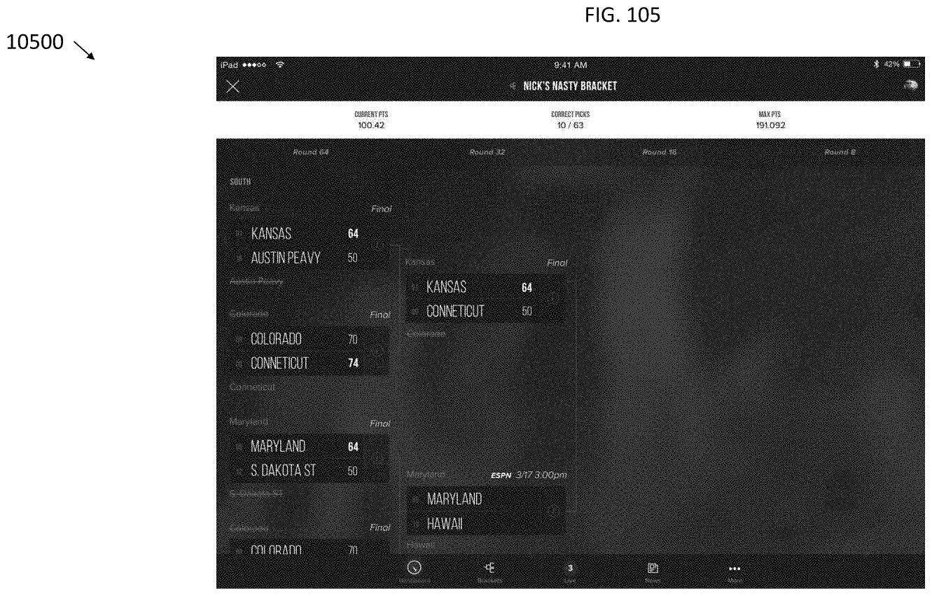

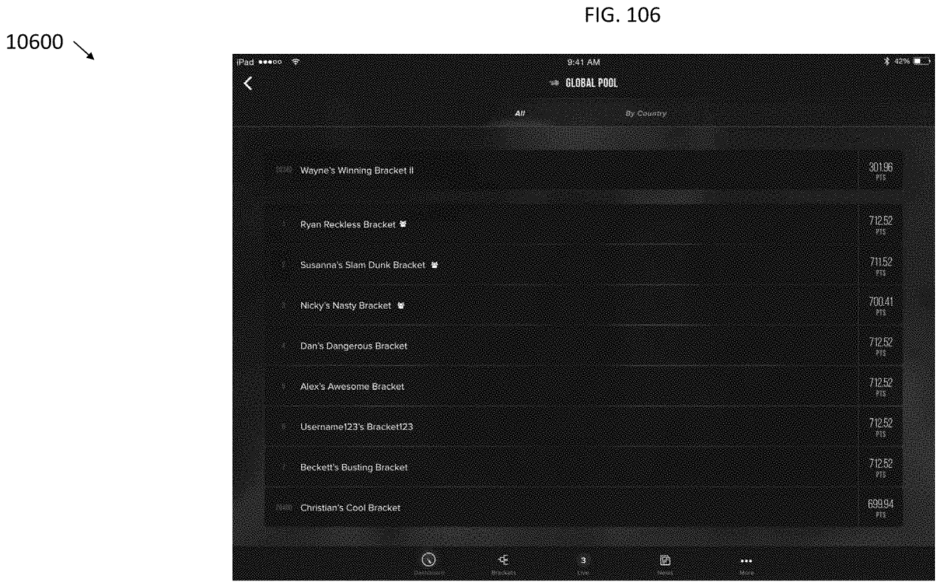

FIG. 106 shows an example embodiment diagram 10600 of a tablet computer based iOS user interface application live bracket and global leaderboard listing screen. Description of the features of this screen is similar to that of FIG. 52.

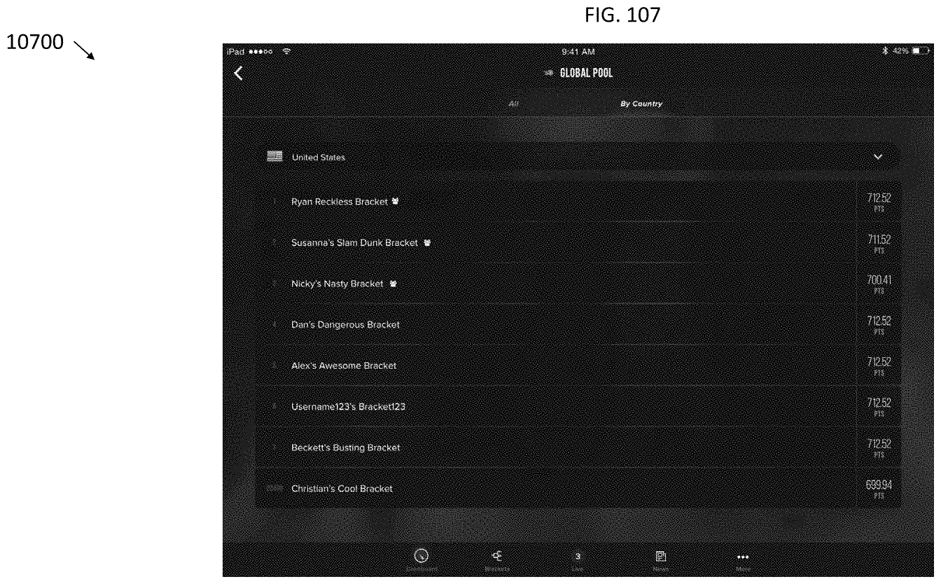

FIG. 107 shows an example embodiment diagram 10700 of a tablet computer based iOS user interface application live bracket single country leaderboard listing screen. Description of the features of this screen is similar to that of FIG. 53.

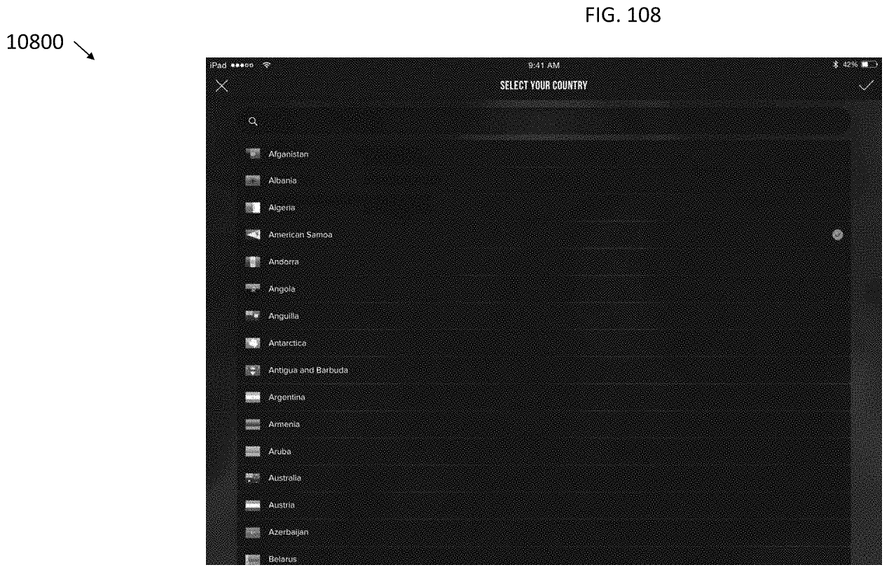

FIG. 108 shows an example embodiment diagram 10800 of a tablet computer based iOS user interface application live bracket country selection listing screen. Here, users can view how their brackets are performing against brackets of users created by users of one or more countries worldwide. Description of the features of this screen is similar to that of FIG. 54.

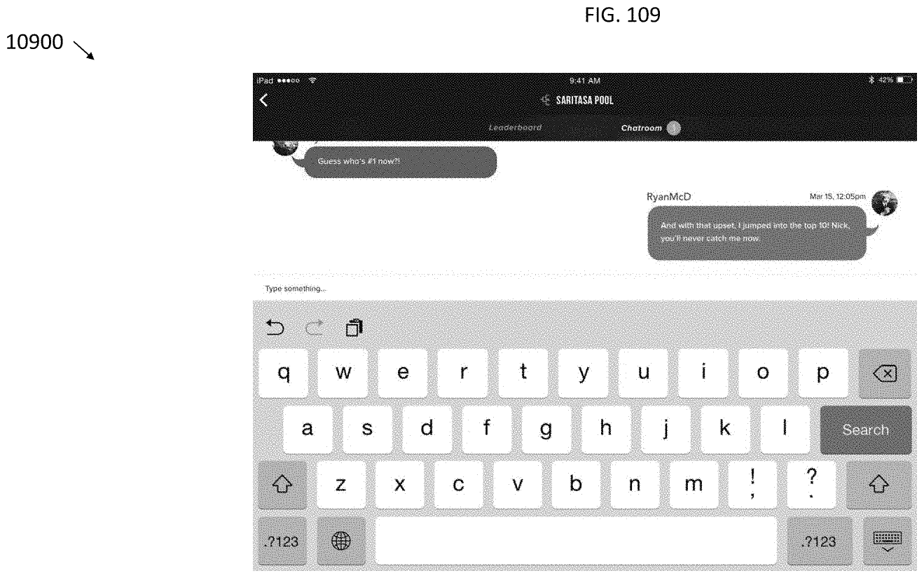

FIG. 109 shows an example embodiment diagram 10900 of a tablet computer based iOS user interface application live pool chat screen. Here, users can interact with friends through the system, such as by using a user interface, camera or other communication device or application. Description of the features of this screen is similar to that of FIG. 31.

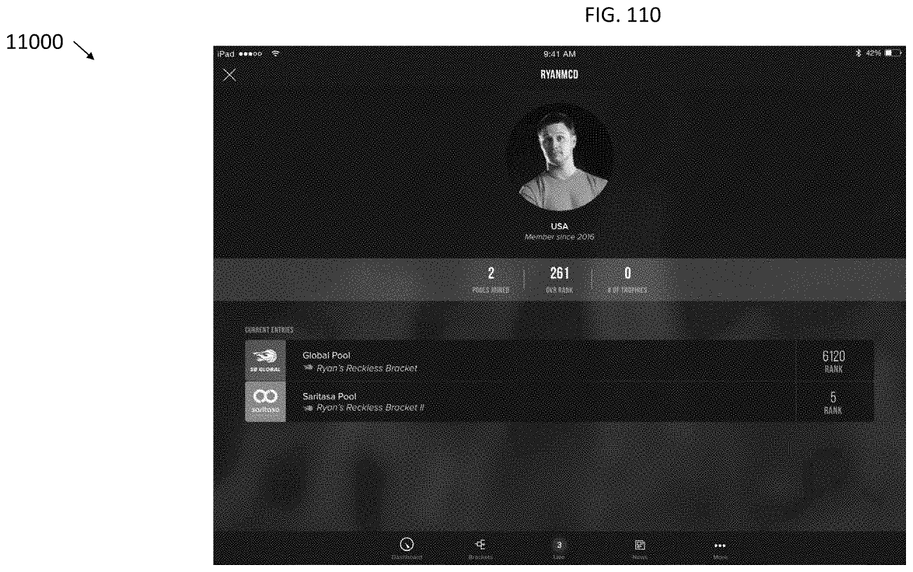

FIG. 110 shows an example embodiment diagram 11000 of a tablet computer based iOS user interface application live friend profile screen. Description of the features of this screen is similar to that of FIG. 55.

FIG. 111 shows an example embodiment diagram 11100 of a tablet computer based iOS user interface application news screen. Here, current news information or article blurbs or abstracts can be displayed that may affect users' decisions to keep or change picks. Description of the features of this screen is similar to that of FIG. 56.

FIG. 112 shows an example embodiment diagram 11200 of a tablet computer based iOS user interface application notifications screen. Here, game information is listed that provides status information and questions or recommendations for users to change or modify picks, as well as timing information. Description of the features of this screen is similar to that of FIG. 57.

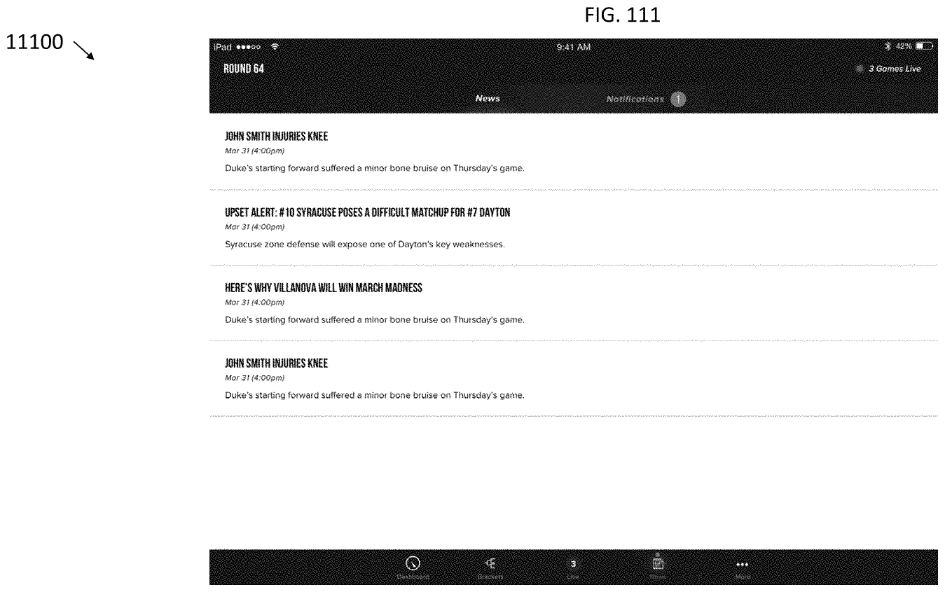

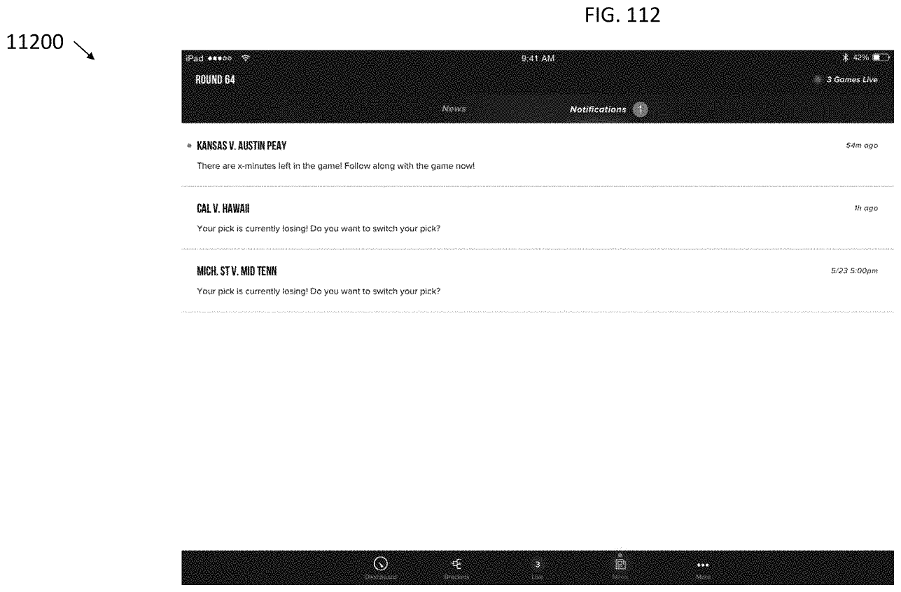

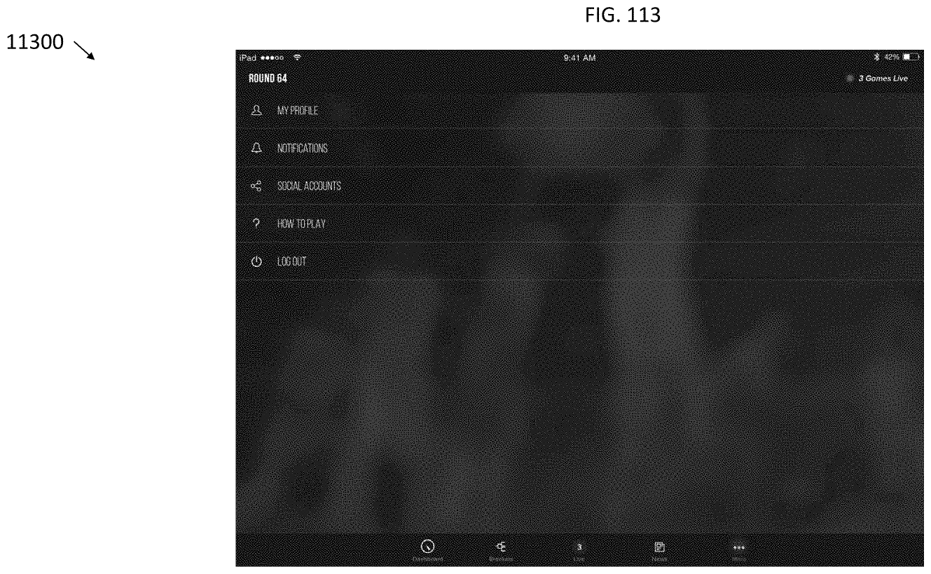

FIG. 113 shows an example embodiment diagram 11300 of a tablet computer based iOS user interface application settings screen. Here users can select buttons to view their profile, notifications, social accounts, information about how to use the system, log out or others. Description of the features of this screen is similar to that of FIG. 28.

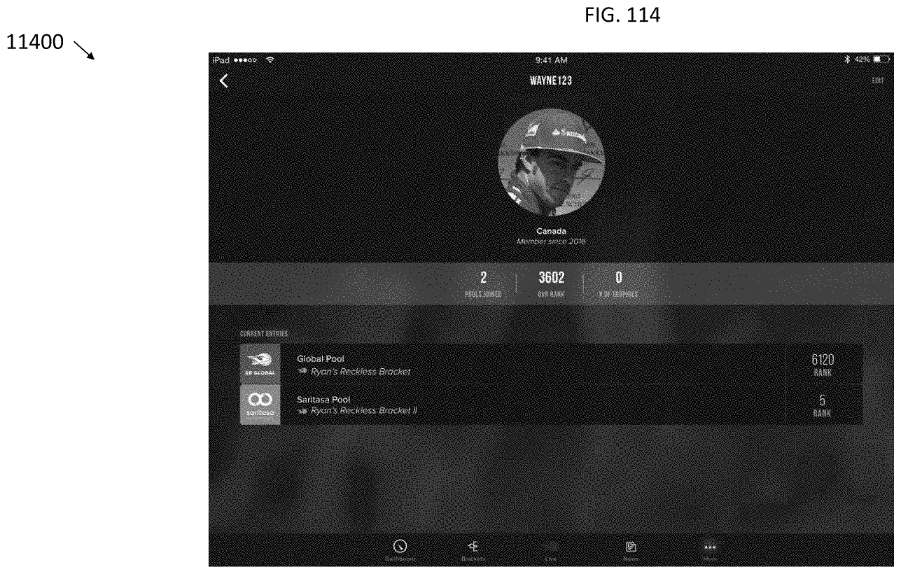

FIG. 114 shows an example embodiment diagram 11400 of a tablet computer based iOS user interface application personal profile screen, including active pools, rankings within the pools and brackets used in the pools. Description of the features of this screen is similar to that of FIG. 58.

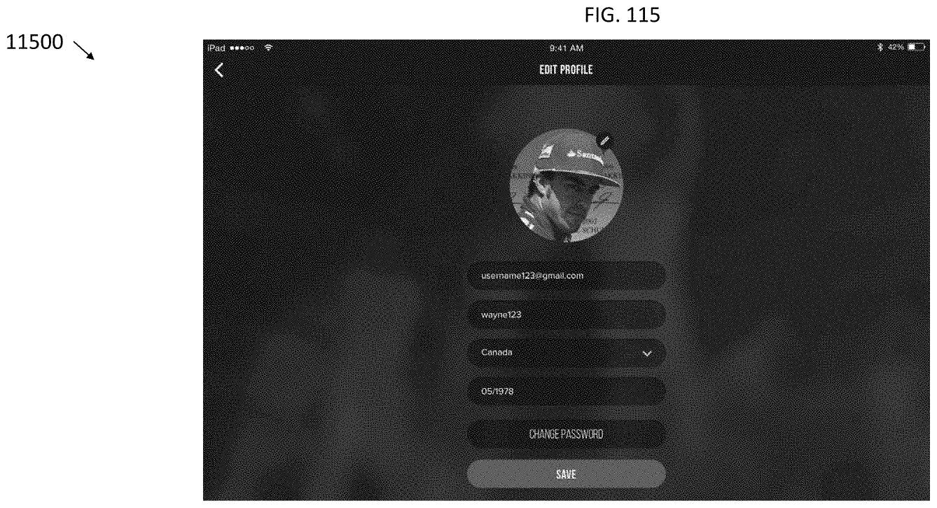

FIG. 115 shows an example embodiment diagram 11500 of a tablet computer based iOS user interface application personal profile editing screen. Description of the features of this screen is similar to that of FIG. 59.

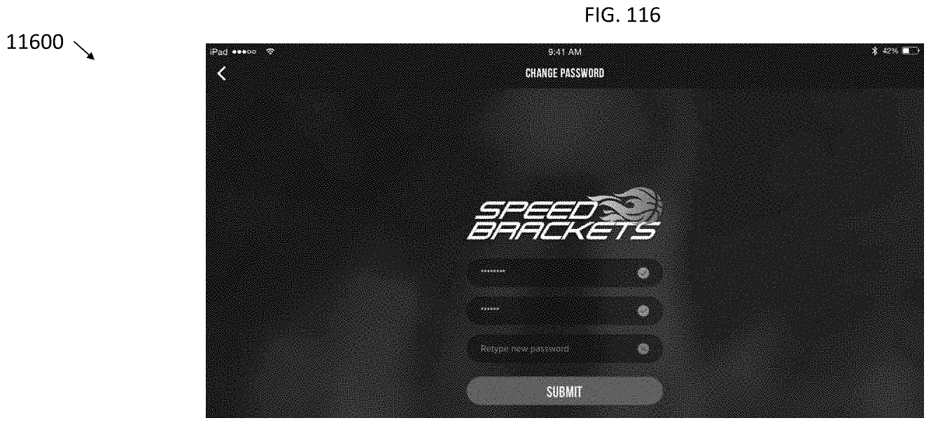

FIG. 116 shows an example embodiment diagram 11600 of a tablet computer based iOS user interface application password changing screen. Description of the features of this screen is similar to that of FIG. 60.

FIG. 117 shows an example embodiment diagram 11700 of a tablet computer based iOS user interface application notifications settings screen with modifiable sliding on-off switches and links to other screens. Here users can change which notifications they wish to receive on their device by interacting with buttons or switches 11702. Examples of notifications can include tournament start or end, start of game, halftime, “x” minutes left in game, “close games” with less than 5 minutes, chat messages, pool invitation, end of game, notify if my selected team is losing at half, your team lost, pick in next round changed, and others.

FIG. 118 shows an example embodiment diagram 11800 of a tablet computer based iOS user interface application social account settings screen. Here users can change which third-party platforms can interact with or be interacted with through the system by interacting with buttons or switches 11802.

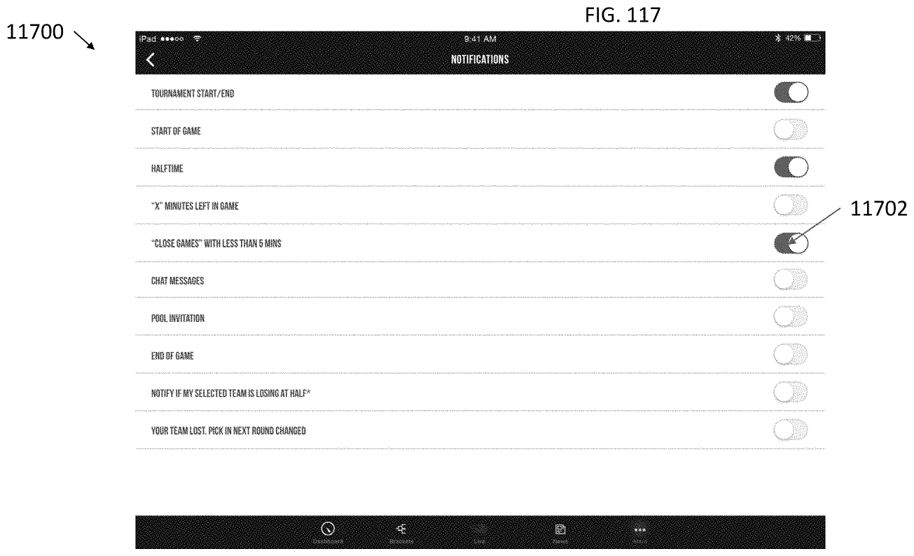

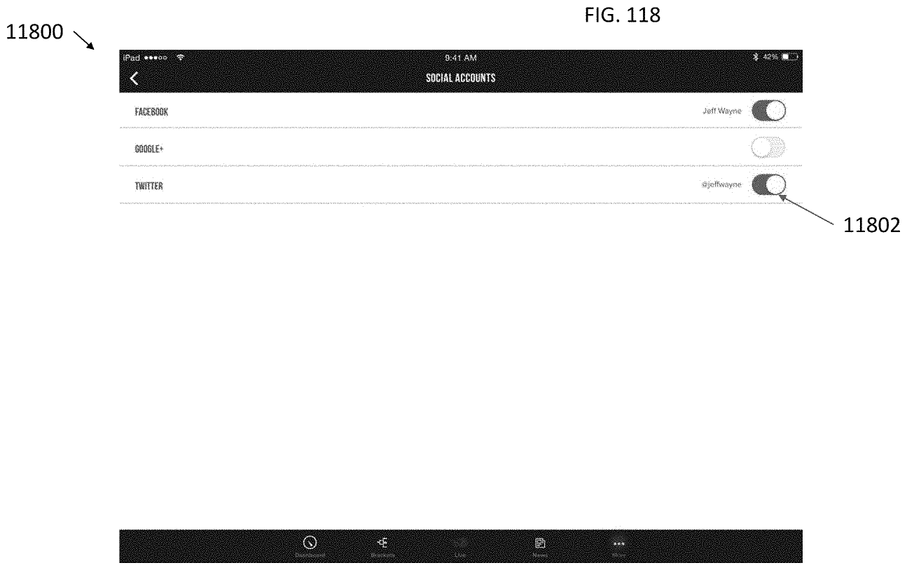

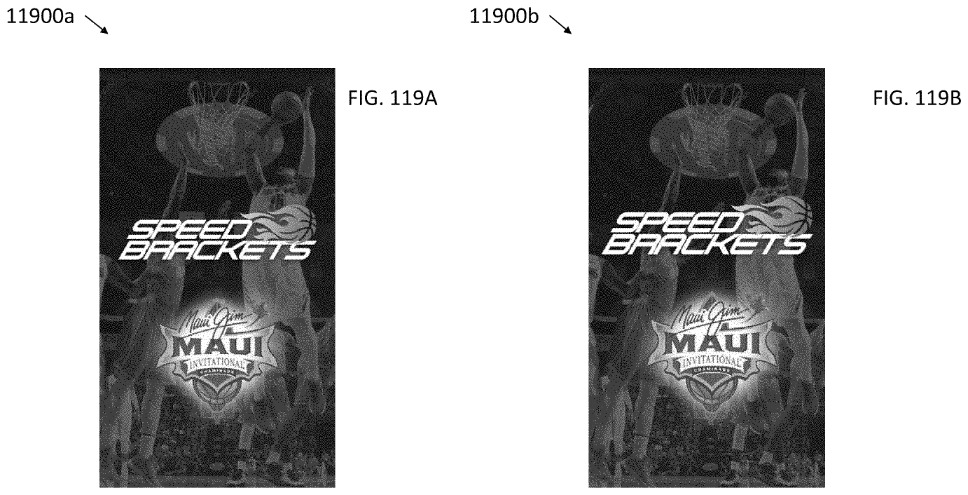

FIGS. 119A-119B show example embodiments 11900A-11900B of Android and iOS mobile device home screens, respectively. Description of the features of this screen is similar to that of FIGS. 64B-64C.

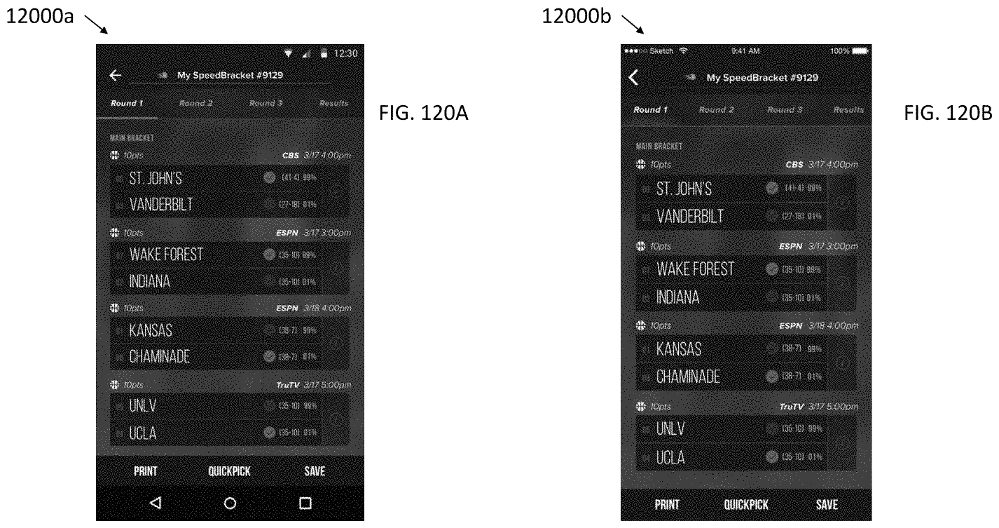

FIGS. 120A-120B show example embodiments 12000A-12000B of Android and iOS mobile device first round bracket screens, respectively. Here users can select buttons to print, make quick picks and save selections. Description of the features of this screen is similar to that of FIG. 62.

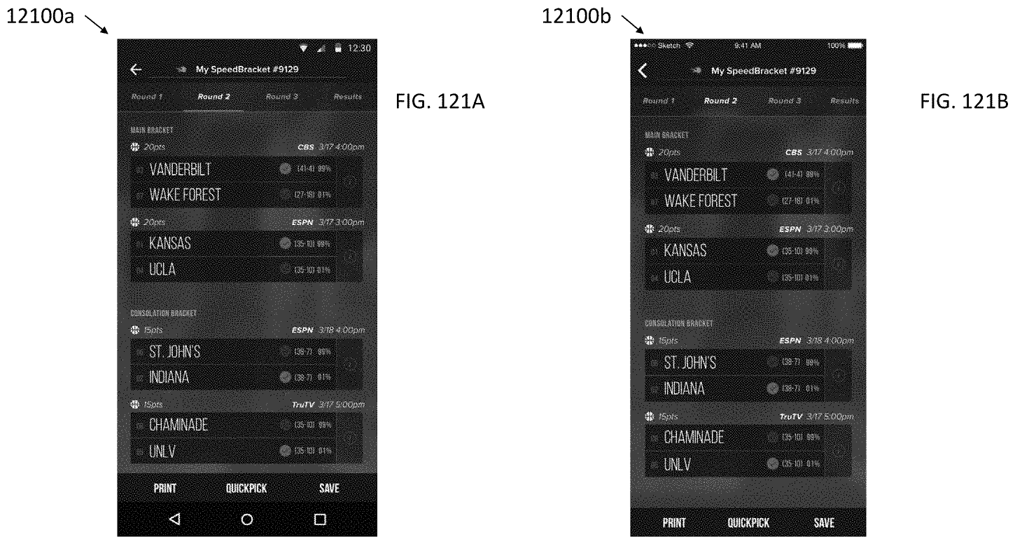

FIGS. 121A-121B show example embodiments 12100A-12100B of Android and iOS mobile device second round bracket screens, respectively. Description of the features of this screen is similar to that of FIG. 62.

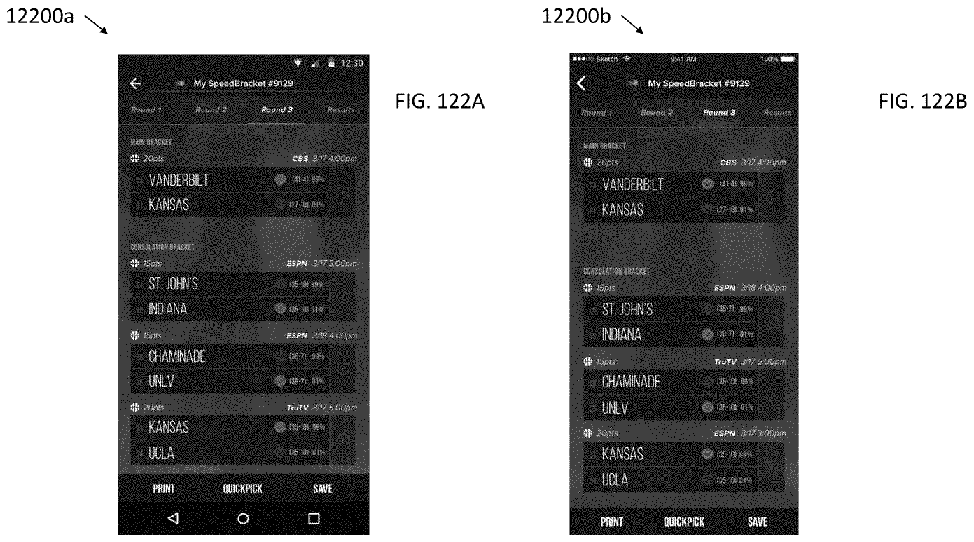

FIGS. 122A-122B show example embodiments 12200A-12200B of Android and iOS mobile device third round bracket screens, respectively. Description of the features of this screen is similar to that of FIG. 62.

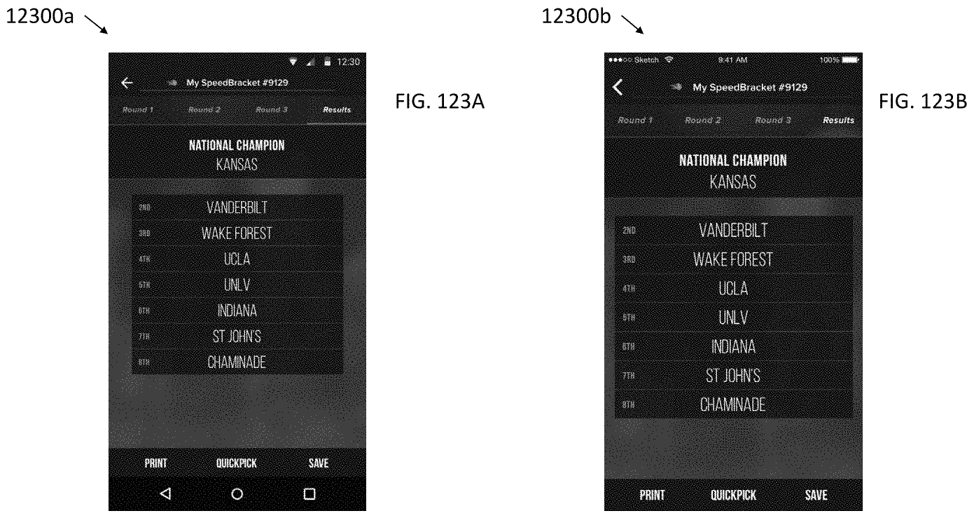

FIGS. 123A-123B show example embodiments 12300A-12300B of Android and iOS mobile device bracket results screens, respectively. As shown in the example embodiment, users can select an order for first place through eighth place or others.

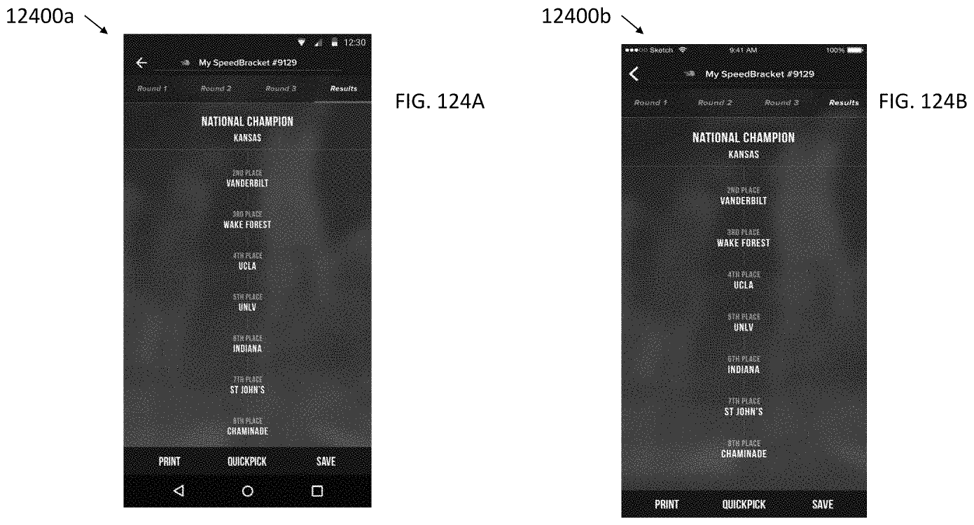

FIGS. 124A-124B show example embodiments of Android and iOS mobile device bracket results screens, respectively. Description of the features of this screen is similar to that of FIGS. 123A-123B.

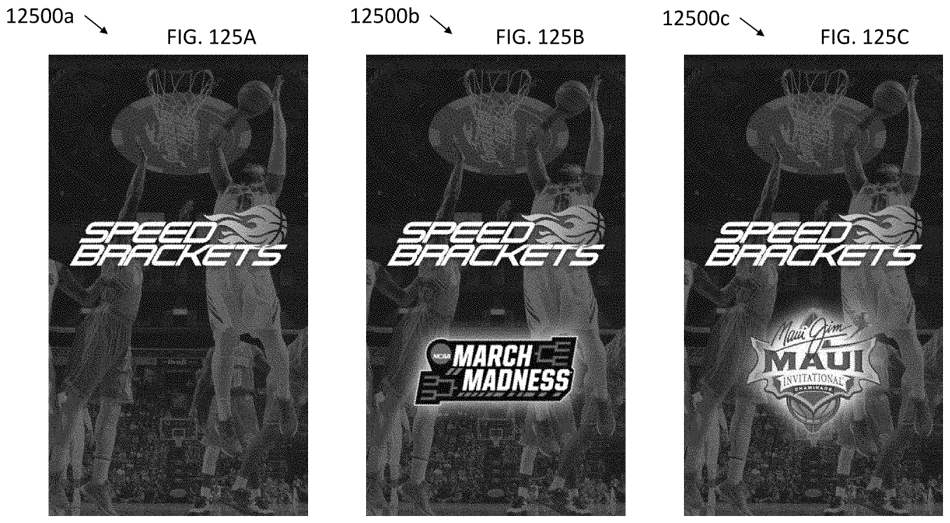

FIGS. 125A-125C show example embodiment diagrams 12500A-12500C of a mobile device based Android user interface generic and tournament specific home screens. Description of the features of this screen is similar to that of FIGS. 64A-64C.

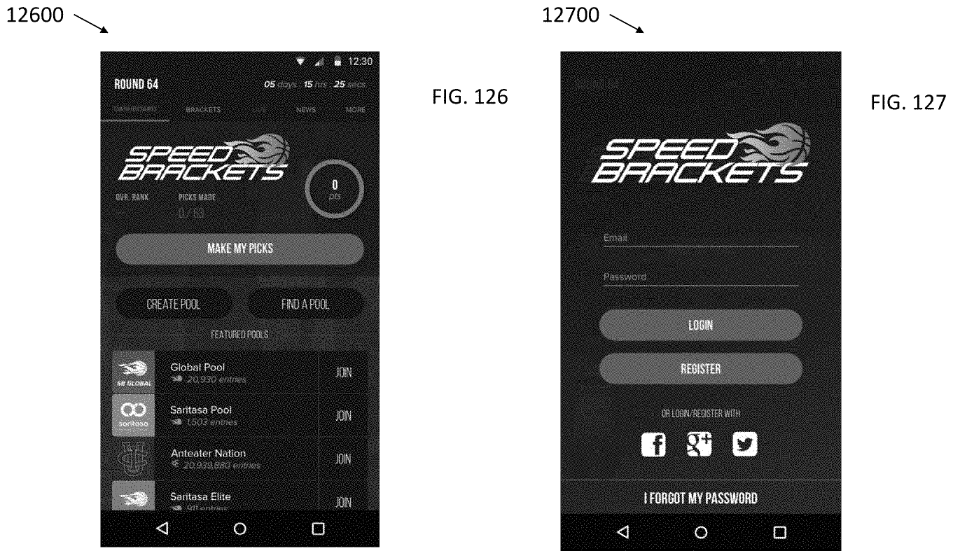

FIG. 126 shows an example embodiment diagram 12600 of a mobile device based Android user interface dashboard screen. Description of the features of this screen is similar to that of FIG. 61.

FIG. 127 shows an example embodiment diagram 12700 of a mobile device based Android user interface login and registration screen. Description of the features of this screen is similar to that of FIG. 15.

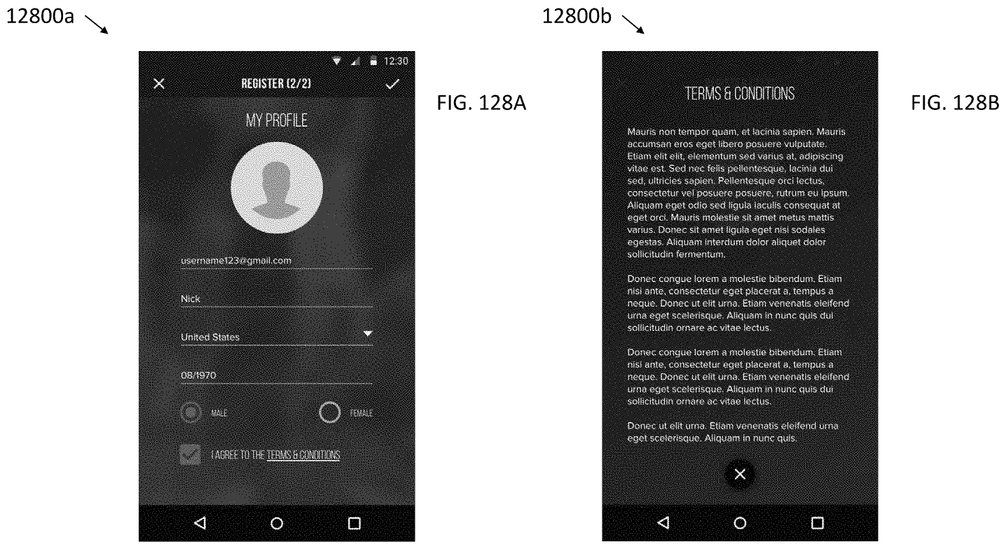

FIG. 128A shows an example embodiment diagram 12800A of a mobile device based Android user interface profile creation screen. Description of the features of this screen is similar to that of FIG. 16.

FIG. 128B shows an example embodiment diagram 12800B of a mobile device based Android user interface terms and conditions screen. Description of the features of this screen is similar to that of FIG. 17.

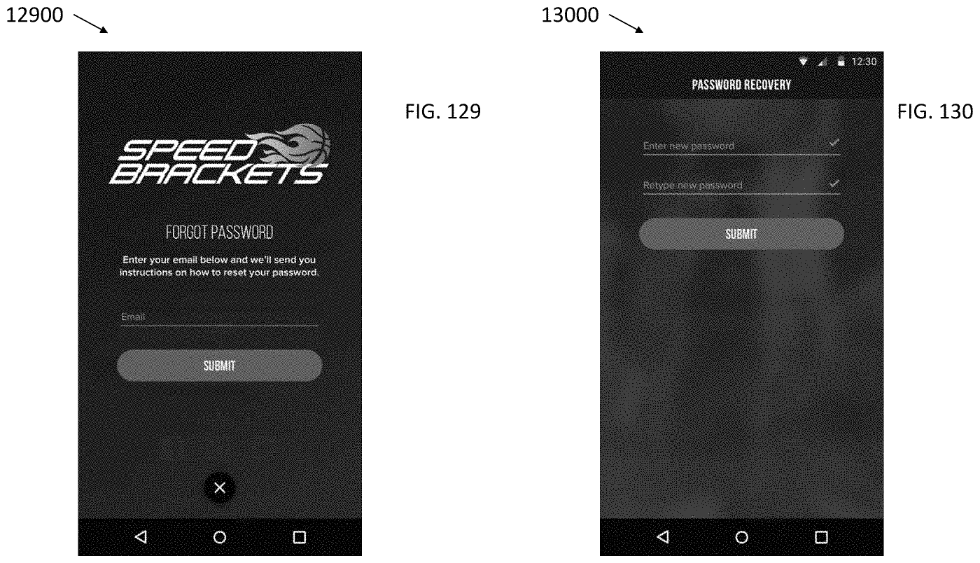

FIG. 129 shows an example embodiment diagram 12900 of a mobile device based Android user interface forgotten password screen. Description of the features of this screen is similar to that of FIG. 18.

FIG. 130 shows an example embodiment diagram 13000 of a mobile device based Android user interface new password creation screen. Description of the features of this screen is similar to that of FIG. 19.

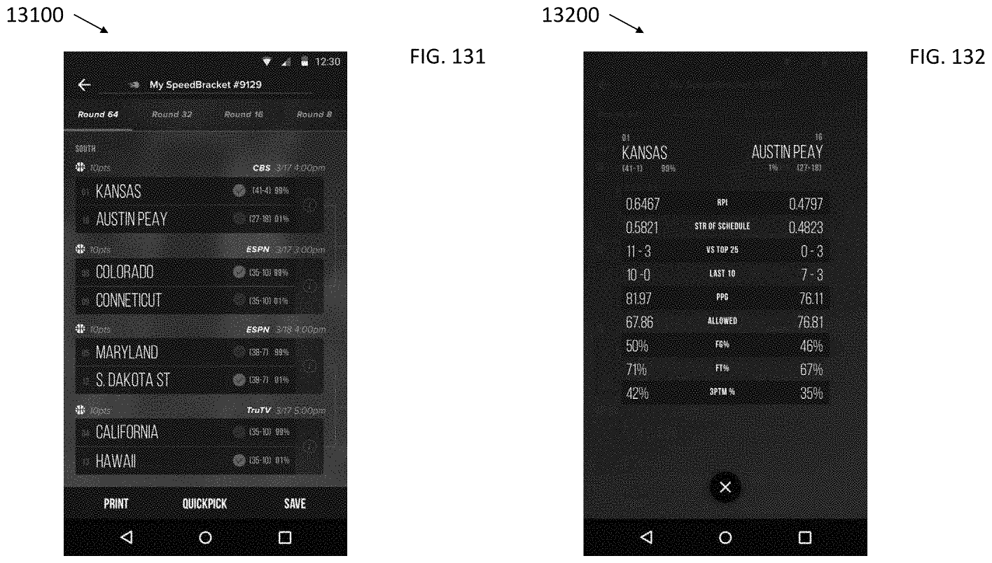

FIG. 131 shows an example embodiment diagram 13100 of a mobile device based Android user interface individual bracket picks screen. Description of the features of this screen is similar to that of FIG. 20.

FIG. 132 shows an example embodiment diagram 13200 of a mobile device based Android user interface select game and team performance statistics screen. Description of the features of this screen is similar to that of FIG. 21.

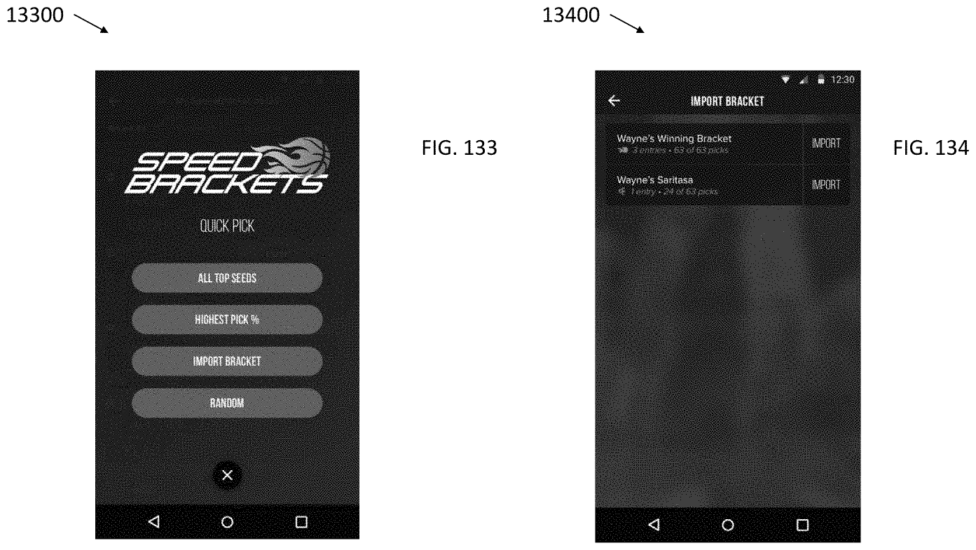

FIG. 133 shows an example embodiment diagram of a mobile device based Android user interface quick pick selection screen. Users can choose various options including selecting all seeds, highest percentage chances to win, importing brackets or choosing bracket choices randomly. Description of the features of this screen is similar to that of FIG. 22.

FIG. 134 shows an example embodiment diagram 13400 of a mobile device based Android user interface import bracket choice selection screen. These can be pre-created and saved bracket files. Description of the features of this screen is similar to that of FIG. 23.

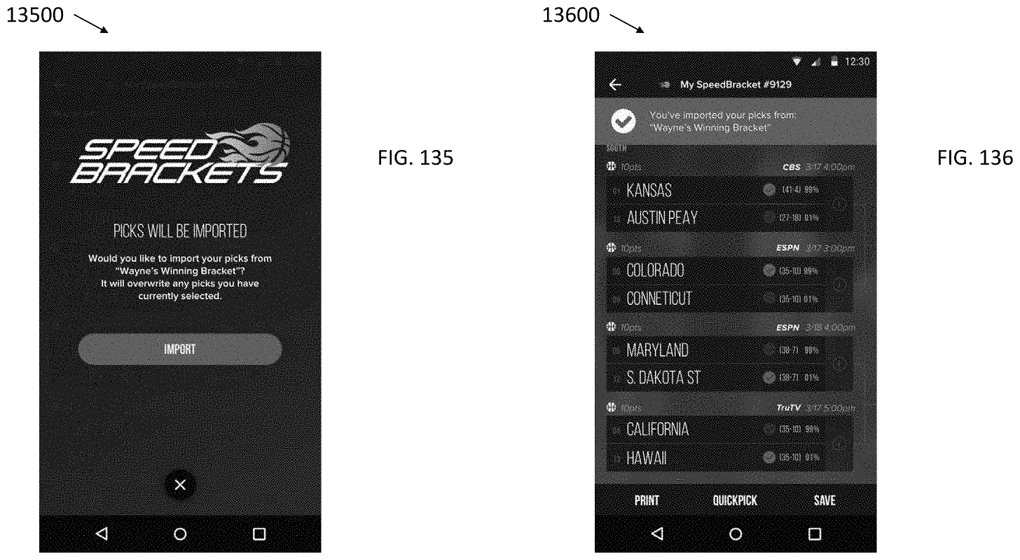

FIG. 135 shows an example embodiment diagram of a mobile device based Android user interface confirming selected bracket to import viewing screen. Description of the features of this screen is similar to that of FIG. 24.

FIG. 136 shows an example embodiment diagram 13600 of a mobile device based Android user interface imported bracket confirmation screen with pool selection option. Description of the features of this screen is similar to that of FIG. 24.

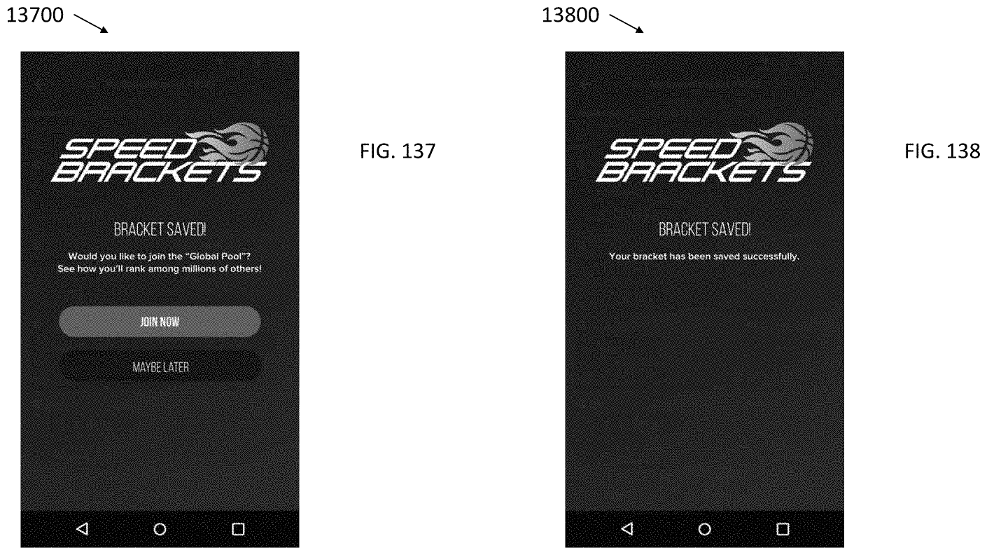

FIG. 137 shows an example embodiment diagram 13700 of a mobile device based Android user interface imported bracket saved confirmation and option to join global pool screen. Description of the features of this screen is similar to that of FIG. 27.

FIG. 138 shows an example embodiment diagram 13800 of a mobile device based Android user interface imported bracket saved confirmation screen. Description of the features of this screen is similar to that of FIG. 26.

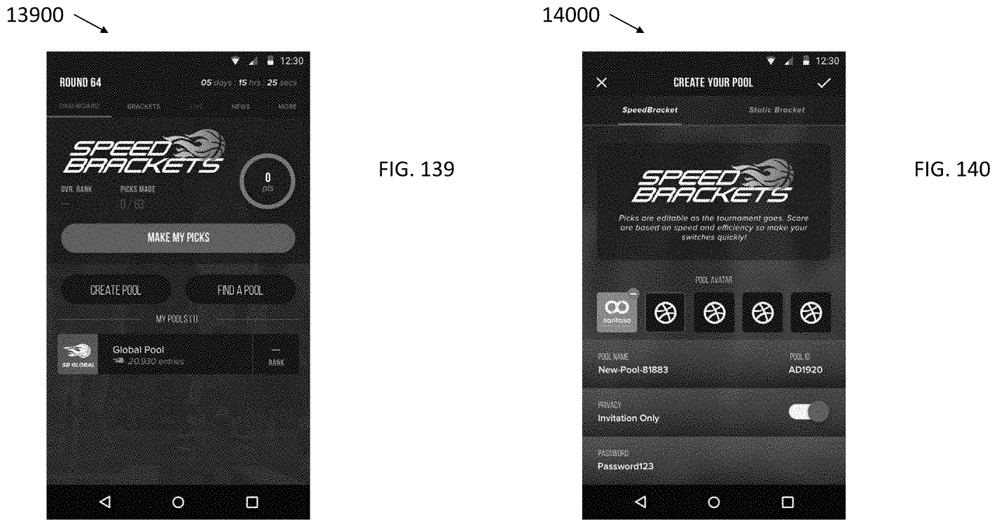

FIG. 139 shows an example embodiment diagram 13900 of a mobile device based Android user interface dashboard screen. Description of the features of this screen is similar to that of FIG. 28.

FIG. 140 shows an example embodiment diagram 14000 of a mobile device based Android user interface pool creation screen. Here users can search for pools using different filters and features. Description of the features of this screen is similar to that of FIG. 29.

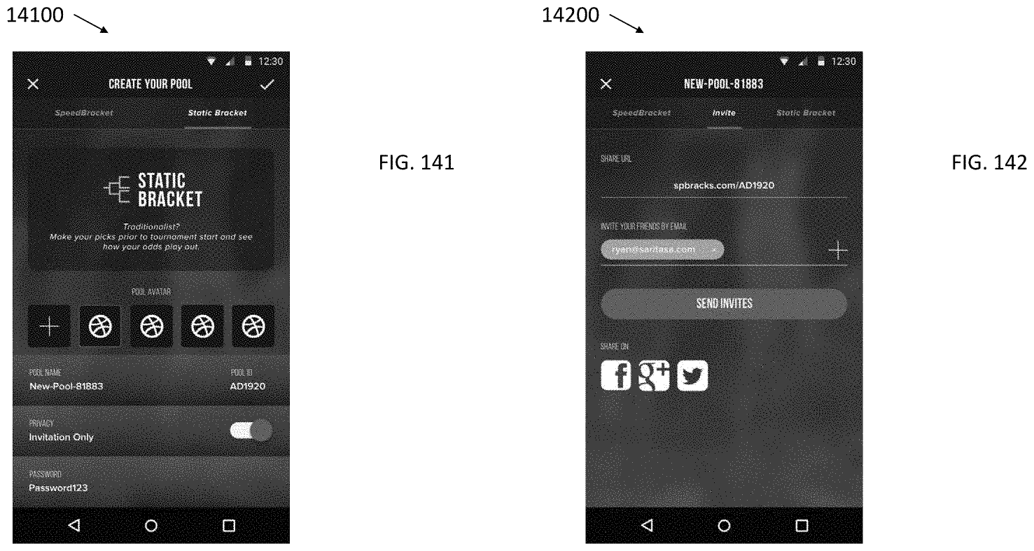

FIG. 141 shows an example embodiment diagram 14100 of a mobile device based Android user interface static pool creation screen, including pool names, identifiers, privacy selections and password entry or viewing field. Description of the features of this screen is similar to that of FIG. 30.

FIG. 142 shows an example embodiment diagram 14200 of a mobile device based Android user interface new pool invite screen. Description of the features of this screen is similar to that of FIG. 31.

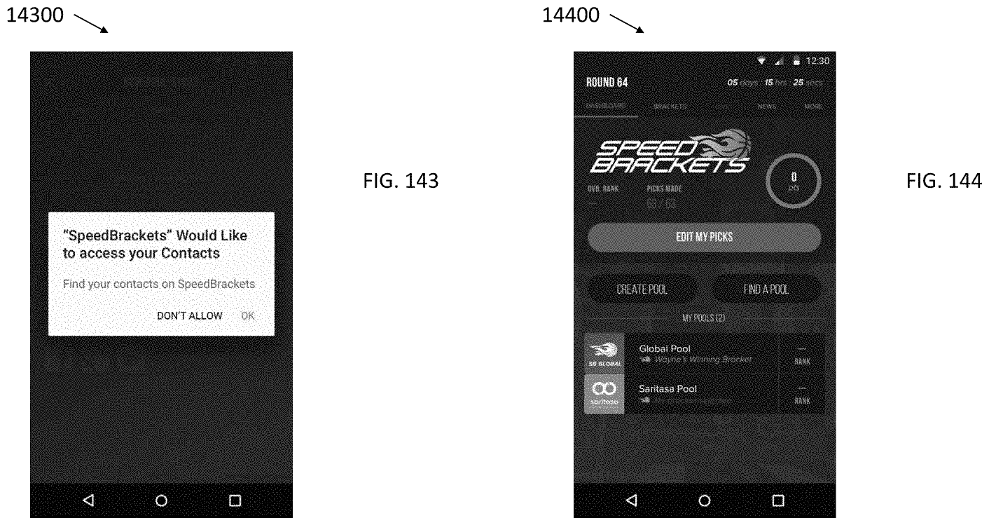

FIG. 143 shows an example embodiment diagram 14300 of a mobile device based Android user interface contact access confirmation screen. Description of the features of this screen is similar to that of FIG. 83.

FIG. 144 shows an example embodiment diagram 14400 of a mobile device based Android user interface dashboard and pool joined viewing screen. Description of the features of this screen is similar to that of FIG. 84.

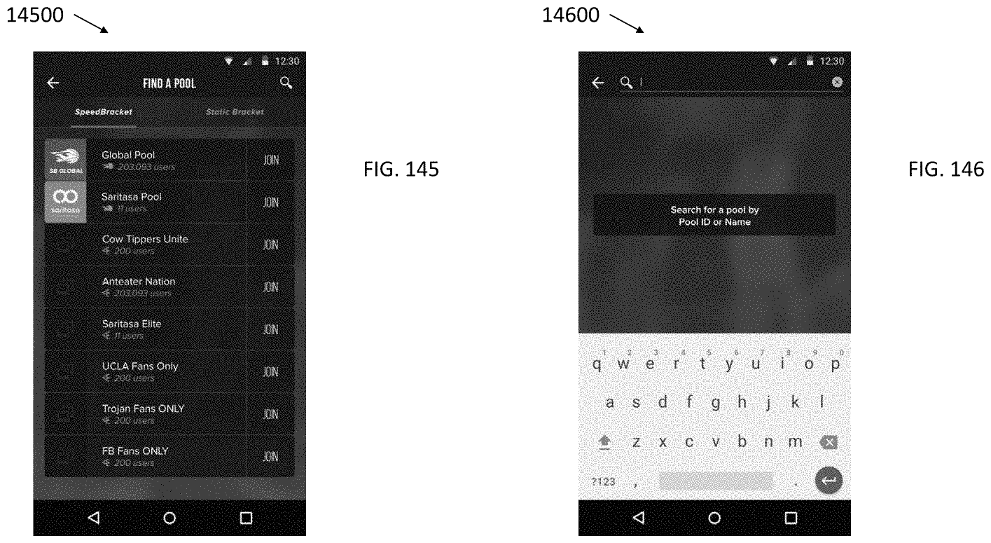

FIG. 145 shows an example embodiment diagram 14500 of a mobile device based Android user interface find pool search screen. Description of the features of this screen is similar to that of FIG. 85.

FIG. 146 shows an example embodiment diagram 14600 of a mobile device based Android user interface pool search entry screen. Description of the features of this screen is similar to that of FIG. 86.

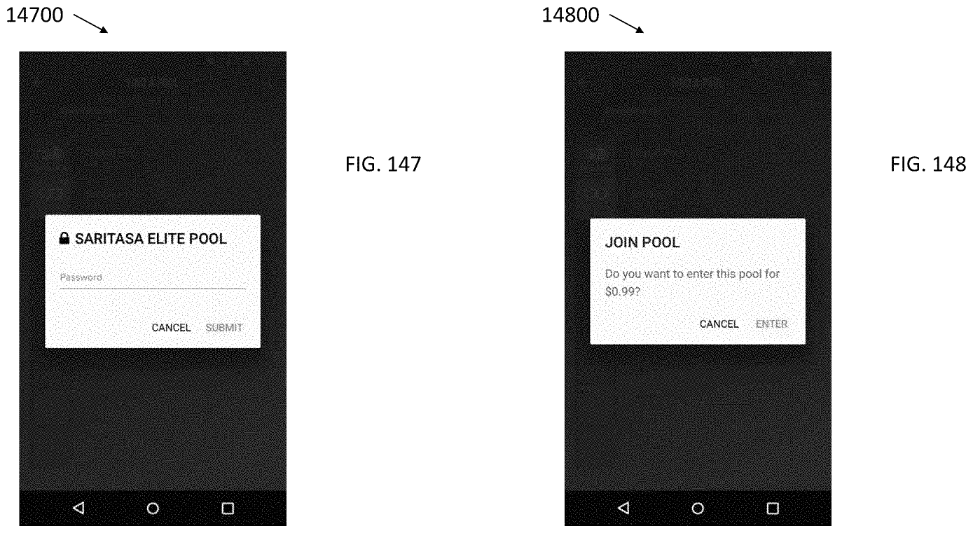

FIG. 147 shows an example embodiment diagram 14700 of a mobile device based Android user interface pool password entry screen. Description of the features of this screen is similar to that of FIG. 87.

FIG. 148 shows an example embodiment diagram 14800 of a mobile device based Android user interface pool entry screen. Description of the features of this screen is similar to that of FIG. 88.

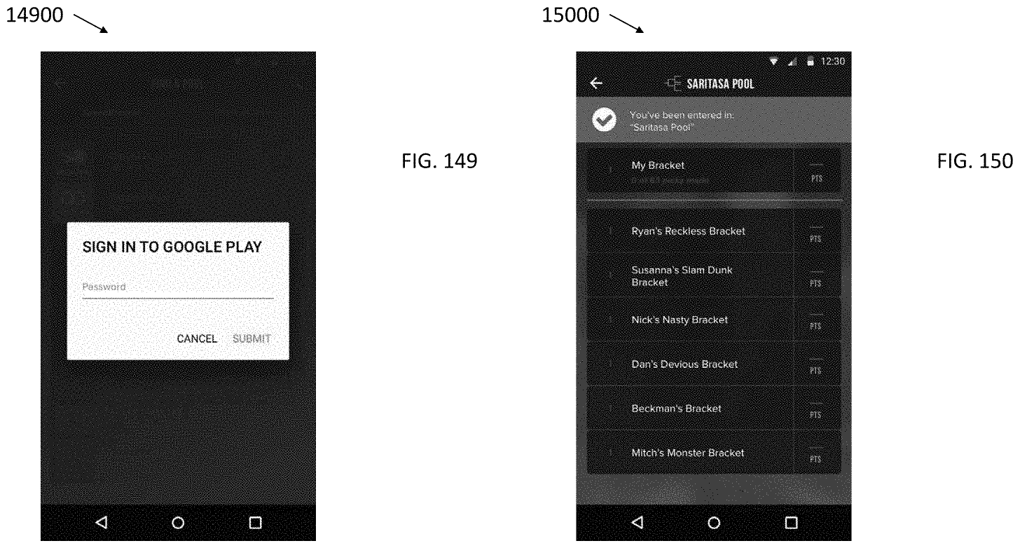

FIG. 149 shows an example embodiment diagram 14900 of a mobile device based Android user interface application password entry screen. Description of the features of this screen is similar to that of FIG. 90.

FIG. 150 shows an example embodiment diagram 15000 of a mobile device based Android user interface application pool entry confirmation screen. Description of the features of this screen is similar to that of FIG. 91.

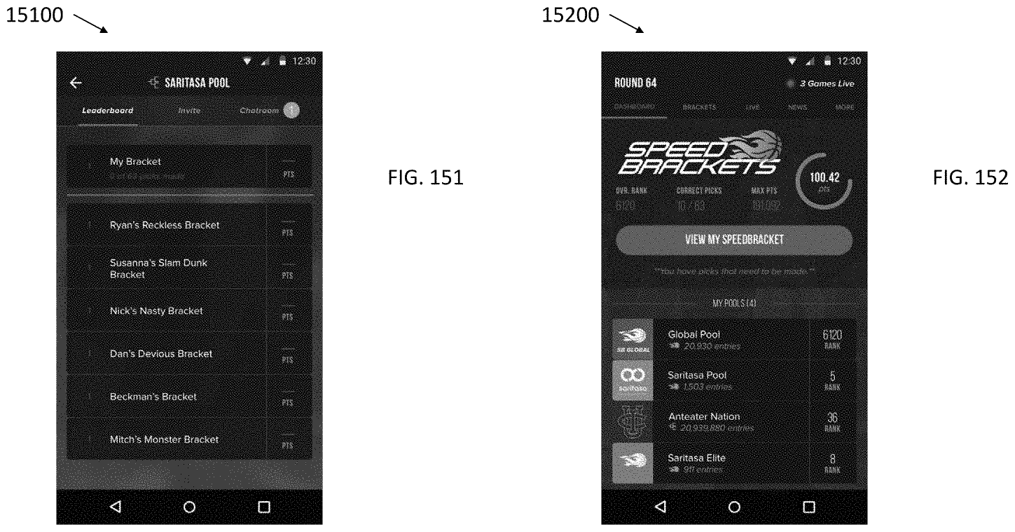

FIG. 151 shows an example embodiment diagram 15100 of a mobile device based Android user interface application pool leaderboard screen. Description of the features of this screen is similar to that of FIG. 92.

FIG. 152 shows an example embodiment diagram 15200 of a mobile device based Android user interface application live dashboard screen. Description of the features of this screen is similar to that of FIG. 93.

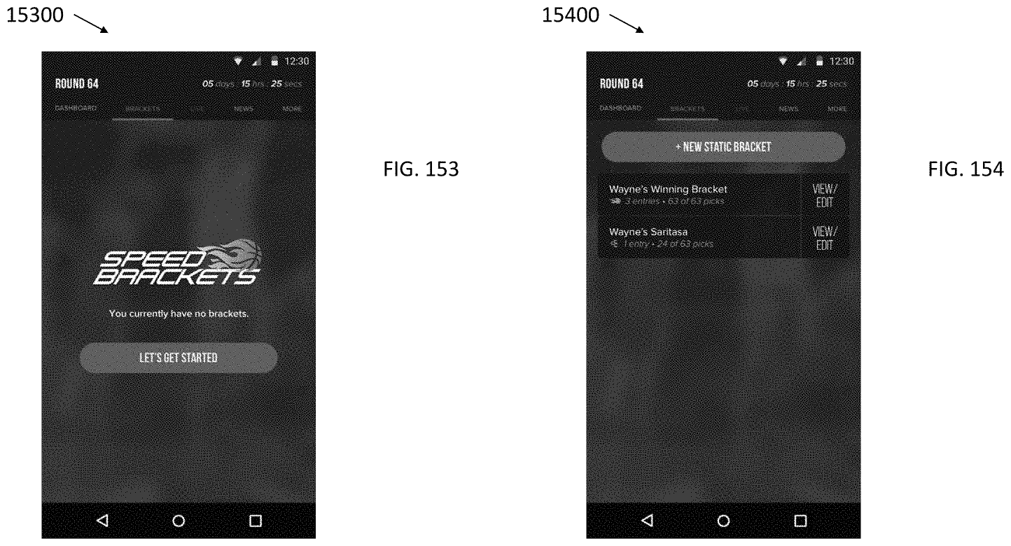

FIG. 153 shows an example embodiment diagram 15300 of a mobile device based Android user interface application bracket creation start screen. Description of the features of this screen is similar to that of FIG. 94.

FIG. 154 shows an example embodiment diagram 15400 of a mobile device based Android user interface application bracket creation screen. Description of the features of this screen is similar to that of FIG. 95.

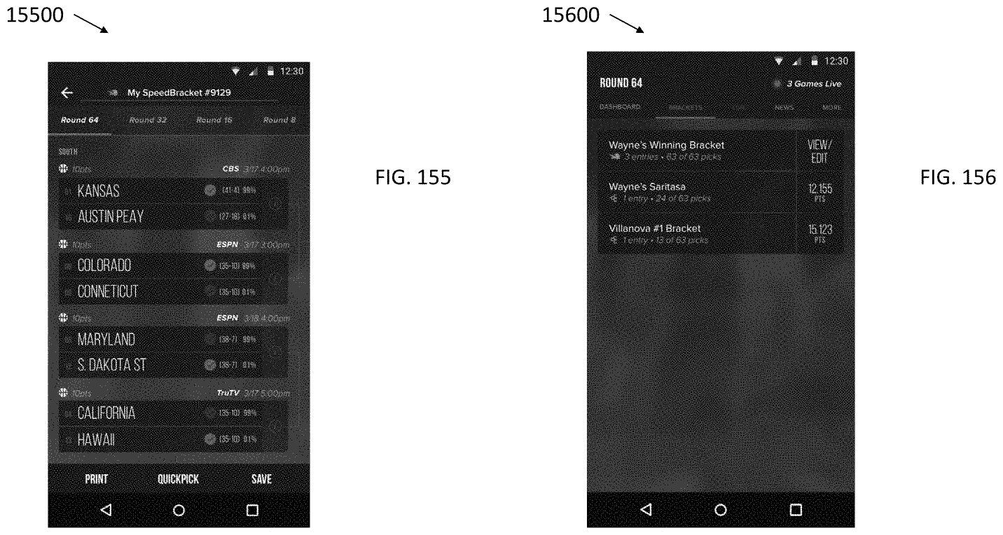

FIG. 155 shows an example embodiment diagram 15500 of a mobile device based Android user interface application bracket creation and game pick screen. Description of the features of this screen is similar to that of FIG. 96.

FIG. 156 shows an example embodiment diagram 15600 of a mobile device based Android user interface application live bracket list screen. Description of the features of this screen is similar to that of FIG. 97.

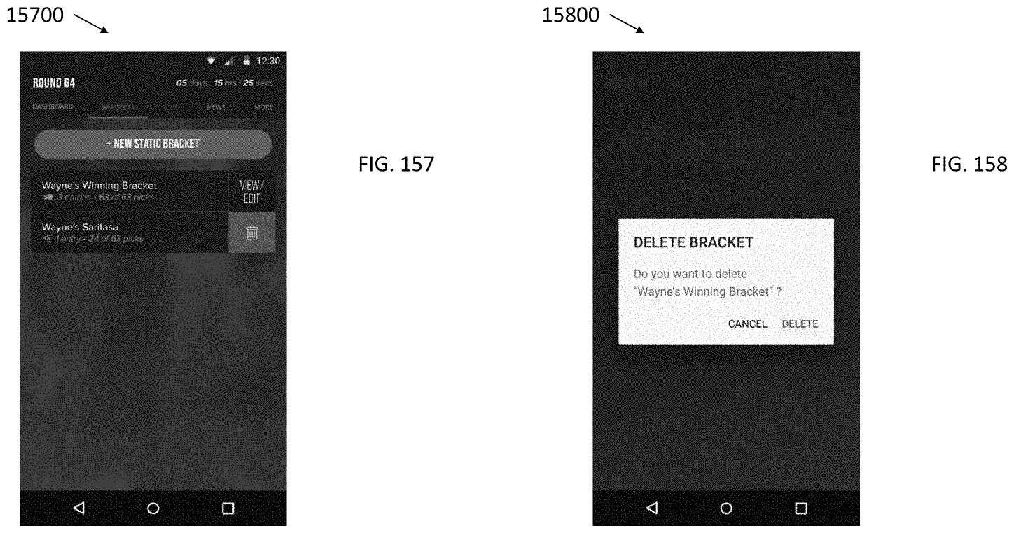

FIG. 157 shows an example embodiment diagram 15700 of a mobile device based Android user interface application bracket deletion screen. Description of the features of this screen is similar to that of FIG. 98.

FIG. 158 shows an example embodiment diagram 15800 of a mobile device based Android user interface application bracket deletion confirmation screen. Description of the features of this screen is similar to that of FIG. 99.

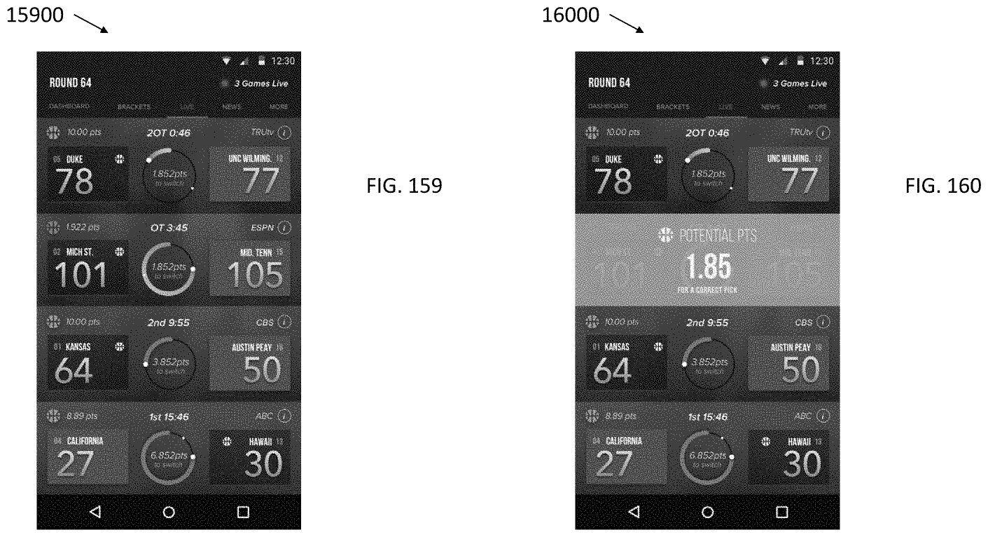

FIG. 159 shows an example embodiment diagram 15900 of a mobile device based Android user interface application live game information screen. Description of the features of this screen is similar to that of FIG. 100.

FIG. 160 shows an example embodiment diagram 16000 of a mobile device based Android user interface application live game potential points for pick switching screen. Description of the features of this screen is similar to that of FIG. 101.

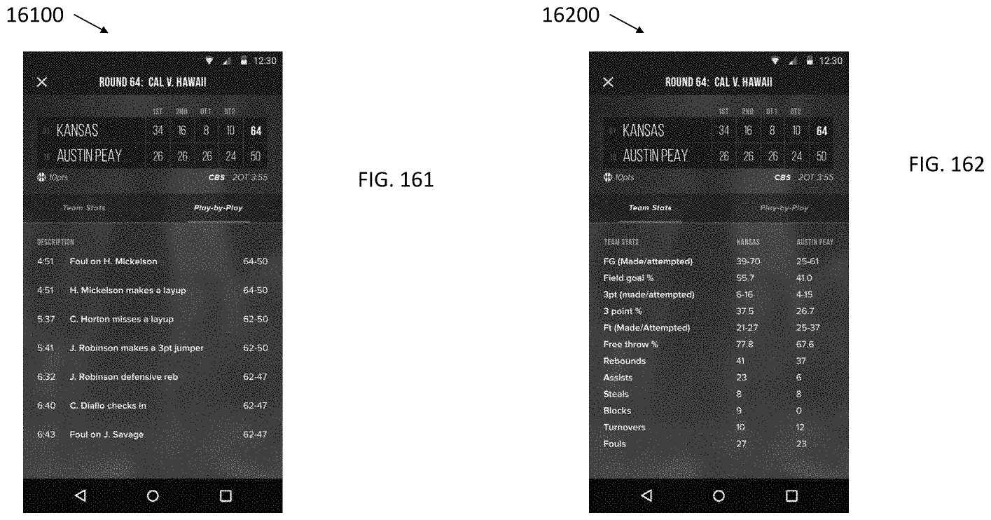

FIG. 161 shows an example embodiment diagram 16100 of a mobile device based Android user interface application live game score and player statistics screen showing play by play information for a matchup. Description of the features of this screen is similar to that of FIG. 102.

FIG. 162 shows an example embodiment diagram 16200 of a mobile device based Android user interface application live game score and game statistics screen including team based statistics. Description of the features of this screen is similar to that of FIG. 103.

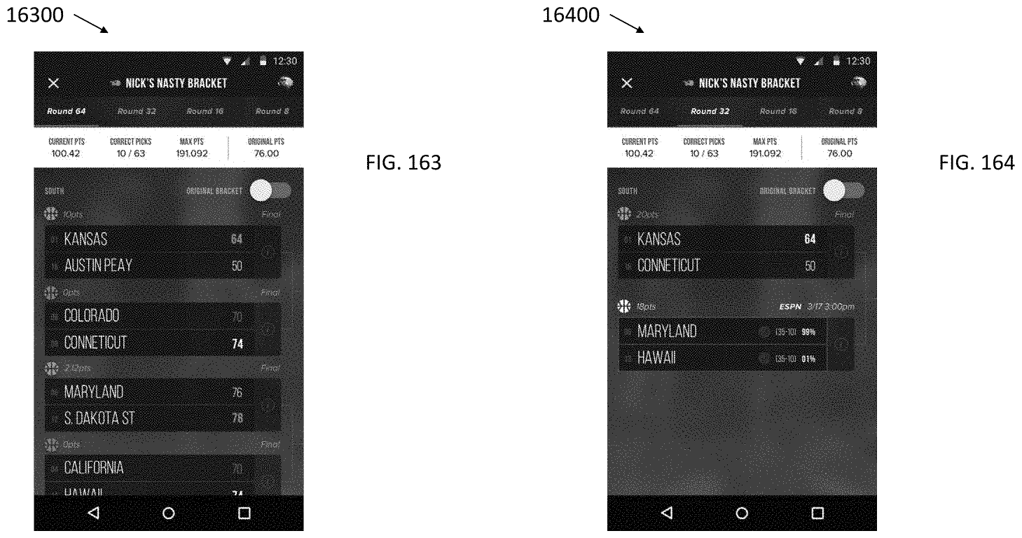

FIG. 163 shows an example embodiment diagram 16300 of a mobile device based Android user interface application live bracket round 1 screen, including information about a user's current points, correct pick number, maximum points available, original points available and toggle switch to view original bracket information, as opposed to changed bracket information. Description of the features of this screen is similar to that of FIG. 104.

FIG. 164 shows an example embodiment diagram 16400 of a mobile device based Android user interface application live bracket round 2 game winner pick screen. Description of the features of this screen is similar to that of FIG. 104.

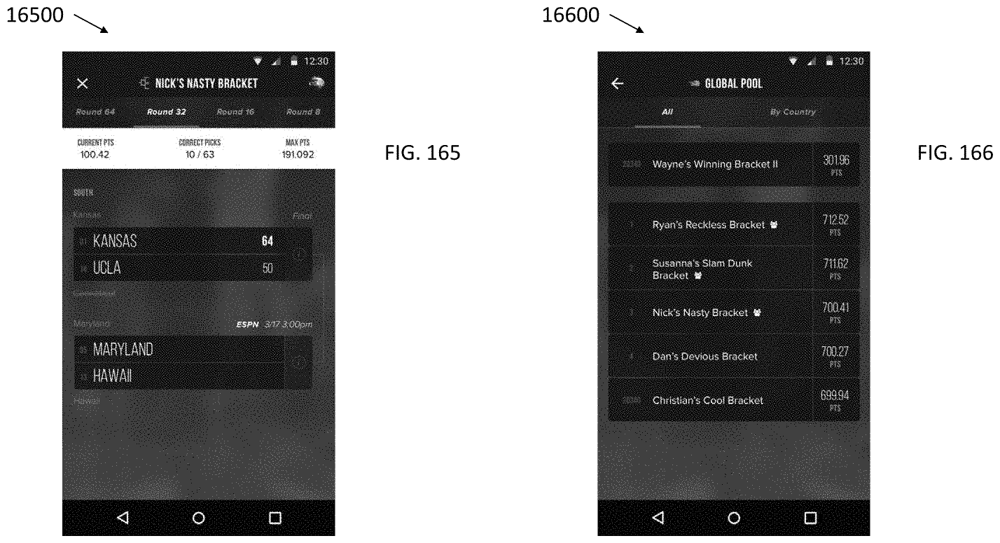

FIG. 165 shows an example embodiment diagram 16500 of a mobile device based Android user interface application live static bracket round 2 screen. Description of the features of this screen is similar to that of FIG. 105.

FIG. 166 shows an example embodiment diagram 16600 of a mobile device based Android user interface application live bracket global pool leaderboard listing screen. Description of the features of this screen is similar to that of FIG. 106.

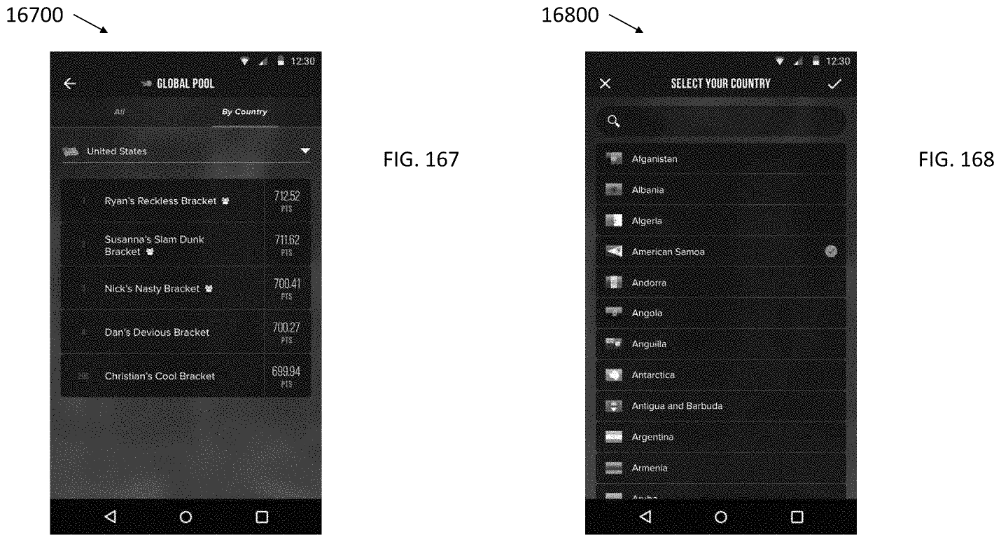

FIG. 167 shows an example embodiment diagram 16700 of a mobile device based Android user interface application live bracket single country pool leaderboard listing screen. Description of the features of this screen is similar to that of FIG. 107.

FIG. 168 shows an example embodiment diagram 16800 of a mobile device based Android user interface application live bracket country selection listing screen. Description of the features of this screen is similar to that of FIG. 108. Description of the features of this screen is similar to that of FIG. 109.

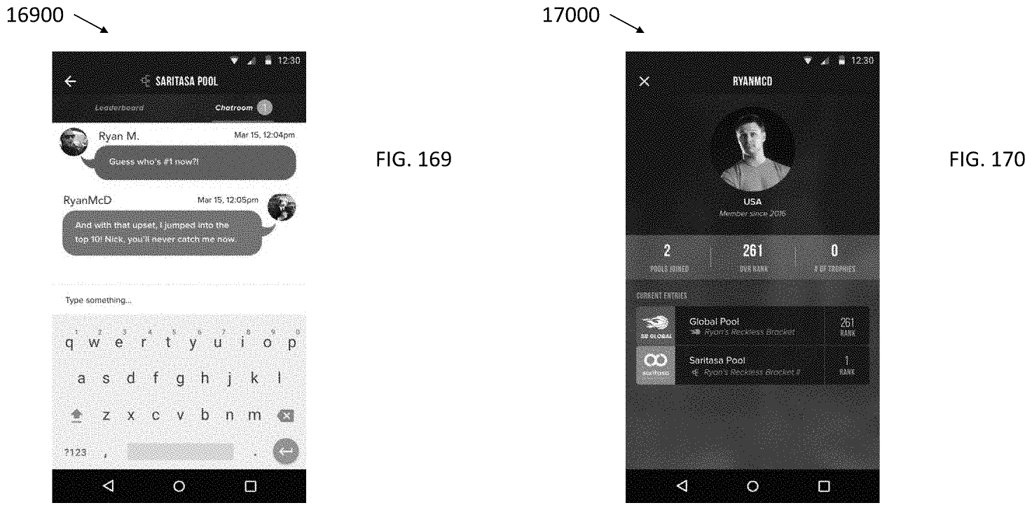

FIG. 169 shows an example embodiment diagram 16900 of a mobile device based Android user interface application live pool chat screen. Description of the features of this screen is similar to that of FIG. 109.

FIG. 170 shows an example embodiment diagram 17000 of a mobile device based Android user interface application live friend profile screen. Description of the features of this screen is similar to that of FIG. 110.

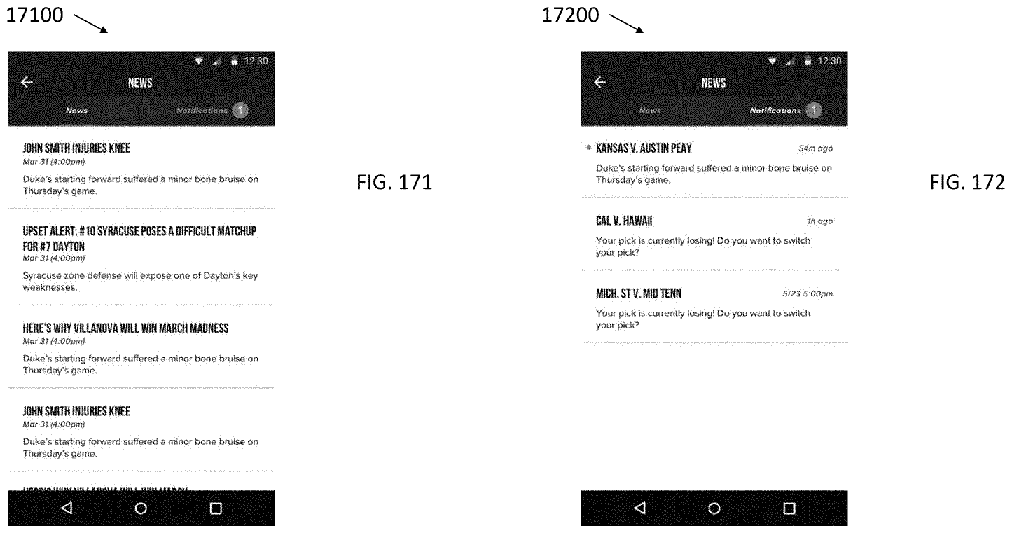

FIG. 171 shows an example embodiment diagram 17100 of a mobile device based Android user interface application news screen. Description of the features of this screen is similar to that of FIG. 111.

FIG. 172 shows an example embodiment diagram 17200 of a mobile device based Android user interface application notifications screen. Description of the features of this screen is similar to that of FIG. 112.

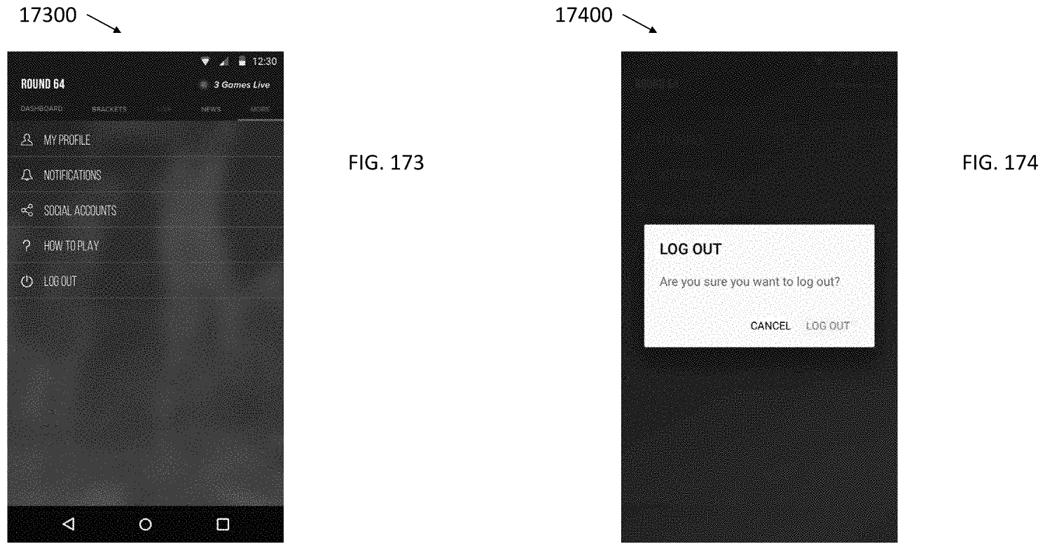

FIG. 173 shows an example embodiment diagram 17300 of a mobile device based Android user interface application settings screen. Description of the features of this screen is similar to that of FIG. 113.

FIG. 174 shows an example embodiment diagram 17400 of a mobile device based Android user interface application logout confirmation screen. Here a user can confirm whether they wish to log out.

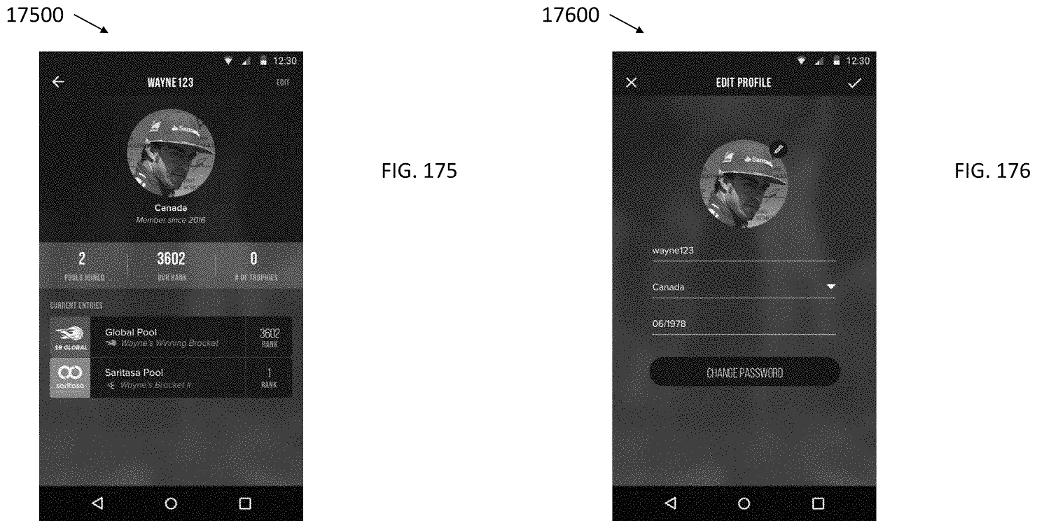

FIG. 175 shows an example embodiment diagram 17500 of a mobile device based Android user interface application personal profile screen. Description of the features of this screen is similar to that of FIG. 114.

FIG. 176 shows an example embodiment diagram 17600 of a mobile device based Android user interface personal profile editing screen. Description of the features of this screen is similar to that of FIG. 115.

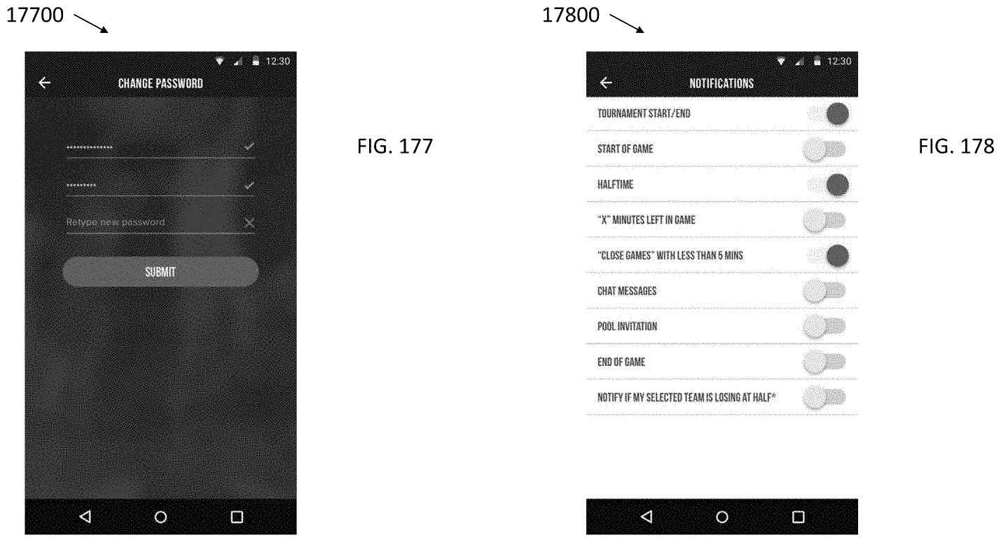

FIG. 177 shows an example embodiment diagram 17700 of a mobile device based Android user interface application password changing screen. Description of the features of this screen is similar to that of FIG. 116.

FIG. 178 shows an example embodiment diagram 17800 of a mobile device based Android user interface application notifications settings screen. Description of the features of this screen is similar to that of FIG. 117.

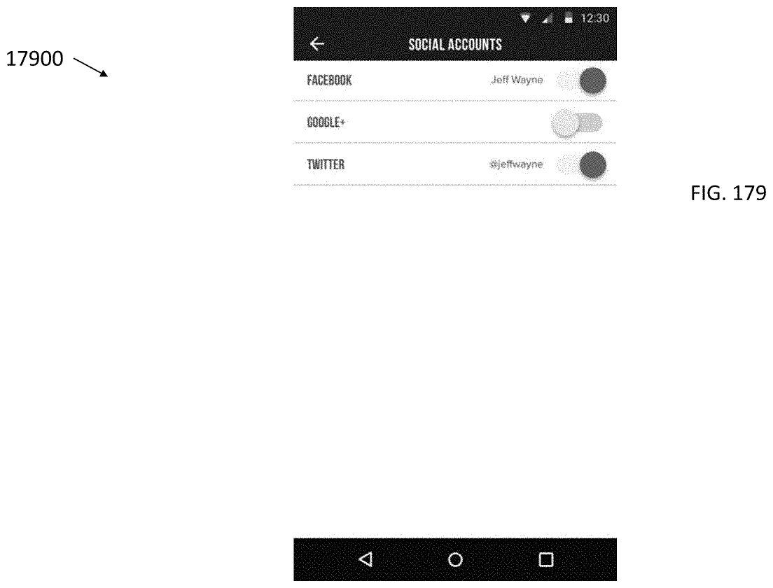

FIG. 179 shows an example embodiment diagram 17900 of a mobile device based Android user interface application social accounts settings screen. Description of the features of this screen is similar to that of FIG. 118.

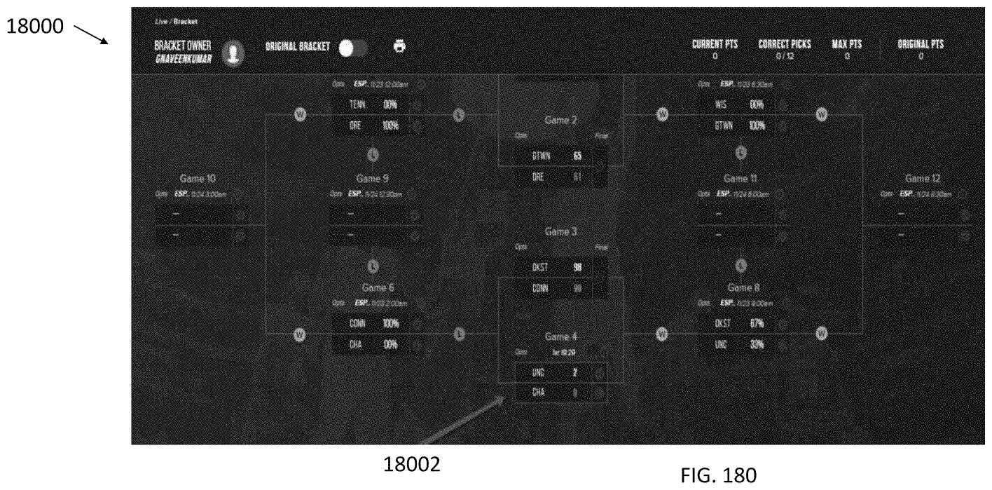

FIG. 180 shows an example embodiment diagram 18000 of a game highlighter feature that can highlight games or matchups that are currently in progress. This feature can be used in either or both dynamic and static bracket games. If one or more games are in progress, this feature will highlight them with a visual cue to provide a quick visibility for users. As shown, this visual cue 18002 can be a box, around the matchup. It could also be shading, flashing, or other types of visual cues in various embodiments.

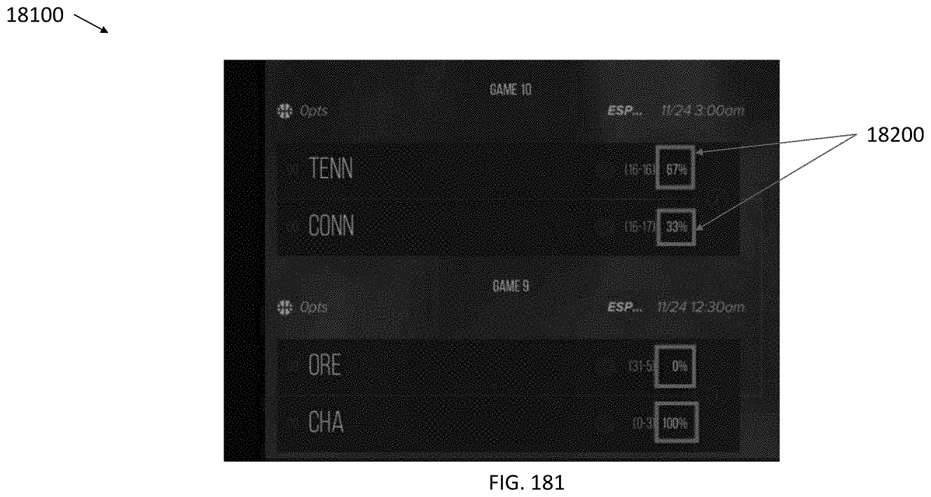

FIG. 181 shows an example embodiment diagram 18100 of a pick percentage feature that is based on a total number of system users who have selected a particular team. As shown in the example embodiment, percentage indicators 18200 can show that 67% of total users picked TENN and 33% of users picked CONN. This feature can be used in either or both dynamic and static bracket games and is designed to help users predict matchup winners based on other user's prediction selections.

In an example embodiment of a system layout, a total number of home picks=homePickCount; a total number of away picks=awayPickCount; and a total number of picks ($total)=total number of home picks+total number of away picks. Further, a home pick percent can be $total? round($homePickCount*100/$total): 50 and an away pick percent can be 100-home pick percent.

In some embodiments, nested pools can be included. In general, a collection of pools is called a nested pool. A nested pool in the system can be an aggregation of the collected pools, which can then be automatically analyzed to displays the top brackets from each pool, for example 3 or 5 from each pool. In some embodiments, the user can create nested pools and can join a user-created pool to the nested pool if they are public or they know the password to join privately.

In order to create nested pools, users can click or select a ‘CREATE NESTED POOL’ button on a dashboard. This selection can then take the user to a nested pool create page or otherwise display it. There, the user has various options to create nested pools. In some embodiments, these options include mandatory fields, such as: Name (Should be unique which means the name should not exist already), Avatar (Can select already existing avatar or upload their avatar), Password, and others.

In some embodiments, nested pools can be a feature that users must pay for. They are generally password protected in most embodiments. If users know the password, they can attach their pool to the nested pool. The system can display all pools joined within nested pool.

In various embodiments, API's can include and use various operations that have various tags. For example, Login existing user, returns access token; Logout, makes authentication token invalid; Use third party platform account token to log in; Set new user's password; Request password reset, when forgotten; Confirm password reset; second step (follow link from email); and others can be used for authentication. Coupons can be used to receive news. Register new user account, Get user's profile info, Get current user's profile info, Edit current user's profile, Set or update current user's avatar, Update uses social accounts, Get user's social accounts Get notification settings, Change notification settings, Get list a current user's brackets, Submit confirmation of user registration (activate new user account), User subscribe his email, and others can be used for users. Miscellaneous can be Get terms and conditions text, Get list of countries, and others. Change notification settings can be used for notifications. Get list of current user's brackets, Create new bracket, Get selected bracket details, Update bracket, Delete bracket, Bracket Pick, Bracket Get Picks, Bracket quick pick, Export bracket board to pdf file, Bracket Pick Change if bracket is dynamic, and others can be used for brackets. Pools can have: Create new pool; Search pool by id or name; Pre-generate pool ID; Get pool details; Edit pool properties; Get brackets, submitted to a pool; Upload pool avatar image; Send message to a pool chat; Get messages of a pool chat; Invite friend(s) to pool via email; Join Pool—verifies in-app purchase and store data for iOS; Get list of available avatars for pool—returns predefined set of avatar and pool avatars, previously uploaded by user and others. Send message to a pool chat; Get messages of a pool chat; and others can be used for chat. Bracket Pick; Bracket Get Picks; Bracket quick pick; Bracket Pick Change. This API only be called if bracket is dynamic can be used for picks. For Games: Get list of games in selected round; Get pick percent of teams; Get statistics for teams; participating in a game; Get play-by-play information for a game; Get comparison. between teams of a game; Switch pick team of a game; Get live game information; and others. For tournaments: Get current tournament information, Get notification list, and others. For news: Get recent news and others.

As mentioned previously, applications, websites, webpages, and other computer implemented versions using the principles herein can be functionally provided for various amateur, college and professional sports and other events using tournament formats. These can include soccer, football, tennis, swimming, golf, boxing, wrestling, cricket, Olympic events, and numerous others. It should be understood that these may be standalone applications, or they can be part of an integrated platform running on one or a network of servers in various embodiments. For example, a boxing application that uses our technology can be used for different boxing tournaments such as the World Boxing Super Series. Similarly, a soccer application for various soccer events and tournaments such as the Euro Cup, World Cup 2018 and others. For cricket tournaments, a cricket application can be implemented, such as for Euro Cricket, the Cricket Championships, and others. Additionally, for football, a NFL Championship App, which includes regular season games and wild-card games through the Super Bowl. Alternatively, it may be provided only for postseason games in various embodiments for various sports and tournaments that have separate regular and postseasons.

To elaborate, for an implementation of a NFL Regular Season application it can be implemented in a manner that allows the user to select the winners of each game each week, and change their pick anytime during the game, but get less points for a changed pick. For example, looking at one game out of the 16 in a scheduled week, if a user selects the Redskins vs the Cowboys, and selects the Redskins to win before the game starts, but does not change their pick, and the Redskins win, they receive 100 points. However, if the user changes their pick to the Cowboys in the fourth quarter and the Cowboys win, they may receive some points still, although reduced. For example, 15.79 points depending on when during the quarter the user changed their pick, due to an implemented decay function. Alternatively, if the user picks a team that loses the game and does not change to pick the winner before a particular deadline, they receive zero points.

As an example, in some embodiments, rules may be simple and intuitive for users. As such, users may be required to select winning teams for one, some, or all games each week before Thursday at a specific time, such as noon in a particular time zone. In dynamic implementations, they may then be able to change their picks any time after the deadline, including during the game. As described herein, changing teams in dynamic implementations during a game or after a deadline may reduce the total points possible for the user, as opposed to if they do not change their winning selection. Further, changing selections earlier is better than changing later due to various decay algorithms managing the point totals possible. These types of scoring algorithms featuring decay can also be used for the college football bowl games for the overall selections of winners.

Users can also create and join pools, as described elsewhere herein. These pools or contests that users can form, or join can be promotional in nature and “run” by a sports celebrity and may provide virtual or real-world incentives for winning users. For example, if a car company sponsors a pool with a famous golfer as a sponsor, the reward for winning the pool might be a car. In various embodiments, winners can be shown publicly at the end of each week, as well as the entire season, giving the “owners” of the pool the ability to award prizes each week.

Additional features are also provided in some embodiments. One feature that can be included in some embodiments is requiring users to select one team out of the maximum thirty-two that may be playing each week. In these embodiments, this can be termed a “lock team,” which is a team that the user is confident will win their game. As such, system can prevent users from changing their selection of that game's winner after it is locked. If the user selects the correct winner of the game, they may receive a substantial reward, for example 500 points, since it is their lock team with no ability to change their decision. However, if the user selects a lock team that ultimately loses their game, the user can receive a substantially reduced number of points, even zero points or negative points. In some embodiments, users may not be able to select that team as a lock team in any other games during the season, adding another layer of strategy.

For an NFL Championship application, similar principles can be applied to those in the regular season. A variety of new features, graphics, and further distinguish over the currently available tournament game picking platforms.

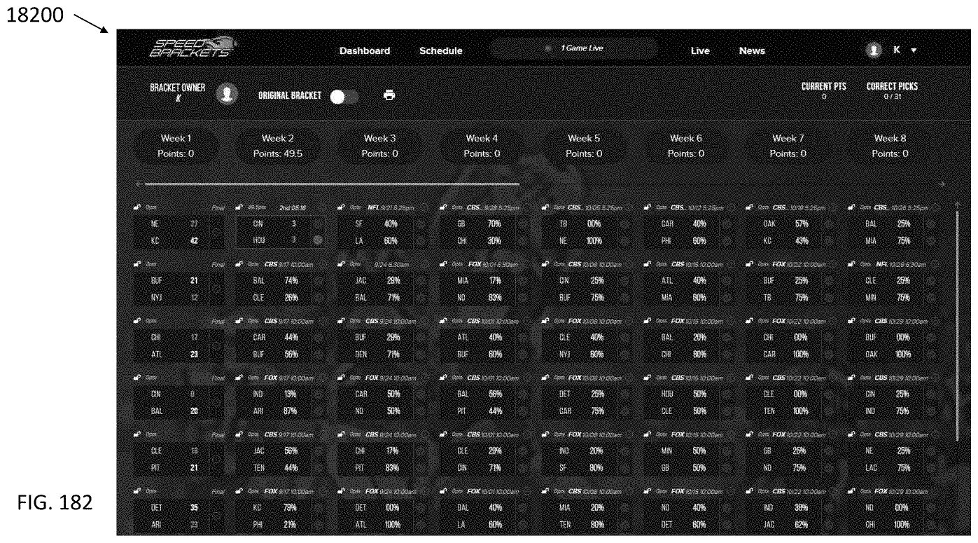

FIG. 182 shows an example embodiment image 18200 of a football selection screen. As shown, users can select winners for all games, as well as change them and the system can show currently occurring games, games with important features, or other attributes with highlighting options as described elsewhere herein. They can also view game statistics, timing, dates, projections, news, and other information as described elsewhere herein.

It should be understood that the features and concepts described herein can be implemented using a number of user interfaces, display screens, such as voice commands through audio processing, touchscreens, physical buttons, visual cues using cameras and others, as appropriate. Notifications can be likewise varied, including device vibrations, audio cues, visual cues and others. Radio buttons, sliders, fields for entering information and numerous other interactive features are contemplated to implement the concepts described herein, as known in the art currently or developed in the future. These various interfaces and functions are implemented using processors, non-transitory memory, networking components, hardware, software, operating systems, graphical user interfaces and others, as appropriate.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A system for promoting a social gaming environment via a computer network, comprising:
a server, communicatively coupled to the network and including at least one point scoring algorithm; and
a first user device, communicatively coupled to the network and having instructions stored in non-transitory memory that, when executed by a processor of the user device, cause the processor to:
communicatively couple with the server via the network;
receive at least one set of tournament bracket selections from a user via a user interface;
display a gaming environment including the bracket selections and an option to change at least one bracket selection while a tournament contest is occurring;
if the user changes a bracket selection, transmit the change to the server and receive an updated point value from the server; and
change the bracket selection and send an update to the server based on a user confirmation.

2. The system for promoting a social gaming environment via a computer network of claim 1, wherein the updated point value is based on a decay functions stored in non-transitory memory on the server.

3. The system for promoting a social gaming environment via a computer network of claim 2, wherein the decay function is based on the time remaining for game time during a tournament contest.

4. The system for promoting a social gaming environment via a computer network of claim 2, wherein the decay function is based on a game attribute associated with at least one team in the tournament contest.

5. The system for promoting a social gaming environment via a computer network of claim 4, wherein the game attribute is based on the game score of at least one team during the tournament contest.

6. The system for promoting a social gaming environment via a computer network of claim 4, wherein the game attribute is based on the number of timeouts remaining for at least one team during the tournament contest.

7. The system for promoting a social gaming environment via a computer network of claim 4, wherein the game attribute is based on an overtime in the tournament contest.

8. The system for promoting a social gaming environment via a computer network of claim 2, wherein the decay function does not begin running until the tournament contest begins.

9. The system for promoting a social gaming environment via a computer network of claim 1, further comprising the instructions causing the processor to:
display a dashboard environment including a total number of points possible for the user to score during the tournament.

10. The system for promoting a social gaming environment via a computer network of claim 1, further comprising the instructions causing the processor to:
display a dashboard environment including a total number of points scored by the user during the tournament.

11. The system for promoting a social gaming environment via a computer network of claim 1, further comprising the instructions causing the processor to:
selectively create a pool.

12. The system for promoting a social gaming environment via a computer network of claim 11, wherein the pool is private and requires a password.

13. The system for promoting a social gaming environment via a computer network of claim 11, wherein the pool is public.

14. The system for promoting a social gaming environment via a computer network of claim 1, further comprising the instructions causing the processor to:
selectively join a pool.

15. The system for promoting a social gaming environment via a computer network of claim 1, further comprising the instructions causing the processor to:
selectively display a leaderboard.

16. The system for promoting a social gaming environment via a computer network of claim 15, wherein the leaderboard is global for all users of the system.

17. The system for promoting a social gaming environment via a computer network of claim 1, further comprising the instructions causing the processor to:
selectively display information on at least one tournament contest that is currently occurring in real-time.

18. The system for promoting a social gaming environment via a computer network of claim 1, further comprising the instructions causing the processor to:
selectively lock at least one tournament bracket selection from the user based on a user confirmation.

19. The system for promoting a social gaming environment via a computer network of claim 1, further comprising the instructions causing the processor to:
selectively perform automatic bracket selections based on a user input.

20. The system for promoting a social gaming environment via a computer network of claim 1, further comprising the instructions causing the processor to:
selectively display running point totals for other users based on user input.
